(19) United States
(12) Patent Application Publication
(10) Pub. No.: US 2008/0304522 A1
(43) Pub. Date: Dec. 11, 2008

(54) Catalyst laser

(76) Inventor: Randell L. Mills, Cranbury, NJ (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/730,065

(22) Filed: Mar. 29, 2007

Related U.S. Application Data
(60) Provisional application No. 60/788,693, filed on Apr. 4, 2006.

(51) Int. Cl. H01S 3/30

(52) U.S. Cl. 372/5

(57) ABSTRACT

Provided is a laser based on the formation of an inverted population in an atom or ion of an element wherein at least one oxidation state of the element serves as a catalyst with atomic hydrogen to form states that are lower in energy than that of the n=1 state of having a binding energy of 13.6 eV. The catalytic reaction between atomic hydrogen and the catalyst pumps the exited states of catalyst or species caused by the ionization of the catalyst as the reaction releases energy with the formation of atomic-hydrogen states with binding energies lower than those of uncatalyzed atomic hydrogen. In an embodiment, the system comprises a source of catalyst and hydrogen gases and a means to cause a plasma of these gases. The plasma dissociates molecular hydrogen to atomic hydrogen and ionizes the source of catalyst to form the catalyst. The catalyst looses one or more electrons during the catalytic reaction, and the recombination of electrons with the ionized catalyst creates an inverted population.

This application claims priority to U.S. Provisional Patent Application Ser. No. 60/788,693, filed 4 Apr. 2006, the complete disclosure of which is incorporated herein by reference.

### FIELD OF THE INVENTION

Lithography, the technique for manufacturing microelectronics semiconductor devices such as processors and memory chips, presently uses deep UV radiation at 193 nm from the ArF excimer laser. Future sources are F₂ lasers at 157 nm and perhaps H₂ lasers at 127 nm. Advancements in light sources are required in order to achieve the steady reduction in the size of integrated circuits. Only a free electron laser (FEL) with a minimum beam energy of 500 MeV appears suitable as a light source for the Next Generation Lithography (NGL) based on EUV lithography (13.5 nm) [J. E. Bjorkholm, “EUV lithography—the successor to optical lithography?”, Intel Technology Journal, Q3, (1998), pp. 1-8; K. Hesch, E. Pellegrin, R. Rossmanith, R. Steininger, V. Saile, J. Wust, G. Dattoli, A. Doria, G. Gallerano, L. Giannessi, P. Ottaviani, H. Moser, “Extreme ultraviolet (EUV) sources based on synchrotron radiation”, Proceedings of the 2001 Particle Accelerator Conference, Chicago, pp. 654-656]. The opportunity exists to replace a FEL that occupies the size of a large building with a table-top laser based on inversion of catalyst atomic or ion states wherein the catalytic reaction between atomic hydrogen and the catalyst pumps the exited states of the catalyst or ionized species of the catalyst as the reaction releases energy with the formation of atomic-hydrogen states with binding energies lower than those of uncatalyzed atomic hydrogen.

This invention comprises a laser based on the formation of an inverted population in an atom or ion of an element wherein at least one oxidation state of the element serves as a catalyst with atomic hydrogen to form states that are lower in energy than that of the n=1 state of having a binding energy of 13.6 eV. The invention comprises a power source that is at least one of an external source and a cell for the catalysis of atomic hydrogen to form novel hydrogen species and/or compositions of matter comprising new forms of hydrogen. In one embodiment, of a He⁺ laser, the emission is in the extreme ultraviolet (EUV). The catalyst laser has an application as a EUV light source for photolithography at short wavelengths.

### BACKGROUND OF THE INVENTION

Hydrinos

A hydrogen atom having a binding energy given by

$$Binding Energy = \frac{13.6 eV}{{( \frac{1}{p} )}^{2}} \qquad ( 1 )$$

where p is an integer greater than 1, preferably from 2 to 200, is disclosed in R. Mills, The Grand Unified Theory of Classical Quantum Mechanics, May 2006 Edition, BlackLight Power, Inc., Cranbury, N.J., (“'06 Mills GUT”), provided by BlackLight Power, Inc., 493 Old Trenton Road, Cranbury, N.J., 08512 (posted at www.blacklightpower.com); R. Mills, The Grand Unified Theory of Classical Quantum Mechanics, January 2004 Edition, BlackLight Power, Inc., Cranbury, N.J., (“'04 Mills GUT”), provided by BlackLight Power, Inc., 493 Old Trenton Road, Cranbury, N.J., 08512; R. Mills, The Grand Unified Theory of Classical Quantum Mechanics, September 2003 Edition, BlackLight Power, Inc., Cranbury, N.J., (“'03 Mills GUT”), provided by BlackLight Power, Inc., 493 Old Trenton Road, Cranbury, N.J., 08512; R. Mills, The Grand Unified Theory of Classical Quantum Mechanics, September 2002 Edition, BlackLight Power, Inc., Cranbury, N.J., (“'02 Mills GUT”), provided by BlackLight Power, Inc., 493 Old Trenton Road, Cranbury, N.J., 08512; R. Mills, The Grand Unified Theory of Classical Quantum Mechanics, September 2001 Edition, BlackLight Power, Inc., Cranbury, N.J., Distributed by Amazon.com (“'01 Mills GUT”), provided by BlackLight Power, Inc., 493 Old Trenton Road, Cranbury, N.J., 08512; R. Mills, The Grand Unified Theory of Classical Quantum Mechanics, January 2000 Edition, BlackLight Power, Inc., Cranbury, N.J., Distributed by Amazon.com (“'00 Mills GUT”), provided by BlackLight Power, Inc., 493 Old Trenton Road, Cranbury, N.J., 08512; R. L. Mills, “Maxwell's Equations and QED: Which is Fact and Which is Fiction”, Physica Scripta, submitted; R. L. Mills, “Exact Classical Quantum Mechanical Solution for Atomic Helium Which Predicts Conjugate Parameters from a Unique Solution for the First Time”, Progress of Physics, submitted; J. Phillips, C-K Chen, R. Mills, “Evidence of catalytic Production of Hot Hydrogen in RF Generated Hydrogen/Argon Plasmas”, IEEE Transactions on Plasma Science, submitted; R. L. Mills, Y. Lu, M. Nansteel, J. He, A. Voigt, W. Good, B. Dhandapani, “Energetic Catalyst-Hydrogen Plasma Reaction as a Potential New Energy Source”, Division of Fuel Chemistry, Session: Advances in Hydrogen Energy, 228th American Chemical Society National Meeting, Aug. 22-26, 2004, Philadelphia, Pa.; R. Mills, B. Dhandapani, W. Good, J. He, “New States of Hydrogen Isolated from K₂CO₃ Electrolysis Gases”, Chemical Engineering Science, submitted; R. L. Mills, “Exact Classical Quantum Mechanical Solutions for One-Through Twenty-Electron Atoms”, Physics Essays, submitted; R. L. Mills, Y. Lu, M. Nansteel, J. He, A. Voigt, B. Dhandapani, “Energetic Catalyst-Hydrogen Plasma Reaction as a Potential New Energy Source”, Division of Fuel Chemistry, Session: Chemistry of Solid, Liquid, and Gaseous Fuels, 227th American Chemical Society National Meeting, Mar. 28-Apr. 1, 2004, Anaheim, Calif.; R. Mills, B. Dhandapani, J. He, “Highly Stable Amorphous Silicon Hydride from a Helium Plasma Reaction”, Materials Chemistry and Physics, submitted; R. L. Mills, Y. Lu, B. Dhandapani, “Spectral Identification of H₂(½)”, submitted; R. L. Mills, Y. Lu, J. He, M. Nansteel, P. Ray, X. Chen, A. Voigt, B. Dhandapani, “Spectral Identification of New States of Hydrogen”, New Journal of Chemistry, submitted; R. Mills, P. Ray, B. Dhandapani, “Evidence of an Energy Transfer Reaction Between Atomic Hydrogen and Argon II or Helium II as the Source of Excessively Hot H Atoms in RF Plasmas”, Contributions to Plasma Physics, submitted; J. Phillips, C. K. Chen, R. Mills, “Evidence of the Production of Hot Hydrogen Atoms in RF Plasmas by Catalytic Reactions Between Hydrogen and Oxygen Species”, Spectrochimica Acta Part B: Atomic Spectroscopy, submitted; R. L. Mills, P. Ray, B. Dhandapani, “Excessive Balmer a Line Broadening of Water-Vapor Capacitively-Coupled RF Discharge Plasmas” IEEE Transactions on Plasma Science, submitted; R. L. Mills, “The Nature of the Chemical Bond Revisited and an Alternative Maxwellian Approach”, Physics Essays, Vol. 17, No. 3, (2004), pp. 342-389; R. L. Mills, P. Ray, M. Nansteel, J. He, X. Chen, A. Voigt, B. Dhandapani, “Energetic Catalyst-Hydrogen Plasma Reaction Forms a New State of Hydrogen”, Doklady Chemistry, submitted; R. L. Mills, P. Ray, M. Nansteel, J. He, X. Chen, A. Voigt, B. Dhandapani, Luca Gamberale, “Energetic Catalyst-Hydrogen Plasma Reaction as a Potential New Energy Source”, Central European Journal of Physics, submitted; R. Mills, P. Ray, “New H I Laser Medium Based on Novel Energetic Plasma of Atomic Hydrogen and Certain Group I Catalysts”, J. Plasma Physics, submitted; R. L. Mills, P. Ray, M. Nansteel, J. He, X. Chen, A. Voigt, B. Dhandapani, “Characterization of an Energetic Catalyst-Hydrogen Plasma Reaction as a Potential New Energy Source”, Am. Chem. Soc. Div. Fuel Chem. Prepr., Vol. 48, No. 2, (2003); R. Mills, P. C. Ray, M. Nansteel, W. Good, P. Jansson, B. Dhandapani, J. He, “Hydrogen Plasmas Generated Using Certain Group I Catalysts Show Stationary Inverted Lyman Populations and Free-Free and Bound-Free Emission of Lower-Energy State Hydride”, Fizika A, submitted; R. Mills, J. Sankar, A. Voigt, J. He, P. Ray, B. Dhandapani, “Role of Atomic Hydrogen Density and Energy in Low Power CVD Synthesis of Diamond Films”, Thin Solid Films, submitted; R. Mills, B. Dhandapani, M. Nansteel, J. He, P. Ray, “Liquid-Nitrogen-Condensable Molecular Hydrogen Gas Isolated from a Catalytic Plasma Reaction”, J. Phys. Chem. B, submitted; R. L. Mills, P. Ray, J. He, B. Dhandapani, M. Nansteel, “Novel Spectral Series from Helium-Hydrogen Evenson Microwave Cavity Plasmas that Matched Fractional-Principal-Quantum-Energy-Level Atomic and Molecular Hydrogen”, European Journal of Physics, submitted; R. L. Mills, P. Ray, R. M. Mayo, Highly Pumped Inverted Balmer and Lyman Populations, New Journal of Physics, submitted; R. L. Mills, P. Ray, J. Dong, M. Nansteel, R. M. Mayo, B. Dhandapani, X. Chen, “Comparison of Balmer a Line Broadening and Power Balances of Helium-Hydrogen Plasma Sources”, Braz. J. Phys., submitted; R. Mills, P. Ray, M. Nansteel, R. M. Mayo, “Comparison of Water-Plasma Sources of Stationary Inverted Balmer and Lyman Populations for a CW HI Laser”, J. Appl. Spectroscopy, in preparation; R. Mills, J. Sankar, A. Voigt, J. He, P. Ray, B. Dhandapani, “Synthesis and Characterization of Diamond Films from MPCVD of an Energetic Argon-Hydrogen Plasma and Methane”, J. of Materials Research, submitted; R. Mills, P. Ray, B. Dhandapani, W. Good, P. Jansson, M. Nansteel, J. He, A. Voigt, “Spectroscopic and NMR Identification of Novel Hydride Ions in Fractional Quantum Energy States Formed by an Exothermic Reaction of Atomic Hydrogen with Certain Catalysts”, European Physical Journal-Applied Physics, Vol. 28, (2004), pp. 83-104; R. L. Mills, The Fallacy of Feynman's Argument on the Stability of the Hydrogen Atom According to Quantum Mechanics, Fondation Louis de Broglie, submitted; R. Mills, J. He, B. Dhandapani, P. Ray, “Comparison of Catalysts and Microwave Plasma Sources of Vibrational Spectral Emission of Fractional-Rydberg-State Hydrogen Molecular Ion”, Canadian Journal of Physics, submitted; R. L. Mills, P. Ray, X. Chen, B. Dhandapani, “Vibrational Spectral Emission of Fractional-Principal-Quantum-Energy-Level Molecular Hydrogen”, J. of the Physical Society of Japan, submitted; J. Phillips, R. L. Mills, X. Chen, “Water Bath Calorimetric Study of Excess Heat in ‘Resonance Transfer’ Plasmas”, Journal of Applied Physics, Vol. 96, No. 6, pp. 3095-3102; R. L. Mills, P. Ray, B. Dhandapani, X. Chen, “Comparison of Catalysts and Microwave Plasma Sources of Spectral Emission of Fractional-Principal-Quantum-Energy-Level Atomic and Molecular Hydrogen”, Journal of Applied Spectroscopy, submitted; R. L. Mills, B. Dhandapani, M. Nansteel, J. He, P. Ray, “Novel Liquid-Nitrogen-Condensable Molecular Hydrogen Gas”, Acta Physica Polonica A, submitted; R. L. Mills, P. C. Ray, R. M. Mayo, M. Nansteel, B. Dhandapani, J. Phillips, “Spectroscopic Study of Unique Line Broadening and Inversion in Low Pressure Microwave Generated Water Plasmas”, J. Plasma Physics, submitted; R. L. Mills, P. Ray, B. Dhandapani, J. He, “Energetic Helium-Hydrogen Plasma Reaction”, AIAA Journal, submitted; R. L. Mills, M. Nansteel, P. C. Ray, “Bright Hydrogen-Light and Power Source due to a Resonant Energy Transfer with Strontium and Argon Ions”, Vacuum, submitted; R. L. Mills, P. Ray, B. Dhandapani, J. Dong, X. Chen, “Power Source Based on Helium-Plasma Catalysis of Atomic Hydrogen to Fractional Rydberg States”, Contributions to Plasma Physics, submitted; R. Mills, J. He, A. Echezuria, B Dhandapani, P. Ray, “Comparison of Catalysts and Plasma Sources of Vibrational Spectral Emission of Fractional-Rydberg-State Hydrogen Molecular Ion”, European Journal of Physics D, submitted; R. L. Mills, J. Sankar, A. Voigt, J. He, B. Dhandapani, “Spectroscopic Characterization of the Atomic Hydrogen Energies and Densities and Carbon Species During Helium-Hydrogen-Methane Plasma CVD Synthesis of Diamond Films”, Chemistry of Materials, Vol. 15, (2003), pp. 1313-1321; R. Mills, P. Ray, R. M. Mayo, “Stationary Inverted Balmer and Lyman Populations for a CW HI Water-Plasma Laser”, IEEE Transactions on Plasma Science, submitted; R. L. Mills, P. Ray, “Extreme Ultraviolet Spectroscopy of Helium-Hydrogen Plasma”, J. Phys. D, Applied Physics, Vol. 36, (2003), pp. 1535-1542; R. L. Mills, P. Ray, “Spectroscopic Evidence for a Water-Plasma Laser”, Europhysics Letters, submitted; R. Mills, P. Ray, “Spectroscopic Evidence for Highly Pumped Balmer and Lyman Populations in a Water-Plasma”, J. of Applied Physics, submitted; R. L. Mills, J. Sankar, A. Voigt, J. He, B. Dhandapani, “Low Power MPCVD of Diamond Films on Silicon Substrates”, Journal of Vacuum Science & Technology A, submitted; R. L. Mills, X. Chen, P. Ray, J. He, B. Dhandapani, “Plasma Power Source Based on a Catalytic Reaction of Atomic Hydrogen Measured by Water Bath Calorimetry”, Thermochimica Acta, Vol. 406/1-2, (2003), pp. 35-53; R. L. Mills, A. Voigt, B. Dhandapani, J. He, “Synthesis and Spectroscopic Identification of Lithium Chloro Hydride”, Materials Characterization, submitted; R. L. Mills, B. Dhandapani, J. He, “Highly Stable Amorphous Silicon Hydride”, Solar Energy Materials & Solar Cells, Vol. 80, No. 1, pp. 1-20; R. L. Mills, J. Sankar, P. Ray, A. Voigt, J. He, B. Dhandapani, “Synthesis of HDLC Films from Solid Carbon”, Journal of Material Science, Vol. 39, (2004), pp. 3309-3318; R. Mills, P. Ray, R. M. Mayo, “The Potential for a Hydrogen Water-Plasma Laser”, Applied Physics Letters, Vol. 82, No. 11, (2003), pp. 1679-1681; R. L. Mills, “Classical Quantum Mechanics”, Physics Essays, in press; R. L. Mills, P. Ray, “Spectroscopic Characterization of Stationary Inverted Lyman Populations and Free-Free and Bound-Free Emission of Lower-Energy State Hydride Ion Formed by a Catalytic Reaction of Atomic Hydrogen and Certain Group I Catalysts”, Journal of Quantitative Spectroscopy and Radiative Transfer, No. 39, sciencedirect.com, Apr. 17, (2003); R. M. Mayo, R. Mills, “Direct Plasmadynamic Conversion of Plasma Thermal Power to Electricity for Microdistributed Power Applications”, 40th Annual Power Sources Conference, Chemy Hill, N.J., Jun. 10-13, (2002), pp. 1-4; R. Mills, P. Ray, R. M. Mayo, “Chemically-Generated Stationary Inverted Lyman Population for a CW HI Laser”, European J of Phys. D, submitted; R. L. Mills, P. Ray, “Stationary Inverted Lyman Population Formed from Incandescently Heated Hydrogen Gas with Certain Catalysts”, J. Phys. D, Applied Physics, Vol. 36, (2003), pp. 1504-1509; R. Mills, “A Maxwellian Approach to Quantum Mechanics Explains the Nature of Free Electrons in Superfluid Helium”, Low Temperature Physics, submitted; R. Mills and M. Nansteel, P. Ray, “Bright Hydrogen-Light Source due to a Resonant Energy Transfer with Strontium and Argon Ions”, New Journal of Physics, Vol. 4, (2002), pp. 70.1-70.28; R. Mills, P. Ray, R. M. Mayo, “CW HI Laser Based on a Stationary Inverted Lyman Population Formed from Incandescently Heated Hydrogen Gas with Certain Group I Catalysts”, IEEE Transactions on Plasma Science, Vol. 31, No. 2, (2003), pp. 236-247; R. L. Mills, P. Ray, J. Dong, M. Nansteel, B. Dhandapani, J. He, “Spectral Emission of Fractional-Principal-Quantum-Energy-Level Atomic and Molecular Hydrogen”, Vibrational Spectroscopy, Vol. 31, No. 2, (2003), pp. 195-213; R. L. Mills, P. Ray, B. Dhandapani, J. He, “Comparison of Excessive Balmer a Line Broadening of Inductively and Capacitively Coupled RF, Microwave, and Glow Discharge Hydrogen Plasmas with Certain Catalysts”, IEEE Transactions on Plasma Science, Vol. 31, No. (2003), pp. 338-355; R. M. Mayo, R. Mills, M. Nansteel, “Direct Plasmadynamic Conversion of Plasma Thermal Power to Electricity”, IEEE Transactions on Plasma Science, October, (2002), Vol. 30, No. 5, pp. 2066-2073; H. Conrads, R. Mills, Th. Wrubel, “Emission in the Deep Vacuum Ultraviolet from a Plasma Formed by Incandescently Heating Hydrogen Gas with Trace Amounts of Potassium Carbonate”, Plasma Sources Science and Technology, Vol. 12, (2003), pp. 389-395; R. L. Mills, P. Ray, “Stationary Inverted Lyman Population and a Very Stable Novel Hydride Formed by a Catalytic Reaction of Atomic Hydrogen and Certain Catalysts”, Optical Materials, in press; R. L. Mills, J. He, P. Ray, B. Dhandapani, X. Chen, “Synthesis and Characterization of a Highly Stable Amorphous Silicon Hydride as the Product of a Catalytic Helium-Hydrogen Plasma Reaction”, Int. J. Hydrogen Energy, Vol. 28, No. 12, (2003), pp. 1401-1424; R. L. Mills, A. Voigt, B. Dhandapani, J. He, “Synthesis and Characterization of Lithium Chloro Hydride”, Int. J. Hydrogen Energy, submitted; R. L. Mills, P. Ray, “Substantial Changes in the Characteristics of a Microwave Plasma Due to Combining Argon and Hydrogen”, New Journal of Physics, www.njp.org, Vol. 4, (2002), pp. 22.1-22.17; R. L. Mills, P. Ray, “A Comprehensive Study of Spectra of the Bound-Free Hyperfine Levels of Novel Hydride Ion I (½), Hydrogen, Nitrogen, and Air”, Int. J. Hydrogen Energy, Vol. 28, No. 8, (2003), pp. 825-871; R. L. Mills, E. Dayalan, “Novel Alkali and Alkaline Earth Hydrides for High Voltage and High Energy Density Batteries”, Proceedings of the 17^{th} Annual Battery Conference on Applications and Advances, California State University, Long Beach, Calif., (Jan. 15-18, 2002), pp. 1-6; R. M. Mayo, R. Mills, M. Nansteel, “On the Potential of Direct and MHD Conversion of Power from a Novel Plasma Source to Electricity for Microdistributed Power Applications”, IEEE Transactions on Plasma Science, August, (2002), Vol. 30, No. 4, pp. 1568-1578; R. Mills, P. C. Ray, R. M. Mayo, M. Nansteel, W. Good, P. Jansson, B. Dhandapani, J. He, “Stationary Inverted Lyman Populations and Free-Free and Bound-Free Emission of Lower-Energy State Hydride Ion Formed by an Exothermic Catalytic Reaction of Atomic Hydrogen and Certain Group I Catalysts”, J. Phys. Chem. A, submitted; R. Mills, E. Dayalan, P. Ray, B. Dhandapani, J. He, “Highly Stable Novel Inorganic Hydrides from Aqueous Electrolysis and Plasma Electrolysis”, Electrochimica Acta, Vol. 47, No. 24, (2002), pp. 3909-3926; R. L. Mills, P. Ray, B. Dhandapani, R. M. Mayo, J. He, “Comparison of Excessive Balmer a Line Broadening of Glow Discharge and Microwave Hydrogen Plasmas with Certain Catalysts”, J. of Applied Physics, Vol. 92, No. 12, (2002), pp. 7008-7022; R. L. Mills, P. Ray, B. Dhandapani, J. He, “Emission Spectroscopic Identification of Fractional Rydberg States of Atomic Hydrogen Formed by a Catalytic Helium-Hydrogen Plasma Reaction”, Vacuum, submitted; R. L. Mills, P. Ray, B. Dhandapani, M. Nansteel, X. Chen, J. He, “New Power Source from Fractional Rydberg States of Atomic Hydrogen”, Current Applied Physics, submitted; R. L. Mills, P. Ray, B. Dhandapani, M. Nansteel, X. Chen, J. He, “Spectroscopic Identification of Transitions of Fractional Rydberg States of Atomic Hydrogen”, J. of Quantitative Spectroscopy and Radiative Transfer, in press; R. L. Mills, P. Ray, B. Dhandapani, M. Nansteel, X. Chen, J. He, “New Power Source from Fractional Quantum Energy Levels of Atomic Hydrogen that Surpasses Internal Combustion”, J. Mol. Struct., Vol. 643, No. 1-3, (2002), pp. 43-54; R. L. Mills, P. Ray, “Spectroscopic Identification of a Novel Catalytic Reaction of Rubidium Ion with Atomic Hydrogen and the Hydride Ion Product”, Int. J. Hydrogen Energy, Vol. 27, No. 9, (2002), pp. 927-935; R. Mills, J. Dong, W. Good, P. Ray, J. He, B. Dhandapani, “Measurement of Energy Balances of Noble Gas-Hydrogen Discharge Plasmas Using Calvet Calorimetry”, Int. J. Hydrogen Energy, Vol. 27, No. 9, (2002), pp. 967-978; R. L. Mills, A. Voigt, P. Ray, M. Nansteel, B. Dhandapani, “Measurement of Hydrogen Balmer Line Broadening and Thermal Power Balances of Noble Gas-Hydrogen Discharge Plasmas”, Int. J. Hydrogen Energy, Vol. 27, No. 6, (2002), pp. 671-685; R. Mills, P. Ray, “Vibrational Spectral Emission of Fractional-Principal-Quantum-Energy-Level Hydrogen Molecular Ion”, Int. J. Hydrogen Energy, Vol. 27, No. 5, (2002), pp. 533-564; R. Mills, P. Ray, “Spectral Emission of Fractional Quantum Energy Levels of Atomic Hydrogen from a Helium-Hydrogen Plasma and the Implications for Dark Matter”, Int. J. Hydrogen Energy, (2002), Vol. 27, No. 3, pp. 301-322; R. Mills, P. Ray, “Spectroscopic Identification of a Novel Catalytic Reaction of Potassium and Atomic Hydrogen and the Hydride Ion Product”, Int. J. Hydrogen Energy, Vol. 27, No. 2, (2002), pp. 183-192; R. Mills, “BlackLight Power Technology—A New Clean Hydrogen Energy Source with the Potential for Direct Conversion to Electricity”, Proceedings of the National Hydrogen Association, 12th Annual U.S. Hydrogen Meeting and Exposition, Hydrogen: The Common Thread, The Washington Hilton and Towers, Washington D.C., (Mar. 6-8, 2001), pp. 671-697; R. Mills, W. Good, A. Voigt, Jinquan Dong, “Minimum Heat of Formation of Potassium Iodo Hydride”, Int. J. Hydrogen Energy, Vol. 26, No. 11, (2001), pp. 1199-1208; R. Mills, “Spectroscopic Identification of a Novel Catalytic Reaction of Atomic Hydrogen and the Hydride Ion Product”, Int. J. Hydrogen Energy, Vol. 26, No. 10, (2001), pp. 1041-1058; R. Mills, N. Greenig, S. Hicks, “Optically Measured Power Balances of Glow Discharges of Mixtures of Argon, Hydrogen, and Potassium, Rubidium, Cesium, or Strontium Vapor”, Int. J. Hydrogen Energy, Vol. 27, No. 6, (2002), pp. 651-670; R. Mills, “The Grand Unified Theory of Classical Quantum Mechanics”, Global Foundation, Inc. Orbis Scientiae entitled The Role of Attractive and Repulsive Gravitational Forces in Cosmic Acceleration of Particles The Origin of the Cosmic Gamma Ray Bursts, (29th Conference on High Energy Physics and Cosmology Since 1964) Dr. Behram N. Kursunoglu, Chairman, Dec. 14-17, 2000, Lago Mar Resort, Fort Lauderdale, Fla., Kluwer Academic/Plenum Publishers, New York, pp. 243-258; R. Mills, “The Grand Unified Theory of Classical Quantum Mechanics”, Int. J. Hydrogen Energy, Vol. 27, No. 5, (2002), pp. 565-590; R. Mills and M. Nansteel, P. Ray, “Argon-Hydrogen-Strontium Discharge Light Source”, IEEE Transactions on Plasma Science, Vol. 30, No. 2, (2002), pp. 639-653; R. Mills, B. Dhandapani, M. Nansteel, J. He, A. Voigt, “Identification of Compounds Containing Novel Hydride Ions by Nuclear Magnetic Resonance Spectroscopy”, Int. J. Hydrogen Energy, Vol. 26, No. 9, (2001), pp. 965-979; R. Mills, “BlackLight Power Technology—A New Clean Energy Source with the Potential for Direct Conversion to Electricity”, Global Foundation International Conference on “Global Warming and Energy Policy”, Dr. Behram N. Kursunoglu, Chairman, Fort Lauderdale, Fla., Nov. 26-28, 2000, Kluwer Academic/Plenum Publishers, New York, pp. 187-202; R. Mills, “The Nature of Free Electrons in Superfluid Helium—a Test of Quantum Mechanics and a Basis to Review its Foundations and Make a Comparison to Classical Theory”, Int. J. Hydrogen Energy, Vol. 26, No. 10, (2001), pp. 1059-1096; R. Mills, M. Nansteel, and P. Ray, “Excessively Bright Hydrogen-Strontium Plasma Light Source Due to Energy Resonance of Strontium with Hydrogen”, J. of Plasma Physics, Vol. 69, (2003), pp. 131-158; R. Mills, J. Dong, Y. Lu, “Observation of Extreme Ultraviolet Hydrogen Emission from Incandescently Heated Hydrogen Gas with Certain Catalysts”, Int. J. Hydrogen Energy, Vol. 25, (2000), pp. 919-943; R. Mills, “Observation of Extreme Ultraviolet Emission from Hydrogen-KI Plasmas Produced by a Hollow Cathode Discharge”, Int. J. Hydrogen Energy, Vol. 26, No. 6, (2001), pp. 579-592; R. Mills, “Temporal Behavior of Light-Emission in the Visible Spectral Range from a Ti-K2CO3-H-Cell”, Int. J. Hydrogen Energy, Vol. 26, No. 4, (2001), pp. 327-332; R. Mills, T. Onuma, and Y. Lu, “Formation of a Hydrogen Plasma from an Incandescently Heated Hydrogen-Catalyst Gas Mixture with an Anomalous Afterglow Duration”, Int. J. Hydrogen Energy, Vol. 26, No. 7, July, (2001), pp. 749-762; R. Mills, M. Nansteel, and Y. Lu, “Observation of Extreme Ultraviolet Hydrogen Emission from Incandescently Heated Hydrogen Gas with Strontium that Produced an Anomalous Optically Measured Power Balance”, Int. J. Hydrogen Energy, Vol. 26, No. 4, (2001), pp. 309-326; R. Mills, B. Dhandapani, N. Greenig, J. He, “Synthesis and Characterization of Potassium Iodo Hydride”, Int. J. of Hydrogen Energy, Vol. 25, Issue 12, December, (2000), pp. 1185-1203; R. Mills, “Novel Inorganic Hydride”, Int. J. of Hydrogen Energy, Vol. 25, (2000), pp. 669-683; R. Mills, B. Dhandapani, M. Nansteel, J. He, T. Shannon, A. Echezuria, “Synthesis and Characterization of Novel Hydride Compounds”, Int. J. of Hydrogen Energy, Vol. 26, No. 4, (2001), pp. 339-367; R. Mills, “Highly Stable Novel Inorganic Hydrides”, Journal of New Materials for Electrochemical Systems, Vol. 6, (2003), pp. 45-54; R. Mills, “Novel Hydrogen Compounds from a Potassium Carbonate Electrolytic Cell”, Fusion Technology, Vol. 37, No. 2, March, (2000), pp. 157-182; R. Mills, “The Hydrogen Atom Revisited”, Int. J. of Hydrogen Energy, Vol. 25, Issue 12, December, (2000), pp. 1171-1183; R. Mills, W. Good, “Fractional Quantum Energy Levels of Hydrogen”, Fusion Technology, Vol. 28, No. 4, November, (1995), pp. 1697-1719; R. Mills, W. Good, R. Shaubach, “Dihydrino Molecule Identification”, Fusion Technology, Vol. 25, (1994), pp. 103-119; R. Mills, S. Kneizys, Fusion Technol. Vol. 20, (1991), pp. 65-81; and in prior PCT applications PCT/US00/20820; PCT/US00/20819; PCT/US99/17171; PCT/US99/17129; PCT/US 98/22822; PCT/US98/14029; PCT/US96/07949; PCT/US94/02219; PCT/US91/08496; PCT/US90/01998; and prior U.S. patent application Ser. No. 09/225,687, filed on Jan. 6, 1999; Ser. No. 60/095,149, filed Aug. 3, 1998; Ser. No. 60/101,651, filed Sep. 24, 1998; Ser. No. 60/105,752, filed Oct. 26, 1998; Ser. No. 60/113,713, filed Dec. 24, 1998; Ser. No. 60/123,835, filed Mar. 11, 1999; Ser. No. 60/130,491, filed Apr. 22, 1999; Ser. No. 60/141,036, filed Jun. 29, 1999; Ser. No. 09/009,294 filed Jan. 20, 1998; Ser. No. 09/111,160 filed Jul. 7, 1998; Ser. No. 09/111,170 filed Jul. 7, 1998; Ser. No. 09/111,016 filed Jul. 7, 1998; Ser. No. 09/111,003 filed Jul. 7, 1998; Ser. No. 09/110,694 filed Jul. 7, 1998; Ser. No. 09/110,717 filed Jul. 7, 1998; Ser. No. 60/053,378 filed Jul. 22, 1997; Ser. No. 60/068,913 filed Dec. 29, 1997; Ser. No. 60/090,239 filed Jun. 22, 1998; Ser. No. 09/009,455 filed Jan. 20, 1998; Ser. No. 09/110,678 filed Jul. 7, 1998; Ser. No. 60/053,307 filed Jul. 22, 1997; Ser. No. 60/068,918 filed Dec. 29, 1997; Ser. No. 60/080,725 filed Apr. 3, 1998; Ser. No. 09/181,180 filed Oct. 28, 1998; Ser. No. 60/063,451 filed Oct. 29, 1997; Ser. No. 09/008,947 filed Jan. 20, 1998; Ser. No. 60/074,006 filed Feb. 9, 1998; Ser. No. 60/080,647 filed Apr. 3, 1998; Ser. No. 09/009,837 filed Jan. 20, 1998; Ser. No. 08/822,170 filed Mar. 27, 1997; Ser. No. 08/592,712 filed Jan. 26, 1996; Ser. No. 08/467,051 filed on Jun. 6, 1995; Ser. No. 08/416,040 filed on Apr. 3, 1995; Ser. No. 08/467,911 filed on Jun. 6, 1995; Ser. No. 08/107,357 filed on Aug. 16, 1993; Ser. No. 08/075,102 filed on Jun. 11, 1993; Ser. No. 07/626,496 filed on Dec. 12, 1990; Ser. No. 07/345,628 filed Apr. 28, 1989; Ser. No. 07/341,733 filed Apr. 21, 1989 the entire disclosures of which are all incorporated herein by reference (hereinafter “Mills Prior Publications”).

The binding energy of an atom, ion, or molecule, also known as the ionization energy, is the energy required to remove one electron from the atom, ion or molecule. A hydrogen atom having the binding energy given in Eq. (1) is hereafter referred to as a hydrino atom or hydrino. The designation for a hydrino of radius

$$\frac{{a}_{H}}{p} ,$$

where a_{H} is the radius of an ordinary hydrogen atom and p is an integer, is

$$H [ \frac{{a}_{H}}{p} ] .$$

A hydrogen atom with a radius a_{H} is hereinafter referred to as “ordinary hydrogen atom” or “normal hydrogen atom.” Ordinary atomic hydrogen is characterized by its binding energy of 13.6 eV.

Hydrinos are formed by reacting an ordinary hydrogen atom with a catalyst having a net enthalpy of reaction of about

m·27.2 eV (2a)

where m is an integer. This catalyst has also been referred to as an energy hole or source of energy hole in Mills earlier filed patent applications. It is believed that the rate of catalysis is increased as the net enthalpy of reaction is more closely matched to m·27.2 eV. It has been found that catalysts having a net enthalpy of reaction within ±10%, preferably ±5%, of m·27.2 eV are suitable for most applications.

In another embodiment, the catalyst to form hydrinos has a net enthalpy of reaction of about

m/2·227.2 eV (2b)

where m is an integer greater that one. It is believed that the rate of catalysis is increased as the net enthalpy of reaction is more closely matched to m/2·27.2 eV. It has been found that catalysts having a net enthalpy of reaction within ±10%, preferably ±5%, of m/2·27.2 eV are suitable for most applications.

A catalyst of the present invention may provide a net enthalpy of m·27.2 eV where m is an integer or m/2·27.2 eV where m is an integer greater than one by undergoing a transition to a resonant excited state energy level with the energy transfer from hydrogen. For example, He⁺ absorbs 40.8 eV during the transition from the n=1 energy level to the n=2 energy level which corresponds to 3/2·27.2 eV (m=3 in Eq. (2b)). This energy is resonant with the difference in energy between the p=2 and the p=1 states of atomic hydrogen given by Eq. (1). Thus He⁺ may serve as a catalyst to cause the transition between these hydrogen states.

A catalyst of the present invention may provide a net enthalpy of m·27.2 eV where m is an integer or m/2·27.2 eV where m is an integer greater than one by becoming ionized during resonant energy transfer. For example, the third ionization energy of argon is 40.74 eV; thus, Ar²⁺ absorbs 40.8 eV during the ionization to Ar³⁺ which corresponds to 3/2·27.2 eV (m=3 in Eq. (2b)). This energy is resonant with the difference in energy between the p=2 and the p=1 states of atomic hydrogen given by Eq. (1). Thus Ar²⁺ may serve as a catalyst to cause the transition between these hydrogen states.

This catalysis releases energy from the hydrogen atom with a commensurate decrease in size of the hydrogen atom, rₙ=na_{H}. For example, the catalysis of H(n=1) to H(n=1/2) releases 40.8 eV, and the hydrogen radius decreases from

$${a}_{H} to \frac{1}{2} {a}_{H} .$$

A catalytic system is provided by the ionization of t electrons from an atom each to a continuum energy level such that the sum of the ionization energies of the t electrons is approximately m×27.2 eV where m is an integer. One such catalytic system involves potassium metal. The first, second, and third ionization energies of potassium are 4.34066 eV, 31.63 eV, 45.806 eV, respectively [D. R. Lide, CRC Handbook of Chemistry and Physics, 78th Edition, CRC Press, Boca Raton, Fla., (1997), p. 10-214 to 10-216]. The triple ionization (t=3) reaction of K to K³⁺, then, has a net enthalpy of reaction of 81.7426 eV, which is equivalent to m=3 in Eq. (2a).

$$\begin{matrix}81.7426 eV + K ( m ) + H [ \frac{{a}_{H}}{p} ] -> {K}^{3 +} + 3 {e}^{-} + H [ \frac{{a}_{H}}{( p + 3 )} ] + [ {( p + 3 )}^{2} - {p}^{2} ] X 13.6 {eV K}^{3 +} + 3 {e}^{-} -> & ( 3 ) \\ K ( m ) + 81.7426 eV & ( 4 )\end{matrix}$$

And, the overall reaction is

$$H [ \frac{{a}_{H}}{p} ] -> H [ \frac{{a}_{H}}{( p + 3 )} ] + [ {( p + 3 )}^{2} - {p}^{2} ] X 13.6 eV \qquad ( 5 )$$

Rubidium ion (Rb⁺) is also a catalyst because the second ionization energy of rubidium is 27.28 eV. In this case, the catalysis reaction is

$$\begin{matrix}27.86 eV + {Rb}^{+} + H [ \frac{{a}_{H}}{p} ] -> {Rb}^{2 +} + {e}^{-} + H [ \frac{{a}_{H}}{( p + 1 )} ] + [ {( p + 1 )}^{2} - {p}^{2} ] X 13.6 eV & i . ( 6 ) \\ {Rb}^{2 +} + {e}^{-} -> {Rb}^{+} + 27.28 eV & ( 7 )\end{matrix}$$

And, the overall reaction is

$$H [ \frac{{a}_{H}}{p} ] -> H [ \frac{{a}_{H}}{( p + 1 )} ] + [ {( p + 1 )}^{2} - {p}^{2} ] X 13.6 eV \qquad ( 8 )$$

Strontium ion (Sr⁺) is also a catalyst since the second and third ionization energies of strontium are 11.03013 eV and 42.89 eV, respectively. The ionization reaction of Sr⁺ to Sr³⁺, (t=2), then, has a net enthalpy of reaction of 53.92 eV, which is equivalent to m=2 in Eq. (2a).

$$\begin{matrix}53.92 eV + {Sr}^{+} + H [ \frac{{a}_{H}}{p} ] -> {Sr}^{3 +} + 2 {e}^{-} + H [ \frac{{a}_{H}}{( p + 2 )} ] + [ {( p + 2 )}^{2} - {p}^{2} ] X 13.6 eV & ( 9 ) \\ {Sr}^{3 +} + 2 {e}^{-} -> {Sr}^{+} + 53.92 eV & ( 10 )\end{matrix}$$

And, the overall reaction is

$$H [ \frac{{a}_{H}}{p} ] -> H [ \frac{{a}_{H}}{( p + 2 )} ] + [ {( p + 2 )}^{2} - {p}^{2} ] X 13.6 eV \qquad ( 11 )$$

Helium ion (He⁺) is also a catalyst because the second ionization energy of helium is 54.417 eV. In this case, the catalysis reaction is

$$\begin{matrix}54.417 eV + {He}^{+} + H [ \frac{{a}_{H}}{p} ] -> {He}^{2 +} + {e}^{-} + H [ \frac{{a}_{H}}{( p + 2 )} ] + [ {( p + 2 )}^{2} - {p}^{2} ] X 13.6 eV & i . ( 12 ) \\ {He}^{2 +} + {e}^{-} -> {He}^{+} + 54.417 eV & ( 13 )\end{matrix}$$

And, the overall reaction is

$$H [ \frac{{a}_{H}}{p} ] -> H [ \frac{{a}_{H}}{( p + 2 )} ] + [ {( p + 2 )}^{2} - {p}^{2} ] X 13.6 eV \qquad ( 14 )$$

Argon ion is a catalyst. The second ionization energy is 27.63 eV.

$$\begin{matrix}27.63 eV + {Ar}^{+} + H [ \frac{{a}_{H}}{p} ] -> {Ar}^{2 +} + {e}^{-} + H [ \frac{{a}_{H}}{( p + 1 )} ] + [ {( p + 1 )}^{2} - {p}^{2} ] X 13.6 eV & i . ( 15 ) \\ {Ar}^{2 +} + {e}^{-} -> {Ar}^{+} + 24.63 eV & ( 16 )\end{matrix}$$

And, the overall reaction is

$$H [ \frac{{a}_{H}}{p} ] -> H [ \frac{{a}_{H}}{( p + .1 )} ] + [ {( p + 1 )}^{2} - {p}^{2} ] X 13.6 eV \qquad ( 17 )$$

A neon ion and a proton can also provide a net enthalpy of a multiple of that of the potential energy of the hydrogen atom. The second ionization energy of neon is 40.96 eV, and H⁺ releases 13.6 eV when it is reduced to H. The combination of reactions of Ne⁺ to Ne²⁺ and H⁺ to H, then, has a net enthalpy of reaction of 27.36 eV, which is equivalent to m=1 in Eq. (2a).

$$\begin{matrix}27.36 eV + {Ne}^{+} + {H}^{+} + H [ \frac{{a}_{H}}{p} ] -> H + {Ne}^{2 +} + H [ \frac{{a}_{H}}{( p + 1 )} ] + [ {( p + 1 )}^{2} - {p}^{2} ] X 13.6 eV & ( 18 ) \\ H + {Ne}^{2 +} -> {H}^{+} + {Ne}^{+} + 27.36 eV & ( 19 )\end{matrix}$$

And, the overall reaction is

$$H [ \frac{{a}_{H}}{p} ] -> H [ \frac{{a}_{H}}{( p + 1 )} ] + [ {( p + 1 )}^{2} - {p}^{2} ] X 13.6 eV \qquad ( 20 )$$

A neon ion can also provide a net enthalpy of a multiple of that of the potential energy of the hydrogen atom. Ne⁺ has an excited state Ne⁺* of 27.2 eV (46.5 nm) which provides a net enthalpy of reaction of 27.2 eV, which is equivalent to m=1 in Eq. (2a).

$$\begin{matrix}27.2 eV + {Ne}^{+} + H [ \frac{{a}_{H}}{p} ] -> {Ne}^{{+}^{*}} + H [ \frac{{a}_{H}}{( p + 1 )} ] + [ {( p + 1 )}^{2} - {p}^{2} ] X 13.6 eV & ( 21 ) \\ {Ne}^{{+}^{*}} -> {Ne}^{+} + 27.2 eV & ( 22 )\end{matrix}$$

And, the overall reaction is

$$H [ \frac{{a}_{H}}{p} ] -> H [ \frac{{a}_{H}}{( p + 1 )} ] + [ {( p + 1 )}^{2} - {p}^{2} ] X 13.6 eV \qquad ( 23 )$$

The first neon excimer continuum Ne₂* may also provide a net enthalpy of a multiple of that of the potential energy of the hydrogen atom. The first ionization energy of neon is 21.56454 eV, and the first neon excimer continuum Ne₂* has an excited state energy of 15.92 eV. The combination of reactions of Ne₂* to 2Ne⁺, then, has a net enthalpy of reaction of 27.21 eV, which is equivalent to m=1 in Eq. (2a).

$$\begin{matrix}27.21 eV + {Ne}_{2}^{*} + H [ \frac{{a}_{H}}{p} ] -> 2 {Ne}^{+} + H [ \frac{{a}_{H}}{( p + 1 )} ] + [ {( p + 1 )}^{2} - {p}^{2} ] X 13.6 eV & ( 24 ) \\ 2 {Ne}^{+} -> {Ne}_{2}^{*} + 27.21 eV & ( 25 )\end{matrix}$$

And, the overall reaction is

$$H [ \frac{{a}_{H}}{p} ] -> H [ \frac{{a}_{H}}{( p + 1 )} ] + [ {( p + 1 )}^{2} - {p}^{2} ] X 13.6 eV \qquad ( 26 )$$

Similarly for helium, the helium excimer continuum to shorter wavelengths He₂* may also provide a net enthalpy of a multiple of that of the potential energy of the hydrogen atom. The first ionization energy of helium is 24.58741 eV, and the helium excimer continuum He₂* has an excited state energy of 21.97 eV. The combination of reactions of He₂* to 2He⁺, then, has a net enthalpy of reaction of 27.21 eV, which is equivalent to m=1 in Eq. (2a).

$$\begin{matrix}27.21 eV + {He}_{2}^{*} + H [ \frac{{a}_{H}}{p} ] -> 2 {He}^{*} + H [ \frac{{a}_{H}}{( p + 1 )} ] + [ {( p + 1 )}^{2} - {p}^{2} ] X 13.6 eV & ( 27 ) \\ 2 {He}^{+} -> {He}_{2}^{*} + 27.21 eV & ( 28 )\end{matrix}$$

And, the overall reaction is

$$H [ \frac{{a}_{H}}{p} ] -> H [ \frac{{a}_{H}}{( p + 1 )} ] + [ {( p + 1 )}^{2} - {p}^{2} ] X 13.6 eV \qquad ( 29 )$$

Atomic hydrogen in sufficient concentration may serve as a catalyst since the ionization energy of hydrogen is 13.6 eV. Two atoms fulfill the catalyst criterion—a chemical or physical process with an enthalpy change equal to an integer multiple of 27.2 eV since together they ionize at 27.2 eV. Thus, the transition cascade for the pth cycle of the hydrogen-type atom,

$$H [ \frac{{a}_{H}}{p} ] ,$$

with two hydrogen atoms,

$$H [ \frac{{a}_{H}}{1} ] ,$$

as the catalyst is represented by

$$\begin{matrix}27.21 eV + 2 H [ \frac{{a}_{H}}{1} ] + H [ \frac{{a}_{H}}{p} ] -> 2 {H}^{+} + H [ \frac{{a}_{H}}{( p + 1 )} ] + [ {( p + 1 )}^{2} - {p}^{2} ] X 13.6 eV & ( 30 ) \\ 2 {H}^{+} + 2 {e}^{\_} -> 2 H [ \frac{{a}_{H}}{1} ] + 27.21 eV & ( 31 )\end{matrix}$$

And, the overall reaction is

$$H [ \frac{{a}_{H}}{p} ] -> H [ \frac{{a}_{H}}{( p + 1 )} ] + [ {( p + 1 )}^{2} - p ] X 13.6 eV \qquad ( 32 )$$

A nitrogen molecule can also provide a net enthalpy of a multiple of that of the potential energy of the hydrogen atom. The bond energy of the nitrogen molecule is 9.75 eV, and the first and second ionization energies of the nitrogen atom are 14.53414 eV and 29.6013 eV, respectively. The combination of reactions of N₂ to 2N and N to N²⁺, then, has a net enthalpy of reaction of 53.9 eV, which is equivalent to m=2 in Eq. (2a).

$$\begin{matrix}53.9 eV + {N}_{2} + H [ \frac{{a}_{H}}{p} ] -> N + {N}^{2 +} + H [ \frac{{a}_{H}}{( p + 2 )} ] + [ {( p + 2 )}^{2} - {p}^{2} ] X 13.6 eV & ( 33 ) \\ N + {N}^{2 +} -> {N}_{2} + 53.9 eV & ( 34 )\end{matrix}$$

And, the overall reaction is

$$H [ \frac{{a}_{H}}{p} ] -> H [ \frac{{a}_{H}}{( p + 2 )} ] + [ {( p + 2 )}^{2} - {p}^{2} ] X 13.6 eV \qquad ( 35 )$$

A carbon molecule can also provide a net enthalpy of a multiple of that of the potential energy of the hydrogen atom. The bond energy of the carbon molecule is 6.29 eV, and the first and through the sixth ionization energies of a carbon atom are 11.2603 eV, 24.38332 eV, 47.8878 eV, 64.4939 eV, and 392.087 eV, respectively. The combination of reactions of C₂ to 2C and C to C⁵⁺, then, has a net enthalpy of reaction of 546.40232 eV, which is equivalent to m=20 in Eq. (2a).

$$\begin{matrix}i . & \\ 546.4 eV + {C}_{2} + H [ \frac{{a}_{H}}{p} ] -> C + {C}^{5 +} + H [ \frac{{a}_{H}}{( p + 20 )} ] + [ {( p + 20 )}^{2} - {p}^{2} ] X 13.6 eV & ( 36 ) \\ C + {C}^{5 +} -> {C}_{2} + 545.4 eV & ( 37 )\end{matrix}$$

And, the overall reaction is

$$H [ \frac{{a}_{H}}{p} ] -> H [ \frac{{a}_{H}}{( p + 20 )} ] + [ {( p + 20 )}^{2} - {p}^{2} ] X 13.6 eV \qquad ( 38 )$$

An oxygen molecule can also provide a net enthalpy of a multiple of that of the potential energy of the hydrogen atom. The bond energy of the oxygen molecule is 5.165 eV, and the first and second ionization energies of an oxygen atom are 13.61806 eV and 35.11730 eV, respectively. The combination of reactions of O₂ to 2O and O to O²⁺, then, has a net enthalpy of reaction of 53.9 eV, which is equivalent to m=2 in Eq. (2a).

$$\begin{matrix}i . & \\ 53.9 eV + {O}_{2} + H [ \frac{{a}_{H}}{p} ] -> O + {O}^{2 +} + H [ \frac{{a}_{H}}{( p + 2 )} ] + [ {( p + 2 )}^{2} - {p}^{2} ] X 13.6 eV & ( 39 ) \\ O + {O}^{2 +} -> {O}_{2} + 53.9 eV & ( 40 )\end{matrix}$$

And, the overall reaction is

$$H [ \frac{{a}_{H}}{p} ] -> H [ \frac{{a}_{H}}{( p + 2 )} ] + [ {( p + 2 )}^{2} - {p}^{2} ] X 13.6 eV \qquad ( 41 )$$

An oxygen molecule can also provide a net enthalpy of a multiple of that of the potential energy of the hydrogen atom by an alternative reaction. The bond energy of the oxygen molecule is 5.165 eV, and the first through the third ionization energies of an oxygen atom are 13.61806 eV, 35.11730 eV, and 54.9355 eV, respectively. The combination of reactions of O₂ to 2O and O to O³⁺, then, has a net enthalpy of reaction of 108.83 eV, which is equivalent to m=4 in Eq. (2a).

$$\begin{matrix}i . & \\ 108.83 eV + {O}_{2} + H [ \frac{{a}_{H}}{p} ] -> O + {O}^{3 +} + H [ \frac{{a}_{H}}{( p + 4 )} ] + [ {( p + 4 )}^{2} - {p}^{2} ] X 13.6 eV & ( 42 ) \\ O + {O}^{3 +} -> {O}_{2} + 108.83 eV & ( 43 )\end{matrix}$$

And, the overall reaction is

$$H [ \frac{{a}_{H}}{p} ] -> H [ \frac{{a}_{H}}{( p + 4 )} ] + [ {( p + 4 )}^{2} - {p}^{2} ] X 13.6 eV \qquad ( 44 )$$

An oxygen molecule can also provide a net enthalpy of a multiple of that of the potential energy of the hydrogen atom by an alternative reaction. The bond energy of the oxygen molecule is 5.165 eV, and the first through the fifth ionization energies of an oxygen atom are 13.61806 eV, 35.11730 eV, 54.9355 eV, 77.41353 eV, and 113.899 eV, respectively. The combination of reactions of O₂ to 2O and O to O⁵⁺, then, has a net enthalpy of reaction of 300.15 eV, which is equivalent to m=11 in Eq. (2a).

$$\begin{matrix}i . & \\ 300.15 eV + {O}_{2} + H [ \frac{{a}_{H}}{p} ] -> O + {O}^{5 +} + H [ \frac{{a}_{H}}{( p + 11 )} ] + [ {( p + 11 )}^{2} - {p}^{2} ] X 13.6 eV & ( 45 ) \\ O + {O}^{5 +} -> {O}_{2} + 300.15 eV & ( 46 )\end{matrix}$$

And, the overall reaction is

$$H [ \frac{{a}_{H}}{p} ] -> H [ \frac{{a}_{H}}{( p + 11 )} ] + [ {( p + 11 )}^{2} - {p}^{2} ] X 13.6 eV \qquad ( 47 )$$

In addition to nitrogen, carbon, and oxygen molecules which are exemplary catalysts, other molecules may be catalysts according to the present invention wherein the energy to break the molecular bond and the ionization of t electrons from an atom from the dissociated molecule to a continuum energy level is such that the sum of the ionization energies of the t electrons is approximately m·27.2 eV where t and m are each an integer. The bond energies and the ionization energies may be found in standard sources such as D. R. Linde, CRC Handbook of Chemistry and Physics, 79th Edition, CRC Press, Boca Raton, Fla., (1999), p. 9-51 to 9-69 and David R. Linde, CRC Handbook of Chemistry and Physics, 79th Edition, CRC Press, Boca Raton, Fla., (1998-9), p. 10-175 to p. 10-177, respectively. Thus, further molecular catalysts which provide a positive enthalpy of m·27.2 eV to cause release of energy from atomic hydrogen may be determined by one skilled in the art.

Molecular hydrogen catalysts capable of providing a net enthalpy of reaction of approximately m×27.2 eV where m is an integer to produce hydrino whereby the molecular bond is broken and t electrons are ionized from a corresponding free atom of the molecule are given infra. The bonds of the molecules given in the first column are broken and the atom also given in the first column is ionized to provide the net enthalpy of reaction of m×27.2 eV given in the eleventh column where m is given in the twelfth column. The energy of the bond which is broken given by Linde [D. R. Lide, CRC Handbook of Chemistry and Physics, 79th Edition, CRC Press, Boca Raton, Fla., (1999), p. 9-51 to 9-69] which is herein incorporated by reference is given in the 2nd column, and the electrons which are ionized are given with the ionization potential (also called ionization energy or binding energy). The ionization potential of the n th electron of the atom or ion is designated by IPₙ and is given by Linde [D. R. Lide, CRC Handbook of Chemistry and Physics, 79th Edition, CRC Press, Boca Raton, Fla., (1998-9), p. 10-175 to p. 10-177] which is herein incorporated by reference. For example, the bond energy of the oxygen molecule, BE=5.165 eV, is given in the 2nd column, and the first ionization potential, IPₙ=13.61806 eV, and the second ionization potential, IP₂=35.11730 eV, are given in the third and fourth columns, respectively. The combination of reactions of O₂ to 2O and O to O²⁺, then, has a net enthalpy of reaction of 53.9 eV, as given in the eleventh column, and m=2 in Eq. (2a) as given in the twelfth column.

TABLE 1
Molecular Hydrogen Catalysts

| Catalyst | BE | IP1 | IP2 | IP3 | IP4 | IP5 | IP6 | IP7 | IP8 | Enthalpy | m |
|---|---|---|---|---|---|---|---|---|---|---|---|
| C₂/C | 6.26 | 11.2603 | 24.38332 | 47.8878 | 64.4939 | 392.087 | | | | 546.4 | 20 |
| N₂/N | 9.75 | 14.53414 | 29.6013 | | | | | | | 53.9 | 2 |
| O₂/O | 5.165 | 13.61806 | 35.11730 | | | | | | | 54.26 | 2 |
| O₂/O | 5.165 | 13.61806 | 35.11730 | 54.9355 | | | | | | 108.83 | 4 |
| O₂/O | 5.165 | 13.61806 | 35.11730 | 54.9355 | 77.41353 | 113.899 | | | | 300.15 | 11 |
| CO₂/O | 5.52 | 13.61806 | 35.11730 | | | | | | | 54.26 | 2 |
| CO₂/O | 5.52 | 13.61806 | 35.11730 | 54.9355 | | | | | | 109.19 | 4 |
| CO₂/O | 5.52 | 13.61806 | 35.11730 | 54.9355 | 77.41353 | 113.8990 | | | | 300.5 | 11 |
| NO₂/O | 3.16 | 13.61806 | 35.11730 | 54.9355 | 77.41353 | 113.8990 | | | | 298.14 | 11 |
| NO₃/O | 2.16 | 13.61806 | 35.11730 | 54.9355 | 77.41353 | 113.8990 | 138.1197 | | | 435.26 | 16 |

In an embodiment, a molecular catalyst such as nitrogen is combined with another catalyst such as He⁺ (Eqs. (12-14)) or Ar⁺ (Eqs. (15-17)). In an embodiment of a catalyst combination of argon and nitrogen, the percentage of nitrogen is within the range 1-10%. In an embodiment of a catalyst combination of argon and nitrogen, the source of hydrogen atoms is a hydrogen halide such as HF.

The energy given off during catalysis is much greater than the energy lost to the catalyst. The energy released is large as compared to conventional chemical reactions. For example, when hydrogen and oxygen gases undergo combustion to form water

$${H}_{2} ( g ) + \frac{1}{2} {O}_{2} ( g ) -> {H}_{2} O ( l ) \qquad ( 48 )$$

the known enthalpy of formation of water is ΔH_{f}=−286 kJ/mole or 1.48 eV per hydrogen atom. By contrast, each (n=1) ordinary hydrogen atom undergoing catalysis releases a net of 40.8 eV. Moreover, further catalytic transitions may occur:

$$n = \frac{1}{2} -> \frac{1}{3} , \frac{1}{3} -> \frac{1}{4} , \frac{1}{4} -> \frac{1}{5} ,$$

and so on. Once catalysis begins, hydrinos autocatalyze further in a process called disproportionation. This mechanism is similar to that of an inorganic ion catalysis. But, hydrino catalysis should have a higher reaction rate than that of the inorganic ion catalyst due to the better match of the enthalpy to m·27.2 eV.

Dihydrino Molecular Ion Dihydrino Molecule, and Hydrino Hydride Ion

Novel emission lines with energies of q·13.6 eV where q=1, 2, 3, 4, 6, 7, 8, 9, or 11 were previously observed by extreme ultraviolet (EUV) spectroscopy recorded on microwave discharges of helium with 2% hydrogen [R. L. Mills, P. Ray, J. Phys. D, Applied Physics, Vol. 36, (2003), pp. 1535-1542]. These lines matched H(1/p), fractional Rydberg states of atomic hydrogen wherein

$$n = \frac{1}{2} , \frac{1}{3} , \frac{1}{4} , … , \frac{1}{p} ;$$

(p≦137 is an integer) replaces the well known parameter n=integer in the Rydberg equation for hydrogen excited states. Evidence supports that these states are formed by a resonant nonradiative energy transfer to He⁺ acting as a catalyst. Ar⁺ also serves as a catalyst to form H(1/p); whereas, krypton, xenon, and their ions serve as controls. H(1/p) may react with a proton and two H(1/p) may react to form H₂ (1/p) and H₂ (1/p), respectively. The hydrogen molecular ion and molecular charge and current density functions, bond distances, and energies were solved previously R. L. Mills, “The Nature of the Chemical Bond Revisited and an Alternative Maxwellian Approach”, Physics Essays, Vol. 17, No. 3, (2004), pp. 342-389] from the Laplacian in ellipsoidal coordinates with the constraint of nonradiation.

$$( η - ζ ) {R}_{ξ} \frac{\partial }{\partial ξ} ( {R}_{ξ} \frac{\partial φ}{\partial ξ} ) + ( ζ - ξ ) {R}_{η} \frac{\partial }{\partial η} ( {R}_{η} \frac{\partial φ}{\partial η} ) + ( ξ - η ) {R}_{ζ} \frac{\partial }{\partial ζ} ( {R}_{ζ} \frac{\partial φ}{\partial ζ} ) = 0 \qquad ( 49 )$$

The total energy of the hydrogen molecular ion having a central field of +pe at each focus of the prolate spheroid molecular orbital is

$$\begin{matrix}{E}_{T} = - {p}^{2} \{ \begin{matrix}\frac{{e}^{2}}{8 {πɛ}_{o} {a}_{H}} ( 4 ln 3 - 1 - 2 ln 3 ) \\ [ 1 + p \sqrt{\frac{2 ℏ \sqrt{\frac{\frac{2 {e}^{2}}{4 {{πɛ}_{o} ( 2 {a}_{H} )}^{3}}}{{m}_{e}}}}{{m}_{e} {c}^{2}}} ] - \frac{1}{2} ℏ \sqrt{\frac{k}{μ}}\end{matrix} \} \\ = - {p}^{2} 16.13392 eV - {p}^{3} 0.118755 eV\end{matrix} \qquad ( 50 )$$

where p is an integer, h is Planck's constant bar, mₑ is the mass of the electron, c is the speed of light in vacuum, μ is the reduced nuclear mass, and k is the harmonic force constant solved previously [R. L. Mills, “The Nature of the Chemical Bond Revisited and an Alternative Maxwellian Approach”, Physics Essays, Vol. 17, No. 3, (2004), pp. 342-389]. The total energy of the hydrogen molecule having a central field of +pe at each focus of the prolate spheroid molecular orbital is

$$\begin{matrix}{E}_{T} = - {p}^{2} \{ \begin{matrix}\frac{{e}^{2}}{8 {πɛ}_{o} {a}_{0}} [ ( 2 \sqrt{2} - \sqrt{2} + \frac{\sqrt{2}}{2} ) ln \frac{\sqrt{2} + 1}{\sqrt{2} - 1} - \sqrt{2} ] \\ [ 1 + p \sqrt{\frac{2 ℏ \sqrt{\frac{\frac{{e}^{2}}{4 {πɛ}_{o} {a}_{0}^{3}}}{{m}_{e}}}}{{m}_{e} {c}^{2}}} ] - \frac{1}{2} ℏ \sqrt{\frac{k}{μ}}\end{matrix} \} \\ = - {p}^{2} 31.351 eV - {p}^{3} 0.326469 eV\end{matrix} \qquad ( 51 )$$

where aₒ is the Bohr radius.

The bond dissociation energy E_{D} of hydrogen molecular ion H₂(1/p)⁺ is the difference between the total energy of the corresponding hydrogen atom H(1/p) and E_{T}:

E_{D}=E(H(1/p))−E_{T} (52)

where

E(H(1/p))=−p²13.59844 eV (53)

E_{D} is given by Eqs. (52-53) and Eq. (50):

$$\begin{matrix}{E}_{D} = - {p}^{2} 13.59844 - {E}_{T} \\ = {p}^{2} 13.59844 - ( - {p}^{2} 16.13392 eV - {p}^{3} 0.118755 eV ) \\ = {p}^{2} 2.535 eV + {p}^{3} 0.118755 eV\end{matrix} \qquad ( 54 )$$

The bond dissociation energy E_{D} of hydrogen molecule H₂(1/p) is the difference between the total energy of the corresponding hydrogen atoms and E_{T}

E_{D}=E(2H(1/p))−E_{T} (55)

where

E(2H(1/p))=−p²27.20 eV (56)

E_{D} is given by Eqs. (55-56) and (51):

$$\begin{matrix}{E}_{D} = - {p}^{2} 27.20 eV - {E}_{T} \\ = - {p}^{2} 27.20 eV - ( - {p}^{2} 31.351 eV - {p}^{3} 0.326469 eV ) \\ = {p}^{2} 4.151 eV + {p}^{3} 0.326469 eV\end{matrix} \qquad ( 57 )$$

The vibrational and rotational energies of fractional-Rydberg-state hydrogen molecular ion H₂(1/p) and molecular hydrogen H₂(1/p) are p² those of H₂⁺ and H₂, respectively. Thus, the vibrational energies E_{vib} for the ν=0 to ν=1 transition of hydrogen-type molecular ions H₂(1/p) are [R. L. Mills, “The Nature of the Chemical Bond Revisited and an Alternative Maxwellian Approach”, Physics Essays, Vol. 17, No. 3, (2004), pp. 342-389]

E_{vib}=p²0.271 eV (58)

where p is an integer and the experimental vibrational energy for the ν=0 to ν=1 transition of H₂⁺E_{H}_{₂}_{⁺}_{(ν=0→ν=1)} is given by Karplus and Porter [M. Karplus, R. N. Porter, Atoms and Molecules an Introduction for Students of Physical Chemistry, The Benjamin/Cummings Publishing Company, Menlo Park, Calif., (1970), pp. 447-484] and NIST [NIST Atomic Spectra Database, www.physics.nist.gov/cgi-bin/AtData/display.ksh]. Similarly, the rotational energies Eᵣₒₜ for the J to J+1 transition of hydrogen-type molecular ions H₂(1/p)⁺ are [R. L. Mills, “The Nature of the Chemical Bond Revisited and an Alternative Maxwellian Approach”, Physics Essays, Vol. 17, No. 3, (2004), pp. 342-389]

$${E}_{rot} = {E}_{J + 1} - {E}_{J} = \frac{{ℏ}^{2}}{I} [ J + 1 ] = {p}^{2} ( J + 1 ) 0.00739 eV \qquad ( 59 )$$

where p is an integer, I is the moment of inertia, and the experimental rotational energy for the J=0 to J=1 transition of H₂ is given by Atkins [P. W. Atkins, Physical Chemistry, Second Edition, W. H. Freeman, San Francisco, (1982), p. 589]. The vibrational energies E_{vib} for the ν=0 to ν=1 transition of hydrogen-type molecules H₂(1/p) are [R. L. Mills, Y. Lu, J. He, M. Nansteel, P. Ray, X. Chen, A. Voigt, B. Dhandapani, “Spectral Identification of New States of Hydrogen”, J. Phys. Chem. B, submitted]

E_{vib}=p²0.515902 eV (60)

where p is an integer and the experimental vibrational energy for the ν=0 to ν=1 transition of H₂ E_{H}_{₂}_{(ν=0→ν=1)} is given by Beutler [H. Beutler, Z. Physical Chem., “Die dissoziationswarme des wasserstoffmolekuls H2, aus einem neuen ultravioletten resonanzbandenzug bestimmt”, Vol. 27B, (1934), pp. 287-302] and Herzberg [G. Herzberg, L. L. Howe, “The Lyman bands of molecular hydrogen”, Can. J. Phys., Vol. 37, (1959), pp. 636-659].

The harmonic oscillator potential energy function can be expanded about the internuclear distance and expressed as a Maclaurin series corresponding to a Morse potential after Karplus and Porter (K&P) [M. Karplus, R. N. Porter, Atoms and Molecules an Introduction for Students of Physical Chemistry, The Benjamin/Cummings Publishing Company, Menlo Park, Calif., (1970), pp. 447-484] and after Eq. (96) of Ref. [R. L. Mills, Y. Lu, J. He, M. Nansteel, P. Ray, X. Chen, A. Voigt, B. Dhandapani, “Spectral Identification of New States of Hydrogen”, J. Phys. Chem. B, submitted]. Treating the Maclaurin series terms as anharmonic perturbation terms of the harmonic states, the energy corrections can be found by perturbation methods. The energy \tilde{v}_{ν} of state ν is

$$\begin{matrix}{\tilde{v}}_{υ} = {υω}_{0} - υ ( υ - 1 ) {ω}_{0} {x}_{0} , υ = 0 \text{,} 1 \text{,} 2 \text{,} 3 … \\ where & ( 61 ) \\ {ω}_{0} {x}_{0} = \frac{hc {ω}_{0}^{2}}{4 {D}_{0}} & ( 62 )\end{matrix}$$

From Eqs. (57), (60), and (62)

$$\begin{matrix}{ω}_{0} {x}_{0} = \frac{hc {ω}_{0}^{2}}{4 {D}_{0}} \\ = \frac{100 {hc ( 8.06573 X {10}^{3} \frac{{cm}^{- 1}}{eV} {p}^{2} 0.5159 eV )}^{2}}{4 e ( {p}^{2} 4.151 eV + {p}^{3} 0.326469 eV )} {cm}^{- 1}\end{matrix} \qquad ( 63 )$$

Using Eqs. (60-63) with p=1 gives

\tilde{v}_{ν}=ν4161 cm⁻¹−ν(ν−1)119.9 cm⁻¹

E_{vibν}=ν0.5159 eV−ν(ν−1)0.01486 eV, ν=0, 1, 2, 3 . . . (64)

where the calculated ω₀x₀=119.9 cm⁻¹ for H₂ is in agreement with the literature values of 117.91 cm⁻¹ from K&P and 121.34 cm⁻¹ from Lide [D. R. Lide, CRC Handbook of Chemistry and Physics, 79th Edition, CRC Press, Boca Raton, Fla., (1998-9), p. 9-82].

Similarly to H₂(1/p)⁺, the rotational energies Eᵣₒₜ for the J to J+1 transition of hydrogen-type molecules H₂(1/p) are [R. L. Mills, Y. Lu, J. He, M. Nansteel, P. Ray, X. Chen, A. Voigt, B. Dhandapani, “Spectral Identification of New States of Hydrogen”, J. Phys. Chem. B, submitted]

$${E}_{rot} = {E}_{J + 1} - {E}_{J} = \frac{{ℏ}^{2}}{I} [ J + 1 ] = {p}^{2} ( J + 1 ) 0.01509 eV \qquad ( 65 )$$

where p is an integer, I is the moment of inertia, and the experimental rotational energy for the J=0 to J=1 transition of H2 is given by Atkins [P. W. Atkins, Physical Chemistry, Second Edition, W. H. Freeman, San Francisco, (1982), p. 589].

The p² dependence of the rotational energies results from an inverse p dependence of the internuclear distance and the corresponding impact on I. The predicted internuclear distances 2c′ for H₂(1/p)⁺ and H₂(1/p) are

$$\begin{matrix}2 {c}^{′} = \frac{2 {a}_{o}}{p} \\ and & ( 66 ) \\ 2 {c}^{′} = \frac{{a}_{o} \sqrt{2}}{p} & ( 67 )\end{matrix}$$

respectively.

The rotational energies provide a very precise measure of I and the internuclear distance using well established theory [M. Karplus, R. N. Porter, Atoms and Molecules an Introduction for Students of Physical Chemistry, The Benjamin/Cummings Publishing Company, Menlo Park, Calif., (1970), pp. 447-484]. Neutral molecular emission was anticipated for high pressure argon-hydrogen plasmas excited by a 15 keV electron beam. Rotational lines for H₂(¼) were anticipated and sought in the 150-250 nm region. The spectral lines were compared to those predicted by Eqs. (60) and (65) corresponding to the internuclear distance of ¼ that of H₂ given by Eq. (67). The predicted energies for the ν=1→ν=0 vibration-rotational series of H₂(¼) (Eqs. (60) and (65)) are

$$\begin{matrix}{E}_{vib \text{-} rot} = {p}^{2} {E}_{vib {H}_{2} ( υ = 0 -> υ = 1 )} \pm {p}^{2} ( J + 1 ) {E}_{rot {H}_{2}} \\ = {4}^{2} {E}_{vib {H}_{2} ( υ = 0 -> υ = 1 )} \pm {4}^{2} ( J + 1 ) {E}_{rot {H}_{2}} \\ = 8.254432 eV \pm ( J + 1 ) 0.24144 eV ,\end{matrix} \\ J = 0 \text{,} 1 \text{,} 2 \text{,} 3 … \qquad ( 69 )$$

for p=4. Rotational lines were observed in the 145-300 nm region from atmospheric pressure electron-beam excited argon-hydrogen plasmas. The unprecedented energy spacing of 4² times that of hydrogen established the internuclear distance as ¼ that of H₂ and identified H₂(¼) [R. L. Mills, Y. Lu, J. He, M. Nansteel, P. Ray, X. Chen, A. Voigt, B. Dhandapani, “Spectral Identification of New States of Hydrogen”, J. Phys. Chem. B, submitted].

The product H₂(1/p) gas was isolated by liquefaction at liquid nitrogen temperature. Helium-hydrogen (90/10%) plasma gases were flowed through a high-vacuum (10⁻⁶ Torr) capable, liquid nitrogen (LN) cryotrap, and the condensed gas was characterized by ¹H nuclear magnetic resonance (NMR) of the LN-condensable gas dissolved in CDCl₃. Other sources of hydrogen such as hydrocarbons were eliminated by mass spectroscopy (MS) and Fourier transform infrared spectroscopy (FTIR). The ¹H NMR resonance of H₂(1/p) is predicted to be upfield from that of H₂ due to the fractional radius in elliptic coordinates wherein the electrons are significantly closer to the nuclei. The predicted shift

$$\frac{Δ {B}_{T}}{B}$$

for H₂(1/p) derived previously ['03 Mills GUT Chp. 12 and R. L. Mills, “The Nature of the Chemical Bond Revisited and an Alternative Maxwellian Approach”, Physics Essays, Vol. 17, No. 3, (2004), pp. 342-389] is given by the sum of that of H₂ and a relativistic term that depends on p>1:

$$\begin{matrix}\frac{Δ {B}_{T}}{B} = - {μ}_{0} ( 4 - \sqrt{2} ln \frac{\sqrt{2} + 1}{\sqrt{2} - 1} ) \frac{{e}^{2}}{36 {a}_{0} {m}_{e}} ( 1 + π α p ) & ( 70 ) \\ \frac{Δ {B}_{T}}{B} = - ( 28.01 + 0.64 p ) ppm & ( 71 )\end{matrix}$$

where p=0 for H₂ since there is no relativistic effect and p=integer>1 for H₂(1/p).

In addition to liquefaction at liquid nitrogen temperature, H₂(1/p) gas was also isolated by decomposition of compounds found to contain the corresponding hydride ions H₂(1/p). The total shift

$$\frac{Δ {B}_{T}}{B}$$

was calculated previously ['03 Mills GUT, Chp. 7, and R. Mills, P. Ray, B. Dhandapani, W. Good, P. Jansson, M. Nansteel, J. He, A. Voigt, “Spectroscopic and NMR Identification of Novel Hydride Ions in Fractional Quantum Energy States Formed by an Exothermic Reaction of Atomic Hydrogen with Certain Catalysts”, European Physical Journal-Applied Physics, submitted] for the hydride ions H⁻(1/p) having a fractional principal quantum number. The shift was given by the sum of that of ordinary hydride ion H⁻ and a component due to a relativistic effect:

$$\begin{matrix}\frac{Δ {B}_{T}}{B} = - {μ}_{0} \frac{{e}^{2}}{12 {m}_{e} {a}_{0} ( 1 + \sqrt{s ( s + 1 )} )} ( 1 + α2π p ) \\ = - ( 29.9 + 1.37 p ) ppm\end{matrix} \qquad ( 72 )$$

where p=0 for H⁻ since there is no relativistic effect and p=integer>1 for H⁻(1/p). The experimental absolute resonance shift of tetramethylsilane (TMS) is −31.5 ppm relative to the proton's gyromagnetic frequency. The results of ¹H MAS NMR spectroscopy were given previously [R. Mills, P. Ray, B. Dhandapani, W. Good, P. Jansson, M. Nansteel, J. He, A. Voigt, “Spectroscopic and NMR Identification of Novel Hydride Ions in Fractional Quantum Energy States Formed by an Exothermic Reaction of Atomic Hydrogen with Certain Catalysts”, European Physical Journal-Applied Physics, submitted; R. Mills, B. Dhandapani, M. Nansteel, J. He, T. Shannon, A. Echezuria, “Synthesis and Characterization of Novel Hydride Compounds”, Int. J. of Hydrogen Energy, Vol. 26, No. 4, (2001), pp. 339-367; R. Mills, B. Dhandapani, N. Greenig, J. He, “Synthesis and Characterization of Potassium Iodo Hydride”, Int. J. of Hydrogen Energy, Vol. 25, Issue 12, December, (2000), pp. 1185-1203; R. Mills, B. Dhandapani, M. Nansteel, J. He, A. Voigt, “Identification of Compounds Containing Novel Hydride Ions by Nuclear Magnetic Resonance Spectroscopy”, Int. J. Hydrogen Energy, Vol. 26, No. 9, (2001), pp. 965-979] on control and novel hydrides synthesized using atomic potassium as a hydrogen catalyst wherein the triple ionization reaction of K to K³⁺, has a net enthalpy of reaction of 81.7766 eV, which is equivalent to 3·27.2 eV. The KH experimental shift of +1.3 ppm relative to TMS corresponding to absolute resonance shift of −30.2 ppm matched very well the predicted shift of H⁻ of −30 ppm given by Eq. (72). The ¹H MAS NMR spectrum of novel compound KH*Cl relative to external tetramethylsilane (TMS) showed a large distinct upfield resonance at −4.4 ppm corresponding to an absolute resonance shift of −35.9 ppm that matched the theoretical prediction of p=4. A novel peak of KH*I at −1.5 ppm relative to TMS corresponding to an absolute resonance shift of −33.0 ppm matched the theoretical prediction of p=2. The predicted catalyst reactions, position of the upfield-shifted NMR peaks, and spectroscopic data for H⁻(½) and H⁻(¼) were found to be in agreement [R. L. Mills, “The Nature of the Chemical Bond Revisited and an Alternative Maxwellian Approach”, Physics Essays, Vol. 17, No. 3, (2004), pp. 342-389; R. Mills, P. Ray, B. Dhandapani, W. Good, P. Jansson, M. Nansteel, J. He, A. Voigt, “Spectroscopic and NMR Identification of Novel Hydride Ions in Fractional Quantum Energy States Formed by an Exothermic Reaction of Atomic Hydrogen with Certain Catalysts”, European Physical Journal-Applied Physics, submitted; '03 Mills GUT, Chp. 7].

The decomposition reaction of H⁻(1/p) is

$$2 {M}^{+} {H}^{-} ( 1 / p ) {}^{Δ} {H}_{2} ( 1 / p ) + 2 M \qquad ( 73 )$$

where M⁺ is a metal ion. NMR peaks of H₂(1/p) given by Eqs. (70-71) provide a direct test of whether compounds such as KH*I contain hydride ions in the same fractional quantum state p. Furthermore, the observation of a series of singlet peaks upfield of H₂ with a predicted integer spacing of 0.64 ppm provides a powerful means to confirm the existence of H₂(1/p).
H₂(1/p) gas isolated by liquefaction at liquid nitrogen temperature and by decomposition of compounds found to contain the corresponding hydride ions H⁻(1/p) was dissolved in CDCl₃ and characterized by ¹H NMR. Considering solvent effects, singlet peaks upfield of H₂ were observed with a predicted integer spacing of 0.64 ppm at 3.47, 3.03, 2.18, 1.25, 0.85, and 0.22 ppm which matched the consecutive series H₂(½), H₂(⅓), H₂(¼), H₂(⅕), H₂(⅙), and H₂( 1/7), respectively.

The exothermic helium plasma catalysis of atomic hydrogen was shown previously [R. L. Mills, P. Ray, B. Dhandapani, R. M. Mayo, J. He, “Comparison of Excessive Balmer a Line Broadening of Glow Discharge and Microwave Hydrogen Plasmas with Certain Catalysts”, J. of Applied Physics, Vol. 92, No. 12, (2002), pp. 7008-7022; R. L. Mills, P. Ray, B. Dhandapani, J. He, “Comparison of Excessive Balmer α Line Broadening of Inductively and Capacitively Coupled RF, Microwave, and Glow Discharge Hydrogen Plasmas with Certain Catalysts”, IEEE Transactions on Plasma Science, Vol. 31, No. (2003), pp. 338-355] by the observation of an average hydrogen atom temperature of 180-210 eV for helium-hydrogen mixed plasmas versus ≈3 eV for hydrogen alone. Since the electronic transitions are very energetic power balances of helium-hydrogen plasmas compared to control krypton plasmas were measured using water bath calorimetry. Excess power was absolutely measured from the helium-hydrogen plasma. For an input of 41.9 W, the total plasma power of the helium-hydrogen plasma measured by water bath calorimetry was 62.1 W corresponding to 20.2 W of excess power in 3 cm³ plasma volume. The excess power density and energy balance were high, 6.7 W/cm³ and −5.4×10⁴ kJ/mole H₂ (280 eV/H atom), respectively.

The hydrino hydride ion of the present invention can be formed by the reaction of an electron source with a hydrino, that is, a hydrogen atom having a binding energy of about

$$\frac{13.6 eV}{{n}^{2}} , where n = \frac{1}{p}$$

and p is an integer greater than 1. The hydrino hydride ion is represented by H⁻(n=1/p) or H⁻(1/p):

$$\begin{matrix}H [ \frac{{a}_{H}}{p} ] + {e}^{-} -> {H}^{-} ( n = 1 / p ) & ( 74 a ) \\ H [ \frac{{a}_{H}}{p} ] + {e}^{-} -> {H}^{-} ( 1 / p ) & ( 74 b )\end{matrix}$$

The hydrino hydride ion is distinguished from an ordinary hydride ion comprising an ordinary hydrogen nucleus and two electrons having a binding energy of about 0.8 eV. The latter is hereafter referred to as “ordinary hydride ion” or “normal hydride ion” The hydrino hydride ion comprises a hydrogen nucleus including proteum, deuterium, or tritium, and two indistinguishable electrons at a binding energy according to Eq. (75).

The binding energy of a novel hydrino hydride ion can be represented by the following formula:

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) \qquad ( 75 )$$

where p is an integer greater than one, s=1/2, π is pi, h is Planck's constant bar, μₒ is the permeability of vacuum, mₑ is the mass of the electron, μₑ is the reduced electron mass given by

$${μ}_{e} = \frac{{m}_{e} {m}_{p}}{\frac{{m}_{e}}{\sqrt{\frac{3}{4}}} + {m}_{p}}$$

where mₚ is the mass of the proton, a_{H} is the radius of the hydrogen atom, aₒ is the Bohr radius, and e is the elementary charge. The radii are given by

$${r}_{2} = {r}_{1} = {a}_{0} ( 1 + \sqrt{s ( s + 1 )} ) s = \frac{1}{2} \qquad ( 76 )$$

The binding energies of the hydrino hydride ion, H⁻(n=1/p) as a function of p, where p is an integer, are shown in TABLE 2.

TABLE 2
The representative binding energy of the hydrino hydride
ion H⁻(n = 1/p) as a function of p, Eq. (75).

| | r₁ | Binding | Wavelength |
|---|---|---|---|
| (a) Hydride Ion | a. (aₒ)^{a}Energy (eV)^{b} | | (nm) |
| H⁻(n = 1) | 1.8660 | 0.7542 | 1644 |
| H⁻(n = 1/2) | 0.9330 | 3.047 | 406.9 |
| H⁻(n = 1/3) | 0.6220 | 6.610 | 187.6 |
| H⁻(n = 1/4) | 0.4665 | 11.23 | 110.4 |
| H⁻(n = 1/5) | 0.3732 | 16.70 | 74.23 |
| H⁻(n = 1/6) | 0.3110 | 22.81 | 54.35 |
| H⁻(n = 1/7) | 0.2666 | 29.34 | 42.25 |
| H⁻(n = 1/8) | 0.2333 | 36.09 | 34.46 |
| H⁻(n = 1/9) | 0.2073 | 42.84 | 28.94 |
| H⁻(n = 1/10) | 0.1866 | 49.38 | 25.11 |
| H⁻(n = 1/11) | 0.1696 | 55.50 | 22.34 |
| H⁻(n = 1/12) | 0.1555 | 60.98 | 20.33 |
| H⁻(n = 1/13) | 0.1435 | 65.63 | 18.89 |
| H⁻(n = 1/14) | 0.1333 | 69.22 | 17.91 |
| H⁻(n = 1/15) | 0.1244 | 71.55 | 17.33 |
| H⁻(n = 1/16) | 0.1166 | 72.40 | 17.12 |
| H⁻(n = 1/17) | 0.1098 | 71.56 | 17.33 |
| H⁻(n = 1/18) | 0.1037 | 68.83 | 18.01 |
| H⁻(n = 1/19) | 0.0982 | 63.98 | 19.38 |
| H⁻(n = 1/20) | 0.0933 | 56.81 | 21.82 |
| H⁻(n = 1/21) | 0.0889 | 47.11 | 26.32 |
| H⁻(n = 1/22) | 0.0848 | 34.66 | 35.76 |
| H⁻(n = 1/23) | 0.0811 | 19.26 | 64.36 |
| H⁻(n = 1/24) | 0.0778 | 0.6945 | 1785 |

^{a}Eq. (76)
^{b}Eq. (75)

The existence of novel alkaline and alkaline earth hydride and halido-hydrides were also previously identified by large distinct upfield ¹H NMR resonances compared to the NMR peaks of the corresponding ordinary hydrides [R. Mills, B. Dhandapani, M. Nansteel, J. He, T. Shannon, A. Echezuria, “Synthesis and Characterization of Novel Hydride Compounds”, Int. J. of Hydrogen Energy, Vol. 26, No. 4, (2001), pp. 339-367; R. Mills, B. Dhandapani, N. Greenig, J. He, “Synthesis and Characterization of Potassium Iodo Hydride”, Int. J. of Hydrogen Energy, Vol. 25, Issue 12, December, (2000), pp. 1185-1203; R. Mills, B. Dhandapani, M. Nansteel, J. He, A. Voigt, “Identification of Compounds Containing Novel Hydride Ions by Nuclear Magnetic Resonance Spectroscopy”, Int. J. Hydrogen Energy, Vol. 26, No. 9, (2001), pp. 965-979.]. Using a number of analytical techniques such as XPS and time-of-flight-secondary-mass-spectroscopy (ToF-SIMS) as well as NMR, the hydrogen content was assigned to H⁻(1/p), novel high-binding-energy hydride ions in stable fractional principal quantum states [R. Mills, B. Dhandapani, M. Nansteel, J. He, T. Shannon, A. Echezuria, “Synthesis and Characterization of Novel Hydride Compounds”, Int. J. of Hydrogen Energy, Vol. 26, No. 4, (2001), pp. 339-367; R. Mills, B. Dhandapani, N. Greenig, J. He, “Synthesis and Characterization of Potassium Iodo Hydride”, Int. J. of Hydrogen Energy, Vol. 25, Issue 12, December, (2000), pp. 1185-1203; R. L. Mills, B. Dhandapani, J. He, “Highly Stable Amorphous Silicon Hydride”, Solar Energy Materials & Solar Cells, Vol. 80, No. 1, pp. 1-20]. The synthesis reactions typically involve metal ion catalysts. For example, Rb⁺ to Rb²⁺ and 2K⁺ to K⁺ K²⁺ each provide a reaction with a net enthalpy equal to the potential energy of atomic hydrogen. It was reported previously [R. L. Mills, P. Ray, “A Comprehensive Study of Spectra of the Bound-Free Hyperfine Levels of Novel Hydride Ion H⁻(½), Hydrogen, Nitrogen, and Air”, Int. J. Hydrogen Energy, Vol. 28, No. 8, (2003), pp. 825-871] that the presence of these gaseous ions with thermally dissociated hydrogen formed a hydrogen plasma with hydrogen atom energies of 17 and 12 eV respectively, compared to 3 eV for a hydrogen microwave plasma. The energetic catalytic reaction involves a resonance energy transfer between hydrogen atoms and Rb⁺ or 2K⁺ to form a very stable novel hydride ion H⁻(½). Its predicted binding energy of 3.0468 eV was observed by high resolution visible spectroscopy as a continuum threshold at 406.82 nm, and a structured, strong emission peak was observed at 407.1 nm corresponding to the fine structure and hyperfine structure of H(½). From the electron g factor, bound-free hyperfine structure lines of H⁻(½) were predicted with energies E_{HF} given by E_{HF}=j²3.00213×10⁻⁵+3.0563 eV (j is an integer) as an inverse Rydberg-type series from 3.0563 eV to 3.1012 eV—the hydride binding energy peak with the fine structure plus one and five times the spin-pairing energy, respectively. The high resolution visible plasma emission spectra in the region of 399.5 to 406.0 nm matched the predicted emission lines for j=1 to j=39 with the series edge at 399.63 nm up to 1 part in 10⁵.

Hydrogen Plasma

Developed sources that provide a suitable intensity hydrogen plasmas are high voltage discharges, synchrotron devices, inductively coupled plasma generators, and magnetically confined plasmas. In contrast to the high electric fields, power densities, and temperatures of prior sources, an intense hydrogen plasma is generated at low gas temperatures (e.g. ≈10³ K) with a very low field (1 V/cm) from atomic hydrogen and certain atomized elements or certain gaseous ions which singly or multiply ionize at integer multiples of the potential energy of atomic hydrogen, m·27.2 eV [R. Mills, J. Dong, Y. Lu, “Observation of Extreme Ultraviolet Hydrogen Emission from Incandescently Heated Hydrogen Gas with Certain Catalysts”, Int. J. Hydrogen Energy, Vol. 25, (2000), pp. 919-943 which is incorporated by reference]. The so-called resonant transfer or rt-plasma of one embodiment of the present invention forms by a resonant energy transfer mechanism involving the species providing a net enthalpy of a multiple of 27.2 eV and atomic hydrogen.

UV and EUV Laser

Lithography, the technique for manufacturing microelectronics semiconductor devices such as processors and memory chips, presently uses deep UV radiation at 193 nm from the ArF excimer laser. Future sources are F₂ lasers at 157 nm and perhaps H₂ lasers at 127 nm. Advancements in light sources are required in order to achieve the steady reduction in the size of integrated circuits. Only a free electron laser (FEL) with a minimum beam energy of 500 MeV appears suitable as a light source for the Next Generation Lithography (NGL) based on EUV lithography (13.5 nm) [J. E. Bjorkholm, “EUV lithography—the successor to optical lithography?”, Intel Technology Journal, Q3, (1998), pp. 1-8; K. Hesch, E. Pellegrin, R. Rossmanith, R. Steininger, V. Saile, J. Wust, G. Dattoli, A. Doria, G. Gallerano, L. Giannessi, P. Ottaviani, H. Moser, “Extreme ultraviolet (EUV) sources based on synchrotron radiation”, Proceedings of the 2001 Particle Accelerator Conference, Chicago, pp. 654-656]. The opportunity exists to replace a FEL that occupies the size of a large building with a table-top laser based on inversion of catalyst atomic or ion states wherein the catalytic reaction between atomic hydrogen and the catalyst pumps the exited states of the catalyst or ionized species of the catalyst as the reaction releases energy with the formation of atomic-hydrogen states with binding energies lower than those of uncatalyzed atomic hydrogen.

This invention comprises a laser based on the formation of an inverted population in an atom or ion of an element wherein at least one oxidation state of the element serves as a catalyst with atomic hydrogen to form states that are lower in energy than that of the n=1 state of having a binding energy of 13.6 eV. The invention comprises a power source that is at least one of an external source and a cell for the catalysis of atomic hydrogen to form novel hydrogen species and/or compositions of matter comprising new forms of hydrogen. In one embodiment, of a He⁺ laser, the emission is in the extreme ultraviolet (EUV). The catalyst laser has an application as a EUV light source for photolithography at short wavelengths.

### SUMMARY OF THE INVENTION

An object of the present invention is to generate laser light from an inverted population of a state formed form a hydrogen catalyst during the catalytic reaction of hydrogen atoms to energy states given by Eq. (1).

A further object of the present invention is generate short wavelength laser light such as visible, ultraviolet, extreme ultraviolet, and soft X-ray laser light form an inversion in a catalyst species.

Another objective of the present invention is to generate a plasma and a source of light such as high energy light such as visible, ultraviolet, extreme ultraviolet, and soft X-ray, and energetic particles via the catalysis of atomic hydrogen.

Another objective of the present invention is to generate a plasma and power and novel hydrogen species and compositions of matter comprising new forms of hydrogen via the catalysis of atomic hydrogen.

Another objective of the present invention is to form the inverted population due to at least one of input power and catalysis of atomic hydrogen to lower-energy states. In an embodiment, the inverted sate of the catalyst species is formed insitu due to the catalysis of atomic hydrogen, the catalysis cell serves as the laser cavity, and an inverted population may be formed due to at least one of catalysis of atomic hydrogen and input power.

Catalysis of Hydrogen to Form Novel Hydrogen Species and Compositions of Matter Comprising New Forms of Hydrogen

The above objectives and other objectives are achieved by the present invention comprising a pumping power source and hydrogen reactor. The power source and reactor comprises a cell for the catalysis of atomic hydrogen to form novel hydrogen species and compositions of matter comprising new forms of hydrogen. The novel hydrogen compositions of matter comprise:
(a) at least one neutral, positive, or negative hydrogen species (hereinafter “increased binding energy hydrogen species”) having a binding energy greater than the binding energy of the corresponding ordinary hydrogen species, or
   i. (ii) greater than the binding energy of any hydrogen species for which the corresponding ordinary hydrogen species is unstable or is not observed because the ordinary hydrogen species' binding energy is less than thermal energies at ambient conditions (standard temperature and pressure, STP), or is negative; and
(b) at least one other element. The compounds of the invention are hereinafter referred to as “increased binding energy hydrogen compounds”.

By “other element” in this context is meant an element other than an increased binding energy hydrogen species. Thus, the other element can be an ordinary hydrogen species, or any element other than hydrogen. In one group of compounds, the other element and the increased binding energy hydrogen species are neutral. In another group of compounds, the other element and increased binding energy hydrogen species are charged such that the other element provides the balancing charge to form a neutral compound. The former group of compounds is characterized by molecular and coordinate bonding; the latter group is characterized by ionic bonding.

Also provided are novel compounds and molecular ions comprising
(a) at least one neutral, positive, or negative hydrogen species (hereinafter “increased binding energy hydrogen species”) having a total energy greater than the total energy of the corresponding ordinary hydrogen species, or
   i. (ii) greater than the total energy of any hydrogen species for which the corresponding ordinary hydrogen species is unstable or is not observed because the ordinary hydrogen species' total energy is less than thermal energies at ambient conditions, or is negative; and
(b) at least one other element.

The total energy of the hydrogen species is the sum of the energies to remove all of the electrons from the hydrogen species. The hydrogen species according to the present invention has a total energy greater than the total energy of the corresponding ordinary hydrogen species. The hydrogen species having an increased total energy according to the present invention is also referred to as an “increased binding energy hydrogen species” even though some embodiments of the hydrogen species having an increased total energy may have a first electron binding energy less that the first electron binding energy of the corresponding ordinary hydrogen species. For example, the hydride ion of Eq. (75) for p=24 has a first binding energy that is less than the first binding energy of ordinary hydride ion, while the total energy of the hydride ion of Eq. (75) for p=24 is much greater than the total energy of the corresponding ordinary hydride ion.

Also provided are novel compounds and molecular ions comprising
(a) a plurality of neutral, positive, or negative hydrogen species (hereinafter “increased binding energy hydrogen species”) having a binding energy greater than the binding energy of the corresponding ordinary hydrogen species, or
   i. (ii) greater than the binding energy of any hydrogen species for which the corresponding ordinary hydrogen species is unstable or is not observed because the ordinary hydrogen species' binding energy is less than thermal energies at ambient conditions or is negative; and
(b) optionally one other element. The compounds of the invention are hereinafter referred to as “increased binding energy hydrogen compounds”.

The increased binding energy hydrogen species can be formed by reacting one or more hydrino atoms with one or more of an electron, hydrino atom, a compound containing at least one of said increased binding energy hydrogen species, and at least one other atom, molecule, or ion other than an increased binding energy hydrogen species.

Also provided are novel compounds and molecular ions comprising
(a) a plurality of neutral, positive, or negative hydrogen species (hereinafter “increased binding energy hydrogen species”) having a total energy greater than the total energy of ordinary molecular hydrogen, or
   i. (ii) greater than the total energy of any hydrogen species for which the corresponding ordinary hydrogen species is unstable or is not observed because the ordinary hydrogen species' total energy is less than thermal energies at ambient conditions or is negative; and
(b) optionally one other element. The compounds of the invention are hereinafter referred to as “increased binding energy hydrogen compounds”.

The total energy of the increased total energy hydrogen species is the sum of the energies to remove all of the electrons from the increased total energy hydrogen species. The total energy of the ordinary hydrogen species is the sum of the energies to remove all of the electrons from the ordinary hydrogen species. The increased total energy hydrogen species is referred to as an increased binding energy hydrogen species, even though some of the increased binding energy hydrogen species may have a first electron binding energy less than the first electron binding energy of ordinary molecular hydrogen. However, the total energy of the increased binding energy hydrogen species is much greater than the total energy of ordinary molecular hydrogen.

In one embodiment of the invention, the increased binding energy hydrogen species can be Hₙ, and Hₙ⁻ where n is a positive integer, or Hₙ⁺ where n is a positive integer greater than one. Preferably, the increased binding energy hydrogen species is Hₙ and Hₙ⁻ where n is an integer from one to about 1×10⁶, more preferably one to about 1×10⁴, even more preferably one to about 1×10², and most preferably one to about 10, and Hₙ⁺, where n is an integer from two to about 1×10⁶, more preferably two to about 1×10⁴, even more preferably two to about 1×10², and most preferably two to about 10. A specific example of Hₙ⁻ is H₁₆⁻.
(a) In an embodiment of the invention, the increased binding energy hydrogen species can be Hₙ^{m-} where n and m are positive integers and Hₙ^{m+} where n and m are positive integers with m<n. Preferably, the increased binding energy hydrogen species is Hₙ^{m-} where n is an integer from one to about 1×10⁶, more preferably one to about 1×10⁴, even more preferably one to about 1×10², and most preferably one to about 10 and m is an integer from one to 100, one to ten, and Hₙ^{m+} where n is an integer from two to about 1×10⁶, more preferably two to about 1×10⁴, even more preferably two to about 1×10², and most preferably two to about 10 and m is one to about 100, preferably one to ten.

According to a preferred embodiment of the invention, a compound is provided, comprising at least one increased binding energy hydrogen species selected from the group consisting of (a) hydride ion having a binding energy according to Eq. (75) that is greater than the binding of ordinary hydride ion (about 0.8 eV) for p=2 up to 23, and less for p=24 (“increased binding energy hydride ion” or “hydrino hydride ion”); (b) hydrogen atom having a binding energy greater than the binding energy of ordinary hydrogen atom (about 13.6 eV) (“increased binding energy hydrogen atom” or “hydrino”); (c) hydrogen molecule having a first binding energy greater than about 15.3 eV (“increased binding energy hydrogen molecule” or “dihydrino”); and (d) molecular hydrogen ion having a binding energy greater than about 16.3 eV (“increased binding energy molecular hydrogen ion” or “dihydrino molecular ion”).

The compounds of the present invention are capable of exhibiting one or more unique properties which distinguishes them from the corresponding compound comprising ordinary hydrogen, if such ordinary hydrogen compound exists. The unique properties include, for example, (a) a unique stoichiometry; (b) unique chemical structure; (c) one or more extraordinary chemical properties such as conductivity, melting point, boiling point, density, and refractive index; (d) unique reactivity to other elements and compounds; (e) enhanced stability at room temperature and above; and/or (f) enhanced stability in air and/or water. Methods for distinguishing the increased binding energy hydrogen-containing compounds from compounds of ordinary hydrogen include: 1.) elemental analysis, 2.) solubility, 3.) reactivity, 4.) melting point, 5.) boiling point, 6.) vapor pressure as a function of temperature, 7.) refractive index, 8.) X-ray photoelectron spectroscopy (XPS), 9.) gas chromatography, 10.) X-ray diffraction (XRD), 11.) calorimetry, 12.) infrared spectroscopy (IR), 13.) Raman spectroscopy, 14.) Mossbauer spectroscopy, 15.) extreme ultraviolet (EUV) emission and absorption spectroscopy, 16.) ultraviolet (UV) emission and absorption spectroscopy, 17.) visible emission and absorption spectroscopy, 18.) nuclear magnetic resonance spectroscopy, 19.) gas phase mass spectroscopy of a heated sample (solids probe and direct exposure probe quadrapole and magnetic sector mass spectroscopy), 20.) time-of-flight-secondary-ion-mass-spectroscopy (TOFSIMS), 21.) electrospray-ionization-time-of-flight-mass-spectroscopy (ESITOFMS), 22.) thermogravimetric analysis (TGA), 23.) differential thermal analysis (DTA), 24.) differential scanning calorimetry (DSC), 25.) liquid chromatography/mass spectroscopy (LCMS), and/or 26.) gas chromatography/mass spectroscopy (GCMS).

According to the present invention, a hydrino hydride ion (H⁻) having a binding energy according to Eq. (75) that is greater than the binding of ordinary hydride ion (about 0.8 eV) for p=2 up to 23, and less for p=24 (H⁻) is provided. For p=2 to p=24 of Eq. (75), the hydride ion binding energies are respectively 3, 6.6, 11.2, 16.7, 22.8, 29.3, 36.1, 42.8, 49.4, 55.5, 61.0, 65.6, 69.2, 71.6, 72.4, 71.6, 68.8, 64.0, 56.8, 47.1, 34.7, 19.3, and 0.69 eV. Compositions comprising the novel hydride ion are also provided.

Novel compounds are provided comprising one or more hydrino hydride ions and one or more other elements. Such a compound is referred to as a hydrino hydride compound.

Ordinary hydrogen species are characterized by the following binding energies (a) hydride ion, 0.754 eV (“ordinary hydride ion”); (b) hydrogen atom (“ordinary hydrogen atom”), 13.6 eV; (c) diatomic hydrogen molecule, 15.46 eV (“ordinary hydrogen molecule”); (d) hydrogen molecular ion, 16.3 eV (“ordinary hydrogen molecular ion”); and (e) H₃⁺, 22.6 eV (“ordinary trihydrogen molecular ion”). Herein, with reference to forms of hydrogen, “normal” and “ordinary” are synonymous.

According to a further preferred embodiment of the invention, a compound is provided comprising at least one increased binding energy hydrogen species such as (a) a hydrogen atom having a binding energy of about

$$\frac{13.6 eV}{{( \frac{1}{p} )}^{2}} ,$$

preferably within ±10%, more preferably ±5%, where p is an integer, preferably an integer from 2 to 200; (b) a hydride ion (H⁻) having a binding energy of about

$$\frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) ,$$

preferably within ±10%, more preferably ±5%, where p is an integer, preferably an integer from 2 to 200; (c) H₄⁺(1/p); (d) a trihydrino molecular ion, H₃⁺(1/p), having a binding energy of about

$$\frac{22.6}{{( \frac{1}{p} )}^{2}} eV$$

preferably within ±10%, more preferably ±5%, where p is an integer, preferably an integer from 2 to 200; (e) a dihydrino having a binding energy of about

$$\begin{matrix}{IP}_{1} = {E}_{T} ( {H}_{2}^{+} ( 1 / p ) ) - {E}_{T} ( {H}_{2} ( 1 / p ) ) \\ = - {p}^{2} 16.13392 eV - {p}^{3} 0.118755 eV - \\ ( - {p}^{2} 31.351 eV - {p}^{3} 0.326469 eV ) given in R . L . \\ = {p}^{2} 15.2171 eV + {p}^{3} 0.207714 eV\end{matrix}$$

Mills, “The Nature of the Chemical Bond Revisited and an Alternative Maxwellian Approach”, Physics Essays, Vol. 17, No. 3, (2004), pp. 342-389 which is herein incorporated by reference, preferably within ±10%, more preferably ±5%, where p is an integer, preferably and integer from 2 to 200; (f) a dihydrino molecular ion with a binding energy of about IP₂=p²16.13392 eV+p³0.118755 eV given in R. L. Mills, “The Nature of the Chemical Bond Revisited and an Alternative Maxwellian Approach”, Physics Essays, Vol. 17, No. 3, (2004), pp. 342-389 which is herein incorporated by reference, preferably within ±10%, more preferably ±5%, where p is an integer, preferably an integer from 2 to 200.

According to one embodiment of the invention wherein the compound comprises a negatively charged increased binding energy hydrogen species, the compound further comprises one or more cations, such as a proton, ordinary H₂⁺, or ordinary H₃⁺.

A method is provided for preparing compounds comprising at least one increased binding energy hydride ion. Such compounds are hereinafter referred to as “hydrino hydride compounds”. The method comprises reacting atomic hydrogen with a catalyst having a net enthalpy of reaction of about

$$\frac{m}{2} \cdot 27 eV ,$$

where m is an integer greater than 1, preferably an integer less than 400, to produce an increased binding energy hydrogen atom having a binding energy of about

$$\frac{13.6 eV}{{( \frac{1}{p} )}^{2}}$$

where p is an integer, preferably an integer from 2 to 200. A further product of the catalysis is energy. The increased binding energy hydrogen atom can be reacted with an electron source, to produce an increased binding energy hydride ion. The increased binding energy hydride ion can be reacted with one or more cations to produce a compound comprising at least one increased binding energy hydride ion.

Hydrogen Power and Plasma Cell and Reactor

The invention is also directed to a reactor for producing a increased binding energy hydrogen compounds of the invention, such as dihydrino molecules and hydrino hydride compounds. A further product of the catalysis is plasma, light, and power. Such a reactor is hereinafter referred to as a “hydrogen reactor” or “hydrogen cell”. The hydrogen reactor comprises a cell for making hydrinos. The cell for making hydrinos may take the form of a gas cell, a gas discharge cell, a plasma torch cell, or microwave power cell, for example. These exemplary cells which are not meant to be exhaustive are disclosed in Mills Prior Publications. Each of these cells comprises: a source of atomic hydrogen; at least one of a solid, molten, liquid, or gaseous catalyst for making hydrinos; and a vessel for reacting hydrogen and the catalyst for making hydrinos. As used herein and as contemplated by the subject invention, the term “hydrogen”, unless specified otherwise, includes not only proteum (¹H), but also deuterium (²H) and tritium (³H).

The reactors described herein as “hydrogen reactors” are capable of producing not only hydrinos, but also the other increased binding energy hydrogen species and compounds of the present invention. Hence, the designation “hydrogen reactors” should not be understood as being limiting with respect to the nature of the increased binding energy hydrogen species or compound produced.

According to one aspect of the present invention, novel compounds are formed from hydrino hydride ions and cations wherein the cell further comprises an electron source. Electrons from the electron source contact the hydrinos and react to form hydrino hydride ions. The reactor produces hydride ions having the binding energy of Eq. (75). The cation may be from an added reductant, or a cation present in the cell (such as a cation comprising the catalyst).

In an embodiment, a plasma forms in the hydrogen cell as a result of the energy released from the catalysis of hydrogen. Water vapor may be added to the plasma to increase the hydrogen concentration as shown by Kikuchi et al. [J. Kikuchi, M. Suzuki, H. Yano, and S. Fujimura, Proceedings SPIE—The International Society for Optical Engineering, (1993), 1803 (Advanced Techniques for Integrated Circuit Processing II), pp. 70-76] which is herein incorporated by reference.

Catalysts

Atom and Ion Catalysts

In an embodiment, a catalytic system is provided by the ionization of t electrons from a participating species such as an atom, an ion, a molecule, and an ionic or molecular compound to a continuum energy level such that the sum of the ionization energies of the t electrons is approximately m×27.2 eV where m is an integer. One such catalytic system involves cesium. The first and second ionization energies of cesium are 3.89390 eV and 23.15745 eV, respectively. The double ionization (t=2) reaction of Cs to Cs²⁺, then, has a net enthalpy of reaction of 27.05135 eV, which is equivalent to m=1 in Eq. (2a).

$$\begin{matrix}27.05135 eV + Cs ( m ) + H [ \frac{{a}_{H}}{p} ] -> {Cs}^{2 +} + 2 {e}^{-} + H [ \frac{{a}_{H}}{( p + 1 )} ] + [ {( p + 1 )}^{2} - {p}^{2} ] X 13.6 eV & ( 77 ) \\ {Cs}^{2 +} + 2 {e}^{-} -> Cs ( m ) + 27.05135 eV & ( 78 )\end{matrix}$$

And, the overall reaction is

$$H [ \frac{{a}_{H}}{p} ] -> H [ \frac{{a}_{H}}{( p + 1 )} ] + [ {( p + 1 )}^{2} - {p}^{2} ] X 13.6 eV \qquad ( 79 )$$

Thermal energies may broaden the enthalpy of reaction. The relationship between kinetic energy and temperature is given by

$${E}_{kinetic} = \frac{3}{2} kT \qquad ( 80 )$$

For a temperature of 1200 K, the thermal energy is 0.16 eV, and the net enthalpy of reaction provided by cesium metal is 27.21 eV which is an exact match to the desired energy.

Hydrogen catalysts capable of providing a net enthalpy of reaction of approximately m×27.2 eV where m is an integer to produce hydrino whereby t electrons are ionized from an atom or ion are given infra. A further product of the catalysis is energy and plasma. The atoms or ions given in the first column are ionized to provide the net enthalpy of reaction of m×27.2 eV given in the tenth column where m is given in the eleventh column. The electrons which are ionized are given with the ionization potential (also called ionization energy or binding energy). The ionization potential of the n th electron of the atom or ion is designated by IPₙ and is given by Linde [D. R. Lide, CRC Handbook of Chemistry and Physics, 78th Edition, CRC Press, Boca Raton, Fla., (1997), p. 10-214 to 10-216] which is herein incorporated by reference. That is for example, Cs+3.89390 eV→Cs⁺+e⁻ and Cs⁺+23.15745 eV→Cs²⁺+e⁻. The first ionization potential, IP₁=3.89390 eV, and the second ionization potential, IP₂=23.15745 eV, are given in the second and third columns, respectively. The net enthalpy of reaction for the double ionization of Cs is 27.05135 eV as given in the tenth column, and m=1 in Eq. (2a) as given in the eleventh column.

| | | | | | | |
|---|---|---|---|---|---|---|
| Mo2+ | | 27.13 | | | 27.13 | 1 |
| Mo4+ | | | | 54.49 | 54.49 | 2 |
| In3+ | | | 54 | | 54 | 2 |
| Ar+ | 27.62967 | | | | 27.62967 | 1 |
| Sr+ | 11.03 | 42.89 | | | 53.92 | 2 |

In an embodiment, each of the catalysts Rb⁺, K⁺/K⁺, and Sr⁺ may be formed from the corresponding metal by ionization. The source of ionization may be UV light or a plasma. At least one of a source of UV light and a plasma may be provided by the catalysis of hydrogen with a one or more hydrogen catalysts given in TABLES 1 and 3. The catalysts may also be formed from the corresponding metal by reaction with hydrogen to form the corresponding alkali hydride or by ionization at a hot filament which may also serve to dissociate molecular hydrogen to atomic hydrogen. The hot filament may be a refractory metal such as tungsten or molybdenum operated within a high temperature range such as 1000 to 2800° C.

A catalyst of the present invention can be an increased binding energy hydrogen compound having a net enthalpy of reaction of about

$$\frac{m}{2} \cdot 27 eV ,$$

where m is an integer greater than 1, preferably an integer less than 400, to produce an increased binding energy hydrogen atom having a binding energy of about

$$\frac{13.6 eV}{{( \frac{1}{p} )}^{2}}$$

where p is an integer, preferably an integer from 2 to 200.

In another embodiment of the catalyst of the present invention, hydrinos are formed by reacting an ordinary hydrogen atom with a catalyst having a net enthalpy of reaction of about

$$\frac{m}{2} \cdot 27.2 eV \qquad ( 81 )$$

where m is an integer. It is believed that the rate of catalysis is increased as the net enthalpy of reaction is more closely matched to

$$\frac{m}{2} \cdot 27.2 eV .$$

It has been found that catalysts having a net enthalpy of reaction within ±10% preferably ±5%, of

$$\frac{m}{2} \cdot 27.2 eV$$

are suitable for most applications.

In an embodiment, catalysts are identified by the formation of a rt-plasma at low voltage as described in Mills publication R. Mills, J. Dong, Y. Lu, “Observation of Extreme Ultraviolet Hydrogen Emission from Incandescently Heated Hydrogen Gas with Certain Catalysts”, Int. J. Hydrogen Energy, Vol. 25, (2000), pp. 919-943 which is incorporated by reference. In another embodiment, a means of identifying catalysts and monitoring the catalytic rate comprises a high resolution visible spectrometer with resolution preferable in the range 1 to 0.01 Å. The identity of a catalysts and the rate of catalysis may be determined by the degree of Doppler broadening of the hydrogen Balmer lines.

### Hydrino Catalysts

In a process called disproportionation, lower-energy hydrogen atoms, hydrinos, can act as catalysts because each of the metastable excitation, resonance excitation, and ionization energy of a hydrino atom is m×27.2 eV. The transition reaction mechanism of a first hydrino atom affected by a second hydrino atom involves the resonant coupling between the atoms of m degenerate multipoles each having 27.21 eV of potential energy [Mills, The Grand Unified Theory of Classical Quantum Mechanics, September 2006 Edition, Chps. 5 and 6, BlackLight Power, Inc., Cranbury, N.J., Distributed by Amazon.com; R. Mills, P. Ray, “Spectral Emission of Fractional Quantum Energy Levels of Atomic Hydrogen from a Helium-Hydrogen Plasma and the Implications for Dark Matter”, Int. J. Hydrogen Energy, Vol. 27, No. 3, pp. 301-322]. The energy transfer of m×27.2 eV from the first hydrino atom to the second hydrino atom causes the central field of the first atom to increase by m and its electron to drop m levels lower from a radius of

$$\frac{{a}_{H}}{p}$$

to a radius of

$$\frac{{a}_{H}}{p + m} .$$

The second interacting lower-energy hydrogen is either excited to a metastable state, excited to a resonance state, or ionized by the resonant energy transfer. The resonant transfer may occur in multiple stages. For example, a nonradiative transfer by multipole coupling may occur wherein the central field of the first increases by m, then the electron of the first drops m levels lower from a radius of

$$\frac{{a}_{H}}{p}$$

to a radius of

$$\frac{{a}_{H}}{p + m}$$

with further resonant energy transfer. The energy transferred by multipole coupling may occur by a mechanism that is analogous to photon absorption involving an excitation to a virtual level. Or, the energy transferred by multipole coupling during the electron transition of the first hydrino atom may occur by a mechanism that is analogous to two photon absorption involving a first excitation to a virtual level and a second excitation to a resonant or continuum level [B. J. Thompson, Handbook of Nonlinear Optics, Marcel Dekker, Inc., New York, (1996), pp. 497-548; Y. R. Shen, The Principles of Nonlinear Optics, John Wiley & Sons, New York, (1984), pp. 203-210; B. de Beauvoir, F. Nez, L. Julien, B. Cagnac, F. Biraben, D. Touahri, L. Hilico, O. Acef, A. Clairon, and J. J. Zondy, Physical Review Letters, Vol. 78, No. 3, (1997), pp. 440-443]. The transition energy greater than the energy transferred to the second hydrino atom may appear as a photon in a vacuum medium.

The transition of

$$H [ \frac{{a}_{H}}{p} ] to H [ \frac{{a}_{H}}{p + m} ]$$

induced by a multipole resonance transfer of m·27.21 eV and a transfer of [(p′)²−(p′−m′)²]×13.6 eV−m·27.2 eV with a resonance state of

$$H [ \frac{{a}_{H}}{{p}^{′} - {m}^{′}} ]$$

excited in

$$H [ \frac{{a}_{H}}{{p}^{′}} ]$$

is represented by

$$H ⌊ \frac{{a}_{H}}{{p}^{′}} ⌋ + H ⌊ \frac{{a}_{H}}{p} ⌋ -> H [ \frac{{a}_{H}}{{p}^{′} - {m}^{′}} ] + H [ \frac{{a}_{H}}{p + m} ] + [ ( {( p + m )}^{2} - {p}^{2} ) - ( {p}^{′2} - {( {p}^{′} - {m}^{′} )}^{2} ) ] X 13.6 eV \qquad ( 82 )$$

where p, p′, m, and m′ are integers.

Hydrinos may be ionized during a disproportionation reaction by the resonant energy transfer. A hydrino atom with the initial lower-energy state quantum number p and radius

$$\frac{{a}_{H}}{p}$$

may undergo a transition to the state with lower-energy state quantum number (p+m) and radius

$$\frac{{a}_{H}}{( p + m )}$$

by reaction with a hydrino atom with the initial lower-energy state quantum number m′, initial radius

$$\frac{{a}_{H}}{{m}^{′}} ,$$

and final radius a_{H} that provides a net enthalpy of m×27.2 eV. Thus, reaction of hydrogen-type atom,

$$H [ \frac{{a}_{H}}{p} ] ,$$

with the hydrogen-type atom,

$$H [ \frac{{a}_{H}}{{m}^{′}} ] ,$$

that is ionized by the resonant energy transfer to cause a transition reaction is represented by

$$\begin{matrix}mX 27.21 e V + H [ \frac{{a}_{H}}{{m}^{′}} ] + H ⌊ \frac{{a}_{H}}{p} ⌋ -> {H}^{+} + {e}^{-} + H [ \frac{{a}_{H}}{( p + m )} ] + [ {( p + m )}^{2} - {p}^{2} - ( {m}^{′2} - 2 m ) ] X 13.6 e V & ( 83 ) \\ {H}^{+} + {e}^{-} -> H [ \frac{{a}_{H}}{1} ] + 13.6 e V & ( 84 )\end{matrix}$$

And, the overall reaction is

$$H [ \frac{{a}_{H}}{{m}^{′}} ] + H ⌊ \frac{{a}_{H}}{p} ⌋ -> H [ \frac{{a}_{H}}{1} ] + H [ \frac{{a}_{H}}{( p + m )} ] + [ 2 pm + {m}^{2} - {m}^{′2} ] X 13.6 e V + 13.6 e V \qquad ( 85 )$$

Adjustment of Catalysis Rate

It is believed that the rate of catalysis is increased as the net enthalpy of reaction is more closely matched to m·27.2 eV where m is an integer. An embodiment of the hydrogen reactor for producing increased binding energy hydrogen compounds of the invention further comprises an electric or magnetic field source. The electric or magnetic field source may be adjustable to control the rate of catalysis. Adjustment of the electric or magnetic field provided by the electric or magnetic field source may alter the continuum energy level of a catalyst whereby one or more electrons are ionized to a continuum energy level to provide a net enthalpy of reaction of approximately m×27.2 eV. The alteration of the continuum energy may cause the net enthalpy of reaction of the catalyst to more closely match m·27.2 eV. Preferably, the electric field is within the range of 0.01-10⁶ V/m, more preferably 0.1-10⁴ V/m, and most preferably 1-10³ V/m. Preferably, the magnetic flux is within the range of 0.01-50 T. A magnetic field may have a strong gradient. Preferably, the magnetic flux gradient is within the range of 10⁻⁴-10² Tcm⁻¹ and more preferably 10⁻³-1 Tcm⁻¹.

In an embodiment, the electric field E and magnetic field B are orthogonal to cause an EXB electron drift. The EXB drift may be in a direction such that energetic electrons produced by hydrogen catalysis dissipate a minimum amount of power due to current flow in the direction of

the applied electric field which may be adjustable to control the rate of hydrogen catalysis.

In an embodiment of the energy cell, a magnetic field confines the electrons to a region of the cell such that interactions with the wall are reduced, and the electron energy is increased. The field may be a solenoidal field or a magnetic mirror field. The field may be adjustable to control the rate of hydrogen catalysis.

In an embodiment, the electric field such as a radio frequency field produces minimal current. In another embodiment, a gas which may be inert such as a noble gas is added to the reaction mixture to decrease the conductivity of the plasma produced by the energy released from the catalysis of hydrogen. The conductivity is adjusted by controlling the pressure of the gas to achieve an optimal voltage that controls the rate of catalysis of hydrogen. In another embodiment, a gas such as an inert gas may be added to the reaction mixture which increases the percentage of atomic hydrogen versus molecular hydrogen.

For example, the cell may comprise a hot filament that dissociates molecular hydrogen to atomic hydrogen and may further heat a hydrogen dissociator such as transition elements and inner transition elements, iron, platinum, palladium, zirconium, vanadium, nickel, titanium, Sc, Cr, Mn, Co, Cu, Zn, Y, Nb, Mo, Tc, Ru, Rh, Ag, Cd, La, Hf, Ta, W, Re, Os, Ir, Au, Hg, Ce, Pr, Nd, Pm, Sm, Eu, Gd, Tb, Dy, Ho, Er, Tm, Vb, Lu, Th, Pa, U, activated charcoal (carbon), and intercalated Cs carbon (graphite). The filament may further supply an electric field in the cell of the reactor. The electric field may alter the continuum energy level of a catalyst whereby one or more electrons are ionized to a continuum energy level to provide a net enthalpy of reaction of approximately m×27.2 eV. In another embodiment, an electric field is provided by electrodes charged by a variable voltage source. The rate of catalysis may be controlled by controlling the applied voltage which determines the applied field which controls the catalysis rate by altering the continuum energy level.

In another embodiment of the hydrogen reactor, the electric or magnetic field source ionizes an atom or ion to provide a catalyst having a net enthalpy of reaction of approximately m×27.2 eV. For examples, potassium metal is ionized to K⁺, rubidium metal is ionized to Rb⁺, or strontium metal is ionized to Sr⁺ to provide the catalyst. The electric field source may be a hot filament whereby the hot filament may also dissociate molecular hydrogen to atomic hydrogen.

The current from a hot filament or an electron gun may replace the electron deficit due to the higher electron mobility compared to ions. In addition, electrons are magnetized over ions at a lower field strength. Confinement of the electrons will also cause the plasma potential to return to the ground potential. In an embodiment, at least one of the electron replacement and electron confinement is controlled to control the plasma potential to control the rate of the hydrogen catalysis reaction. In an embodiment, the magnetic flux is in the range of about 1-100,000 G, preferably the flux is in the range of about 10-1000 G, more preferably the flux in the range of about 50-200 G, most preferably the flux is the range of about 50-150 G. The plasma potential is maintained at a desired potential of about neutral potential, positive, or negative. The plasma potential is controlled to optimize the rate of the catalysis of atomic hydrogen to states with energy levels given by Eq. (1). In an embodiment, the electron flow to the plasma is controlled by controlling the temperature of the filament or the current of the electron gun. Alternatively, the magnetic field strength is controlled The plasma potential may be measured with a probe such as a Langmuir probe, and a feedback loop of the electron flow and the electron confinement may maintain a desired plasma potential to cause a desired rate of hydrogen catalysis. In further embodiments, the catalysis rate is controlled by controlling the concentration of catalysis and atomic hydrogen. Plasma electrons have a higher mobility than plasma ions; thus the plasma typically acquires a net positive charge and the cell wall acquires a net negative charge. The catalysis rate may be increased by neutralizing the plasma or by providing a net negative charge to at least a portion of the plasma where catalyst and atomic hydrogen is present. In an embodiment of the hydrogen catalysis cell, the plasma has a net negative charge at least in a region where catalyst and atomic hydrogen is present. The negative charge may be provided by at least one of a source of electrons and a means to confine electrons. The means to confine electrons may be a magnetic field such as a magnetic bottle or a selenoidal field. The electron source may be an electron emitter such as a heated filament such as a thoriated W, rhenium, or BaO filament or an alkali (Group I) metal or an alkaline earth (Group II) metal. The source of electrons may be a thermionic cathode. The source of electrons may be an electron gun. Alternatively, the source of electrons may be an electron beam or a discharge electrode such as an anode. The electrons may preferentially be increased in a desired spatial region by an electric field. The electric field may be provided by electrodes. The negative charge may also be provided by a source of negatively charged ions such as hydride ions. In an embodiment, negative ions such as hydride ions are boiled from the surface of the wall of the reactor by maintaining the wall at an elevated temperature.

In a further embodiment of the hydrogen catalysis cell, the plasma has a net positive charge at least in a region where catalyst and atomic hydrogen is present. The positive charge may be provided by at least one of a source of ions and a means to confine ions. The means to confine ions may be a magnetic field such as a magnetic bottle or a selenoidal field. Alternatively, electrons may be confined in a region such that a desired region outside of the electron-rich region is positively charged. The means to confine electrons may be a magnetic field such as a magnetic bottle or a selenoidal field. The source of ions may be an ion beam or a discharge electrode such as a cathode. The ions may preferentially be increased in a desired spatial region by an electric field. The electric field may be provided by electrodes. The positive charge may also be provided by a source of positively charged ions such as a source of alkali (Group I) or alkaline earth (Group II) ions. In an embodiment, positive ions such as alkali or alkaline earth ions are boiled from the surface of the wall of the reactor by maintaining the wall at an elevated temperature. The positive ions may also be provided by boiling off electrons to a different region such that electron-emitting source acquires a net positive charge that positively charges the plasma. Such a source is a thermionic cathode.

The rt-plasma emission was experimentally found to be very strongly dependent on the strength of a weak external magnetic flux. With the application of 86 G, the argon-hydrogen ( 97/3%)-strontium rt-plasma emission showed a peak as a function of applied field with a maximum peak intensity of 150 times the baseline emission.

Noble Gas Catalysts

In an embodiment of the hydrogen power and plasma cell, reactor, and laser comprising an energy cell for the catalysis of atomic hydrogen to form novel hydrogen species and compositions of matter comprising new forms of hydrogen of the present invention, the catalyst comprises a mixture of a first catalyst and a source of a second catalyst. In an embodiment, the first catalyst produces the second catalyst from the source of the second catalyst. In an embodiment, the energy released by the catalysis of hydrogen by the first catalyst produces a plasma in the energy cell. The energy ionizes the source of the second catalyst to produce the second catalyst. The second catalyst may be one or more ions produced in the absence of a strong electric field as typically required in the case of a glow discharge. The weak electric field may increase the rate of catalysis of the second catalyst such that the enthalpy of reaction of the catalyst matches m×27.2 eV to cause hydrogen catalysis. In embodiments of the energy cell, the first catalyst is selected from the group of catalyst given in TABLES 1 and 3 such as potassium and strontium, the source of the second catalyst is selected from the group of helium and argon and the second catalyst is selected from the group of He⁺ and Ar⁺ wherein the catalyst ion is generated from the corresponding atom by a plasma created by catalysis of hydrogen by the first catalyst. For examples, 1.) the energy cell contains strontium and argon wherein hydrogen catalysis by strontium produces a plasma containing Ar⁺ which serves as a second catalyst (Eqs. (15-17)) and 2.) the energy cell contains potassium and helium wherein hydrogen catalysis by potassium produces a plasma containing He⁺ which serves as a second catalyst (Eqs. (12-14)). In an embodiment, the pressure of the source of the second catalyst is in the range of about 1 millitorr to about one atmosphere. The hydrogen pressure is in the range of about 1 millitorr to about one atmosphere. In a preferred embodiment, the total pressure is in the range of about 0.5 torr to about 2 torr. In an embodiment, the ratio of the pressure of the source of the second catalyst to the hydrogen pressure is greater than one. In a preferred embodiment, hydrogen is about 0.1% to about 99%, and the source of the second catalyst comprises the balance of the gas present in the cell. More preferably, the hydrogen is in the range of about 1% to about 5% and the source of the second catalyst is in the range of about 95% to about 99%. Most preferably, the hydrogen is about 5% and the source of the second catalyst is about 95%. These pressure ranges are representative examples and a skilled person will be able to practice this invention using a desired pressure to provide a desired result.

In an embodiment of the power cell and laser the catalyst comprises at least one selected from the group of Sr⁺, He⁺, Ne⁺, and Ar⁺ wherein the ionized catalyst ion is generated from the corresponding atom by a plasma created by methods such as a glow discharge or inductively couple microwave discharge. Preferably, the corresponding reactor such as a discharge cell or hydrogen plasma torch reactor has a region of low electric field strength such that the enthalpy of reaction of the catalyst matches m×27.2 eV to cause hydrogen catalysis. In one embodiment, the reactor is a discharge cell having a hollow anode as described by Kuraica and Konjevic [Kuraica, M., Konjevic, N., Physical Review A, Volume 46, No. 7, October (1992), pp. 4429-4432]. In another embodiment, the reactor is a discharge cell having a hollow cathode such as a central wire or rod anode and a concentric hollow cathode such as a stainless or nickel mesh. In a preferred embodiment, the cell is a microwave cell wherein the catalyst is formed by a microwave plasma.

Spontaneous-Emission Light Source and Light from Hydrogen Catalysis

Typically the emission of vacuum ultraviolet light from hydrogen gas is achieved using discharges at high voltage, synchrotron devices, high power inductively coupled plasma generators, or a plasma is created and heated to extreme temperatures by RF coupling (e.g. >10⁶ K) with confinement provided by a toroidal magnetic field. Observation of intense extreme ultraviolet (EUV) emission at low temperatures (e.g. ≈10³ K) from atomic hydrogen generated at a tungsten filament that heated a titanium dissociator and certain gaseous atom or ion catalysts of the present invention vaporized by filament heating has been reported previously [R. Mills, J. Dong, Y. Lu, “Observation of Extreme Ultraviolet Hydrogen Emission from Incandescently Heated Hydrogen Gas with Certain Catalysts”, Int. J. Hydrogen Energy, Vol. 25, (2000), pp. 919-943]. Potassium, cesium, and strontium atoms and Rb⁺ ionize at integer multiples of the potential energy of atomic hydrogen formed the low temperature, extremely low voltage plasma called a resonance transfer or rt-plasma having strong EUV emission. Similarly, the ionization energy of Ar⁺ is 27.63 eV, and the emission intensity of the plasma generated by atomic strontium increased significantly with the introduction of argon gas only when Ar⁺ emission was observed [R. Mills, “Spectroscopic Identification of a Novel Catalytic Reaction of Atomic Hydrogen and the Hydride Ion Product”, Int. J. Hydrogen Energy, Vol. 26, No. 10, (2001), pp. 1041-1058]. In contrast, the chemically similar atoms, sodium, magnesium and barium, do not ionize at integer multiples of the potential energy of atomic hydrogen did not form a plasma and caused no emission.

For further characterization, the width of the 656.3 nm Balmer a line emitted from microwave and glow discharge plasmas of hydrogen alone, strontium or magnesium with hydrogen, or helium, neon, argon, or xenon with 10% hydrogen was recorded with a high resolution visible spectrometer [R. L. Mills, P. Ray, B. Dhandapani, R. M. Mayo, J. He, “Comparison of Excessive Balmer a Line Broadening of Glow Discharge and Microwave Hydrogen Plasmas with Certain Catalysts”, J. of Applied Physics, Vol. 92, No. 12, (2002), pp. 7008-7022; R. L. Mills, P. Ray, B. Dhandapani, J. He, “Comparison of Excessive Balmer a Line Broadening of Inductively and Capacitively Coupled RF, Microwave, and Glow Discharge Hydrogen Plasmas with Certain Catalysts”, IEEE Transactions on Plasma Science, Vol. 31, No. (2003), pp. 338-355]. It was found that the strontium-hydrogen microwave plasma showed a broadening similar to that observed in the glow discharge cell of 27-33 eV; whereas, in both sources, no broadening was observed for magnesium-hydrogen. With noble-gas hydrogen mixtures, the trend of broadening with the particular noble gas was the same for both sources, but the magnitude of broadening was dramatically different. The microwave helium-hydrogen and argon-hydrogen plasmas showed extraordinary broadening corresponding to an average hydrogen atom temperature of 110-130 eV and 180-210 eV, respectively. The corresponding results from the glow discharge plasmas were 30-35 eV and 33-38 eV, respectively. Whereas, plasmas of pure hydrogen, neon-hydrogen, krypton-hydrogen, and xenon-hydrogen maintained in either source showed no excessive broadening corresponding to an average hydrogen atom temperature of 3 eV. Stark broadening or acceleration of charged species due to high fields (e.g. over 10 kV/cm) can not be invoked to explain the microwave results since no high field was observationally present. Rather, the results were explained by a resonant energy transfer between atomic hydrogen and atomic strontium, Ar⁺, or He²⁺ which ionize at an integer multiple of the potential energy of atomic hydrogen.

In a preferred embodiment, the source of light is from the spontaneous emission of excited states of the catalyst or species formed from the catalyst during the hydrogen catalytic reaction. In a further embodiment of the power cell, the catalysis of atomic hydrogen to lower-energy states produces a plasma and may also comprise a light source of at least one of extreme ultraviolet, ultraviolet, visible, infrared, microwave, or radio wave radiation.

A light source of the present invention comprises an emitting species, a cell, a power source, and a output window from the cell. The power input to create a plasma to initiate the catalyst reaction may be at least one of a particle beam such as an electron beam and microwave, high voltage, and RF discharges. The system to create a plasma to form atomic hydrogen and the catalyst may comprises an electron-beam-initiated, high-voltage pulsed discharge plasma of catalyst-hydrogen gases. In an embodiment, the power source that may at least partially comprise a cell for the catalysis of atomic hydrogen to form novel hydrogen species and/or compositions of matter comprising new forms of hydrogen, an increased-binding-energy-hydrogen species reactor. The reaction may be maintained by a particle beam, microwave, glow, or RF discharge plasma of a source of atomic hydrogen and a source of catalyst such as argon to provide catalyst Ar⁺. At least one of the power from catalysis and an external power source maintains an inverted population of one or more states of the catalyst or species formed from the catalyst from which spontaneous emission may occur. The emission may be in the ultraviolet (UV) and extreme ultraviolet (EUV) which may be used for photolithography. In an embodiment for short wavelength light such as EUV or soft-X-ray light, the light source further comprises a pin-hole optic that may be differentially pumped to serve as a “windowless” exit for the light from the cell.

A light source of the present invention comprises a cell of the present invention that comprises a light propagation structure or window for a desired radiation of a desired wavelength or desired wavelength range. For example, a quartz window may be used to transmit ultraviolet, visible, infrared, microwave, and/or radio wave light from the cell since it is transparent to the corresponding wavelength range. Similarly, a glass window may be used to transmit visible, infrared, microwave, and/or radio wave light from the cell, and a ceramic window may be used to transmit infrared, microwave, and/or radio wave light from the cell. The cell wall may comprise the light propagation structure or window. The cell wall or window may be coated with a phosphor that converts one or more short wavelengths to desired longer wavelengths. For example, ultraviolet or extreme ultraviolet may be converted to visible light. The light source may provide short wavelength light directly, and the short wavelength line emission may be used for applications known in the art such as photolithography. In an embodiment for short wavelength light such as EUV or soft-X-ray light, the light source further comprises a pin-hole optic that may be differentially pumped to serve as a “windowless” exit for the light from the cell.

A light source of the present invention such as a visible light source may comprise a transparent cell wall that may be insulated such that an elevated temperature may be maintained in the cell. In an embodiment, the wall may be a double wall with a separating vacuum space. The dissociator may be a filament such as a tungsten filament. The filament may also heat the catalyst to form a gaseous catalyst. A first catalyst may be at least one selected from the group of potassium, rubidium, cesium, and strontium metal. A second catalyst may be generated by a first. In an embodiment, at least one of helium, neon, and argon is ionized to He⁺, Ne⁺, and Ar⁺, respectively, by the plasma formed by the catalysis of hydrogen by a first catalysts such as strontium. He⁺, Ne⁺, and/or Ar⁺ serve as second hydrogen catalysts. The hydrogen may be supplied by a hydride that decomposes over time to maintain a desired pressure which may be determined by the temperature of the cell. The cell temperature may be controlled with a heater and a heater controller. In an embodiment, the temperature may be determined by the power supplied to the filament by a power controller.

The light source of the present invention may comprise at least one of the gas, gas discharge, plasma torch, or microwave plasma cell wherein ions or excimers are effectively formed that serve as catalysts from a source of catalyst such as He⁺, He₂*, Ne₂*, Ne⁺, Ne⁺/H⁺ or Ar⁺ catalysts from helium, helium, neon, neon-hydrogen mixture, and argon gases, respectively. The light may be largely monochromatic light such as line emission of the Lyman series such as Lyman α or Lyman β.

Energy Reactor

An energy reactor 50, in accordance with the invention, is shown in FIG. 1 and comprises a vessel 52 which contains an energy reaction mixture 54, a heat exchanger 60, and a power converter such as a steam generator 62 and turbine 70. The heat exchanger 60 absorbs heat released by the catalysis reaction, when the reaction mixture, comprised of hydrogen and a catalyst reacts to form lower-energy hydrogen. The heat exchanger exchanges heat with the steam generator 62 which absorbs heat from the exchanger 60 and produces steam. The energy reactor 50 further comprises a turbine 70 which receives steam from the steam generator 62 and supplies mechanical power to a power generator 80 which converts the steam energy into electrical energy, which can be received by a load 90 to produce work or for dissipation. The energy reaction mixture 54 comprises an energy releasing material 56 including a source of hydrogen isotope atoms or a source of molecular hydrogen isotope, and a source of catalyst 58 which resonantly remove approximately m×27.21 eV to form lower-energy atomic hydrogen and approximately m×48.6 eV to form lower-energy molecular hydrogen where m is an integer wherein the reaction to lower energy states of hydrogen occurs by contact of the hydrogen with the catalyst. For example, He⁺ fulfills the catalyst criterion—a chemical or physical process with an enthalpy change equal to an integer multiple of 27.2 eV since it ionizes at 54.417 eV which is 2·27.2 eV The catalysis releases energy in a form such as heat and lower-energy hydrogen isotope atoms and/or molecules.

The source of hydrogen can be hydrogen gas, dissociation of water including thermal dissociation, electrolysis of water, hydrogen from hydrides, or hydrogen from metal-hydrogen solutions. In all embodiments, the source of catalysts can be one or more of an electrochemical, chemical, photochemical, thermal, free radical, sonic, or nuclear reaction(s) or inelastic photon or particle scattering reaction(s). In the latter two cases, the present invention of an energy reactor comprises a particle source 75b and/or photon source 75a to supply the catalyst. In these cases, the net enthalpy of reaction supplied corresponds to a resonant collision by the photon or particle. In a preferred embodiment of the energy reactor shown in FIG. 1, atomic hydrogen is formed from molecular hydrogen by a photon source 75a such as a microwave source or a UV source.

The photon source may also produce photons of at least one energy of approximately

$$mX 27.21 eV , \frac{m}{2} X 27.21 eV , or 40.8 eV$$

causes the hydrogen atoms undergo a transition to a lower energy state. In another preferred embodiment, a photon source 75a producing photons of at least one energy of approximately m×48.6 eV, 95.7 eV, or m×31.94 eV causes the hydrogen molecules to undergo a transition to a lower energy state. In all reaction mixtures, a selected external energy device 75, such as an electrode may be used to supply an electrostatic potential or a current (magnetic field) to decrease the activation energy of the reaction. In another embodiment, the mixture 54, further comprises a surface or material to dissociate and/or absorb atoms and/or molecules of the energy releasing material 56. Such surfaces or materials to dissociate and/or absorb hydrogen, deuterium, or tritium comprise an element, compound, alloy, or mixture of transition elements and inner transition elements, iron, platinum, palladium, zirconium, vanadium, nickel, titanium, Sc, Cr, Mn, Co, Cu, Zn, Y, Nb, Mo, Tc, Ru, Rh, Ag, Cd, La, Hf, Ta, W, Re, Os, Ir, Au, Hg, Ce, Pr, Nd, Pm, Sm, Eu, Gd, Tb, Dy, Ho, Er, Tm, Vb, Lu, Th, Pa, U, activated charcoal (carbon), and intercalated Cs carbon (graphite).

In an embodiment, a catalyst is provided by the ionization of t electrons from an atom or ion to a continuum energy level such that the sum of the ionization energies of the t electrons is approximately m×27.2 eV where t and m are each an integer. A catalyst may also be provided by the transfer of t electrons between participating ions. The transfer of t electrons from one ion to another ion provides a net enthalpy of reaction whereby the sum of the ionization energy of the electron donating ion minus the ionization energy of the electron accepting ion equals approximately m·27.2 eV where t and m are each an integer.

In a preferred embodiment, a source of hydrogen atom catalyst comprises a catalytic material 58, that typically provide a net enthalpy of approximately m×27.21 eV plus or minus 1 eV. In a preferred embodiment, a source of hydrogen molecule catalysts comprises a catalytic material 58, that typically provide a net enthalpy of reaction of approximately m×48.6 eV plus or minus 5 eV. The catalysts include those given in TABLES 1 and 3 and the atoms, ions, molecules, and hydrinos described in Mills Prior Publications which are incorporated herein by reference. A further embodiment is the vessel 52 containing a catalysts in the molten, liquid, gaseous, or solid state and a source of hydrogen including hydrides and gaseous hydrogen. In the case of a reactor for catalysis of hydrogen atoms, the embodiment further comprises a means to dissociate the molecular hydrogen into atomic hydrogen including an element, compound, alloy, or mixture of transition elements, inner transition elements, iron, platinum, palladium, zirconium, vanadium, nickel, titanium, Sc, Cr, Mn, Co, Cu, Zn, Y, Nb, Mo, Tc, Ru, Rh, Ag, Cd, La, Hf, Ta, W, Re, Os, Ir, Au, Hg, Ce, Pr, Nd, Pm, Sm, Eu, Gd, Tb, Dy, Ho, Er, Tm, Vb, Lu, Th, Pa, U, activated charcoal (carbon), and intercalated Cs carbon (graphite) or electromagnetic radiation including UV light provided by photon source 75. Alternatively, the hydrogen is dissociated in a plasma.

The present invention of an electrolytic cell energy reactor, electron-beam initiated high-voltage pulsed discharge reactor, plasma electrolysis reactor, barrier electrode reactor, RF plasma reactor, pressurized gas energy reactor, gas discharge energy reactor, microwave cell energy reactor, and a combination of a glow discharge cell and a microwave and or RF plasma reactor of the present invention comprises: a source of hydrogen; one of a solid, molten, liquid, and gaseous source of catalyst; a vessel containing hydrogen and the catalyst wherein the reaction to form lower-energy hydrogen occurs by contact of the hydrogen with the catalyst; and a means for removing the lower-energy hydrogen product. The present energy invention is further described in Mills Prior Publications which are incorporated herein by reference.

In a preferred embodiment, the catalysis of hydrogen produces a plasma. The plasma may also be at least partially maintained by a microwave generator wherein the microwaves are tuned by a tunable microwave cavity, carried by a waveguide, and are delivered to the reaction chamber though an RF transparent window or antenna. The microwave frequency may be selected to efficiently form atomic hydrogen from molecular hydrogen. It may also effectively form ions or excimers that serve as catalysts from a source of catalyst such as He⁺, He₂*, Ne₂*, Ne⁺/H⁺ or Ar⁺ catalysts from helium, helium, neon, neon-hydrogen mixture, and argon gases, respectively. In an embodiment, the cell provides a catalyst for a source of catalyst such as He⁺, Ar⁺, and Ne⁺ from helium, argon, and neon gas, respectively. In embodiments, cell types may be combined for based on specific functions. For example, a glow discharge cell which is very effective at producing catalyst for a source of catalyst such as He⁺, Ar⁺, and Ne⁺ from helium, argon, and neon gas, respectively, may be combined with a reactor such as a microwave reactor that is well suited for the production of atomic hydrogen to react with the catalyst.

In an embodiment, the energy from the catalysis of atomic hydrogen forms or assists the maintenance of a plasma. The plasma dissociates water vapor to hydrogen and oxygen, which is removed and collected as a fuel.

Hydrogen Microwave Plasma and Power Cell and Reactor

A hydrogen microwave plasma and power cell and reactor of the present invention for the catalysis of atomic hydrogen to form increased-binding-energy-hydrogen species and increased-binding-energy-hydrogen compounds comprises a vessel having a chamber capable of containing a vacuum or pressures greater than atmospheric, a source of atomic hydrogen, a source of microwave power to form a plasma, and a catalyst capable of providing a net enthalpy of reaction of m/2·27.2±0.5 eV where m is an integer, preferably m is an integer less than 400. The source of microwave power may comprise a microwave generator, a tunable microwave cavity, waveguide, and an antenna. Alternatively, the cell may further comprise a means to at least partially convert the power for the catalysis of atomic hydrogen to microwaves to maintain the plasma.

Hydrogen Capacitively and Inductively Coupled RF Plasma and Power Cell and Reactor

A hydrogen capacitively and/or inductively coupled radio frequency (RF) plasma and power cell and reactor of the present invention for the catalysis of atomic hydrogen to form increased-binding-energy-hydrogen species and increased-binding-energy-hydrogen compounds comprises a vessel having a chamber capable of containing a vacuum or pressures greater than atmospheric, a source of atomic hydrogen, a source of RF power to form a plasma, and a catalyst capable of providing a net enthalpy of reaction of m/2·27.2±0.5 eV where m is an integer, preferably m is an integer less than 400. The cell may further comprise at least two electrodes and an RF generator wherein the source of RF power may comprise the electrodes driven by the RF generator. Alternatively, the cell may further comprise a source coil which may be external to a cell wall which permits RF power to couple to the plasma formed in the cell, a conducting cell wall which may be grounded and a RF generator which drives the coil which may inductively and/or capacitively couple RF power to the cell plasma.

Electron-Beam-Initiated High-Voltage Pulsed Discharge Plasma and Power Cell and Reactor

An electron-beam-initiated, high-voltage pulsed discharge plasma and power cell and reactor of the present invention for the catalysis of atomic hydrogen to form increased-binding-energy-hydrogen species and increased-binding-energy-hydrogen compounds comprises a vessel having a chamber capable of containing a vacuum or pressures greater than atmospheric, a source of atomic hydrogen, a cathode and an anode, a source of high-voltage power to form a plasma, an electron beam to trigger a pulse of high-voltage applied to two electrodes, and a catalyst capable of providing a net enthalpy of reaction of m/2·27.2±0.5 eV where m is an integer, preferably m is an integer less than 400. At least one of the electrodes may be a microhollow electrode.

Catalyst Laser

A laser of the present invention comprises at least one of a laser medium comprising an inverted population of a state of the catalyst or a species formed from the catalyst, a laser cavity, laser cavity mirrors, a power source, and a output laser beam from the cavity through one of the mirrors. The invention may further comprise Brewer windows and further optical components to cause stimulated emission of an inverted population of the laser medium in the cavity. In an embodiment, the laser has a sufficient path length such that gain is achieved in the absence of mirrors.

A laser light source of the present invention comprises an inverted population of the emitting species, a cell, a power source, and a output window from the cell. The power input to create a plasma to initiate the catalyst reaction may be at least one of a particle beam such as an electron beam and microwave, high voltage, and RF discharges. The system to create a plasma to form atomic hydrogen and the catalyst may comprises an electron-beam-initiated, high-voltage pulsed discharge plasma of catalyst-hydrogen gases. In an embodiment, the power source that may at least partially comprise a cell for the catalysis of atomic hydrogen to form novel hydrogen species and/or compositions of matter comprising new forms of hydrogen, an increased-binding-energy-hydrogen species reactor. The reaction may be maintained by a particle beam, microwave, glow, or RF discharge plasma of a source of atomic hydrogen and a source of catalyst such as helium or argon to provide catalyst He⁺ and Ar⁺, respectively. At least one of the power from catalysis and an external power source maintains an inverted population of one or more states of the catalyst or species formed from the catalyst from which stimulate emission may occur. The emission may be in the ultraviolet (UV) and extreme ultraviolet (EUV) which may be used for photolithography. In an embodiment for short wavelength light such as EUV or soft-X-ray light, the light source further comprises a pin-hole optic that may be differentially pumped to serve as a “windowless” exit for the light from the cell.

### BRIEF DESCRIPTION OF THE DRAWINGS

FIG. 1 is a schematic drawing of a power system comprising a hydrogen power and plasma cell and reactor in accordance with the present invention;

FIG. 2 is a schematic drawing of a hydrogen plasma electrolytic power and plasma cell and reactor in accordance with the present invention;

FIG. 3 is a schematic drawing of a hydrogen gas power and plasma cell and reactor in accordance with the present invention;

FIG. 4 is a schematic drawing of a hydrogen gas discharge power and plasma cell and reactor in accordance with the present invention;

FIG. 5 is a schematic drawing of a hydrogen RF barrier electrode gas discharge power and plasma cell and reactor in accordance with the present invention;

FIG. 6 is a schematic drawing of a hydrogen plasma torch power and plasma cell and reactor in accordance with the present invention;

FIG. 7 is a schematic drawing of another hydrogen plasma torch power and plasma cell and reactor in accordance with the present invention;

FIG. 8 is a schematic drawing of a hydrogen microwave power and plasma cell and reactor in accordance with the present invention;

FIG. 9 is a schematic drawing of an electron-beam-initiated, high-voltage pulsed discharge power and plasma cell and reactor in accordance with the present invention;

FIG. 10 is a schematic drawing of a power and plasma cell, reactor, and laser in accordance with the present invention, and

FIG. 11 is a schematic drawing of a laser in accordance with the present invention.

### DETAILED DESCRIPTION OF THE INVENTION

The following preferred embodiments of the invention disclose numerous property ranges, including but not limited to, voltage, current, pressure, temperature, microwave power, electron-beam energy, current, and power, and the like, which are merely intended as illustrative examples. Based on the detailed written description, one skilled in the art would easily be able to practice this invention within other property ranges to produce the desired result without undue experimentation.

Hydrogen Power and Plasma Cell and Reactor

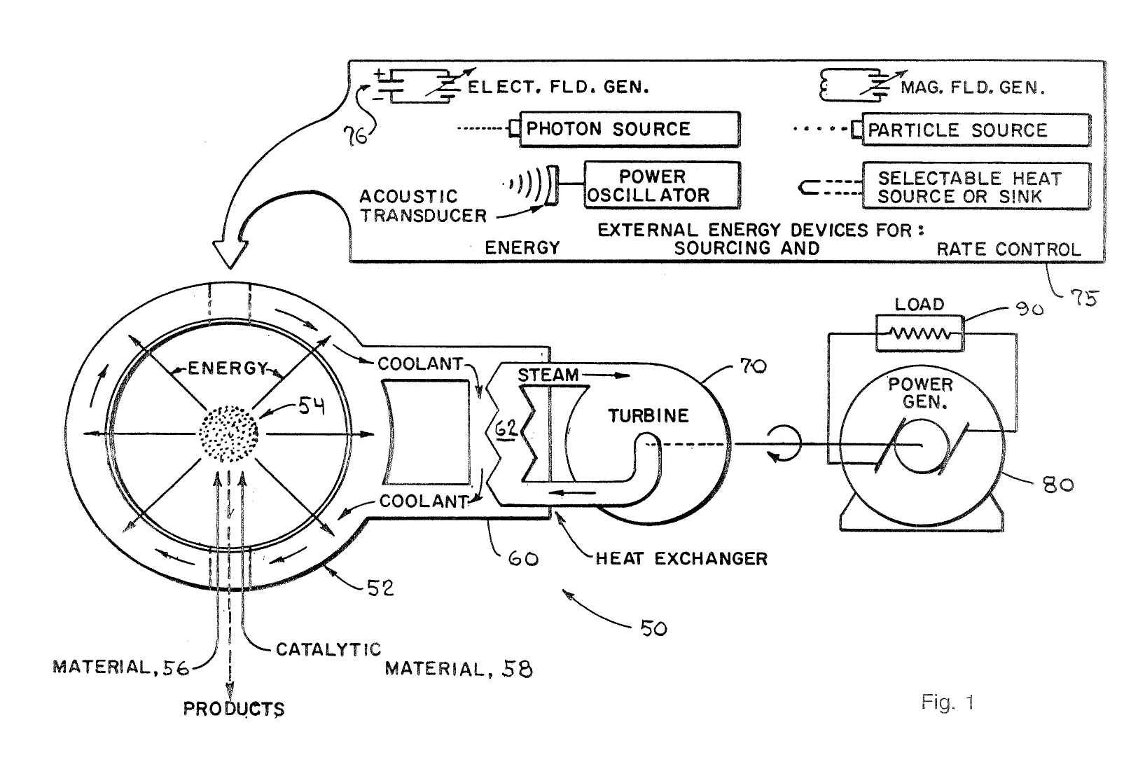

One embodiment of the present invention involves a power system comprising a hydrogen power and plasma cell and reactor shown in FIG. 1. The hydrogen power and plasma cell and reactor comprises a vessel 52 containing a catalysis mixture 54. The catalysis mixture 54 comprises a source of atomic hydrogen 56 supplied through hydrogen supply passage 42 and a catalyst 58 supplied through catalyst supply passage 41. Catalyst 58 has a net enthalpy of reaction of about

$$\frac{m}{2} \cdot 27.21 \pm 0.5 eV ,$$

where m is an integer, preferably an integer less than 400. The catalysis involves reacting atomic hydrogen from the source 56 with the catalyst 58 to form lower-energy hydrogen “hydrinos” and produce power. The hydrogen reactor may further include an electron source 70 for contacting hydrinos with electrons, to reduce the hydrinos to hydrino hydride ions.

The source of hydrogen can be hydrogen gas, water, ordinary hydride, or metal-hydrogen solutions. The water may be dissociated to form hydrogen atoms by, for example, thermal dissociation or electrolysis. According to one embodiment of the invention, molecular hydrogen is dissociated into atomic hydrogen by a molecular hydrogen dissociating catalyst. Such dissociating catalysts include, for example, noble metals such as palladium and platinum, refractory metals such as molybdenum and tungsten, transition metals such as nickel and titanium, inner transition metals such as niobium and zirconium, and other such materials listed in the Prior Mills Publications.

According to another embodiment of the invention, a photon source such as a microwave or UV photon source dissociates hydrogen molecules to hydrogen atoms.

In the hydrogen power and plasma cell and reactor embodiments of the present invention, the means to form hydrinos can be one or more of an electrochemical, chemical, photochemical, thermal, free radical, sonic, or nuclear reaction(s), or inelastic photon or particle scattering reaction(s). In the latter two cases, the hydrogen reactor comprises a particle source 75b and/or photon source 75a as shown in FIG. 1, to supply the reaction as an inelastic scattering reaction. In one embodiment of the hydrogen reactor, the catalyst in the molten, liquid, gaseous, or solid state includes those given in TABLES 1 and 3 and those given in the Tables of the Prior Mills Publications (e.g. TABLE 4 of PCT/US90/01998 and pages 25-46, 80-108 of PCT/US94/02219).

When the catalysis occurs in the gas phase, the catalyst may be maintained at a pressure less than atmospheric, preferably in the range about 10 millitorr to about 100 torr. The atomic and/or molecular hydrogen reactant is also maintained at a pressure less than atmospheric, preferably in the range about 10 millitorr to about 100 torr. However, if desired, higher pressures even greater than atmospheric can be used.

The hydrogen power and plasma cell and reactor comprises the following: a source of atomic hydrogen; at least one of a solid, molten, liquid, or gaseous catalyst for generating hydrinos; and a vessel for containing the atomic hydrogen and the catalyst. Methods and apparatus for producing hydrinos, including a listing of effective catalysts and sources of hydrogen atoms, are described in the Prior Mills Publications. Methodologies for identifying hydrinos are also described. The hydrinos so produced may react with the electrons from a reductant to form hydrino hydride ions.

The power system may further comprise a source of electric field 76 which can be used to adjust the rate of hydrogen catalysis. It may further focus ions in the cell. It may further impart a drift velocity to ions in the cell. The cell may comprise a source of microwave power, which is generally known in the art, such as traveling wave tubes, klystrons, magnetrons, cyclotron resonance masers, gyrotrons, and free electron lasers. The present power cell may be an internal source of microwaves wherein the plasma generated from the hydrogen catalysis reaction may be magnetized to produce microwaves.

Hydrogen Plasma Electrolysis Power and Plasma Cell and Reactor

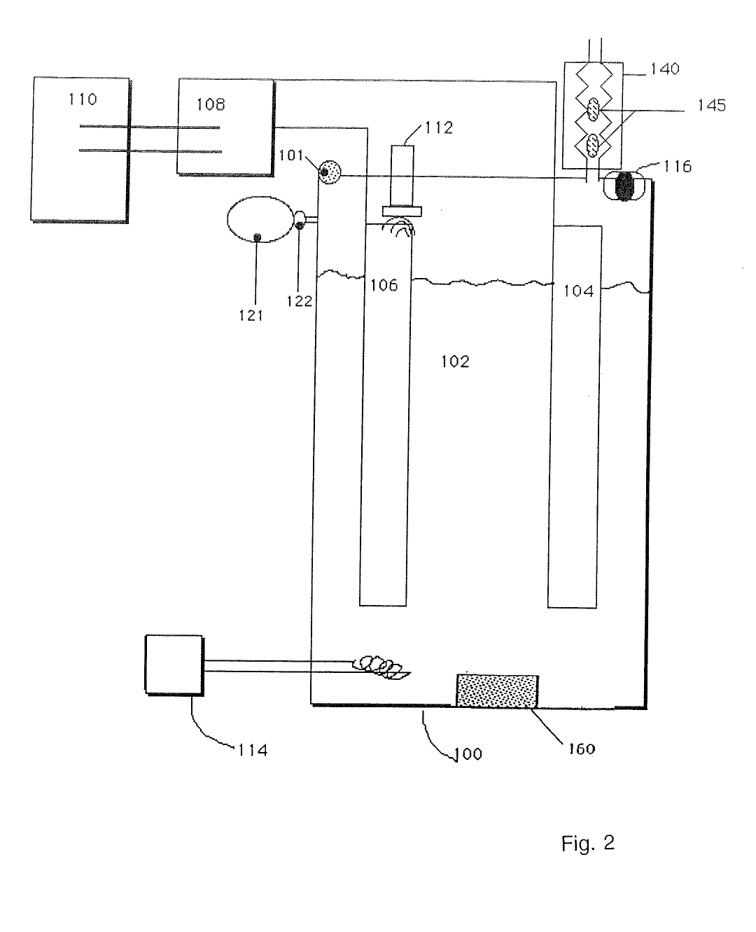

A hydrogen plasma electrolytic power cell and reactor of the present invention to make lower-energy hydrogen compounds comprises an electrolytic cell forming the reaction vessel 52 of FIG. 1, including a molten electrolytic cell. The electrolytic cell 100 is shown generally in FIG. 2. An electric current is passed through the electrolytic solution 102 having a catalyst by the application of a voltage to an anode 104 and cathode 106 by the power controller 108 powered by the power supply 110. Ultrasonic or mechanical energy may also be imparted to the cathode 106 and electrolytic solution 102 by vibrating means 112. Heat can be supplied to the electrolytic solution 102 by heater 114. The pressure of the electrolytic cell 100 can be controlled by pressure regulator means 116 where the cell can be closed. The reactor further comprises a means 101 that removes the (molecular) lower-energy hydrogen such as a selective venting valve to prevent the exothermic shrinkage reaction from coming to equilibrium. In an embodiment, the plasma electrolytic cell is further supplied with hydrogen from hydrogen source 121 where the over pressure can be controlled by pressure control means 122 and 116. An embodiment of the electrolytic cell energy reactor, comprises a reverse fuel cell geometry which removes the lower-energy hydrogen under vacuum. The reaction vessel may be closed except for a connection to a condenser 140 on the top of the vessel 100. The cell may be operated at a boil such that the steam evolving from the boiling electrolyte 102 can be condensed in the condenser 140, and the condensed water can be returned to the vessel 100. The lower-energy state hydrogen can be vented through the top of the condenser 140. In one embodiment, the condenser contains a hydrogen/oxygen recombiner 145 that contacts the evolving electrolytic gases. The hydrogen and oxygen are recombined, and the resulting water can be returned to the vessel 100. The heat released from the catalysis of hydrogen and the heat released due to the recombination of the electrolytically generated normal hydrogen and oxygen can be removed by a heat exchanger 60 of FIG. 1 which can be connected to the condenser 140.

Hydrino atoms form at the cathode 106 via contact of the catalyst of electrolyte 102 with the hydrogen atoms generated at the cathode 106. The electrolytic cell hydrogen reactor apparatus may further comprises a source of electrons in contact with the hydrinos generated in the cell, to form hydrino hydride ions. The hydrinos are reduced (i.e. gain the electron) in the electrolytic cell to hydrino hydride ions. Reduction occurs by contacting the hydrinos with other element 160 such as a consumable reductant added to the cell from an outside source. A compound may form in the electrolytic cell between the hydrino hydride ions and cations. The cations may comprise a cation of an added reductant, or a cation of the electrolyte (such as a cation comprising the catalyst).

A hydrogen plasma forming electrolytic power cell and reactor of the present invention for the catalysis of atomic hydrogen to form increased-binding-energy-hydrogen species and increased-binding-energy-hydrogen compounds comprises a vessel, a cathode, an anode, an electrolyte, a high voltage electrolysis power supply, and a catalyst capable of providing a net enthalpy of reaction of m/2·27.2±0.5 eV where m is an integer. Preferably m is an integer less than 400. In an embodiment, the voltage is in the range of about 10 V to 50 kV and the current density may be high such as in the range of about 1 to 100 A/cm² or higher. In an embodiment, K⁺ is reduced to potassium atom which serves as the catalyst. The cathode of the cell may be tungsten such as a tungsten rod, and the anode of cell of may be platinum. The catalysts of the cell may comprise at least one selected from the group of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, He⁺, Na⁺, Rb⁺, Sr⁺, Fe³⁺, Mo²⁺, Mo⁴⁺, and In³⁺. The catalyst of the cell of may be formed from a source of catalyst. The source of catalyst that forms the catalyst may comprise at least one selected from the group of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, He⁺, Na⁺, Rb⁺, Sr⁺, Fe³⁺, Mo²⁺, Mo⁴⁺, In³⁺ and K⁺/K⁺ alone or comprising compounds. The source of catalyst may comprise a compound that provides K⁺ that is reduced to the catalyst potassium atom during electrolysis.

The compound of formed comprises
(a) at least one neutral, positive, or negative increased binding energy hydrogen species having a binding energy

greater than the binding energy of the corresponding ordinary hydrogen species, or
i. (ii) greater than the binding energy of any hydrogen species for which the corresponding ordinary hydrogen species is unstable or is not observed because the ordinary hydrogen species' binding energy is less than thermal energies at ambient conditions, or is negative; and
(b) at least one other element.

The increased binding energy hydrogen species may be selected from the group consisting of Hₙ, Hₙ⁻, and Hₙ⁺ where n is a positive integer, with the proviso that n is greater than 1 when H has a positive charge. The compound formed may be characterized in that the increased binding energy hydrogen species is selected from the group consisting of (a) hydride ion having a binding energy that is greater than the binding of ordinary hydride ion (about 0.8 eV) for p=2 up to 23 in which the binding energy is represented by

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} )$$

where p is an integer greater than one; (b) hydrogen atom having a binding energy greater than about 13.6 eV; (c) hydrogen molecule having a first binding energy greater than about 15.3 eV; and (d) molecular hydrogen ion having a binding energy greater than about 16.3 eV. The compound may be characterized in that the increased binding energy hydrogen species is a hydride ion having a binding energy of about 3, 6.6, 11.2, 16.7, 22.8, 29.3, 36.1, 42.8, 49.4, 55.5, 61.0, 65.6, 69.2, 71.6, 72.4, 71.6, 68.8, 64.0, 56.8, 47.1, 34.7, 19.3, and 0.69 eV. The compound may characterized in that the increased binding energy hydrogen species is a hydride ion having the binding energy:

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} )$$

where p is an integer greater than one. The compound may characterized in that the increased binding energy hydrogen species is selected from the group consisting of
(a) a hydrogen atom having a binding energy of about

$$\frac{13.6 e V}{{( \frac{1}{p} )}^{2}}$$

where p is an integer,
(b) an increased binding energy hydride ion (H⁻) having a binding energy of about

$$\frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) ;$$

(c) an increased binding energy hydrogen species H₄⁺(1/p);

(d) an increased binding energy hydrogen species trihydrino molecular ion, H₃⁺(1/p), having a binding energy of about

$$\frac{22.6}{{( \frac{1}{p} )}^{2}} e V$$

where p is an integer,
(e) an increased binding energy hydrogen molecule having a binding energy of about

$$\begin{matrix}{IP}_{1} = {E}_{T} ( {H}_{2}^{+} ( 1 / p ) ) - {E}_{T} ( {H}_{2} ( 1 / p ) ) \\ = - {p}^{2} 16.13392 e V - {p}^{3} 0.118755 e V - ( - {p}^{2} 31.351 e V - \\ {p}^{3} 0.326469 e V ) \\ = {p}^{2} 15.2171 e V + {p}^{3} 0.207714 e V\end{matrix}$$

given by in R. L. Mills, “The Nature of the Chemical Bond Revisited and an Alternative Maxwellian Approach”, Physics Essays, Vol. 17, No. 3, (2004), pp. 342-389 which is herein incorporated by reference, and
(f) an increased binding energy hydrogen molecular ion with a binding energy of about IP₂=p²16.13392 eV+p³0.118755 eV given in R. L. Mills, “The Nature of the Chemical Bond Revisited and an Alternative Maxwellian Approach”, Physics Essays, Vol. 17, No. 3, (2004), pp. 342-389 which is herein incorporated by reference.

Hydrogen Gas Power and Plasma Cell and Reactor

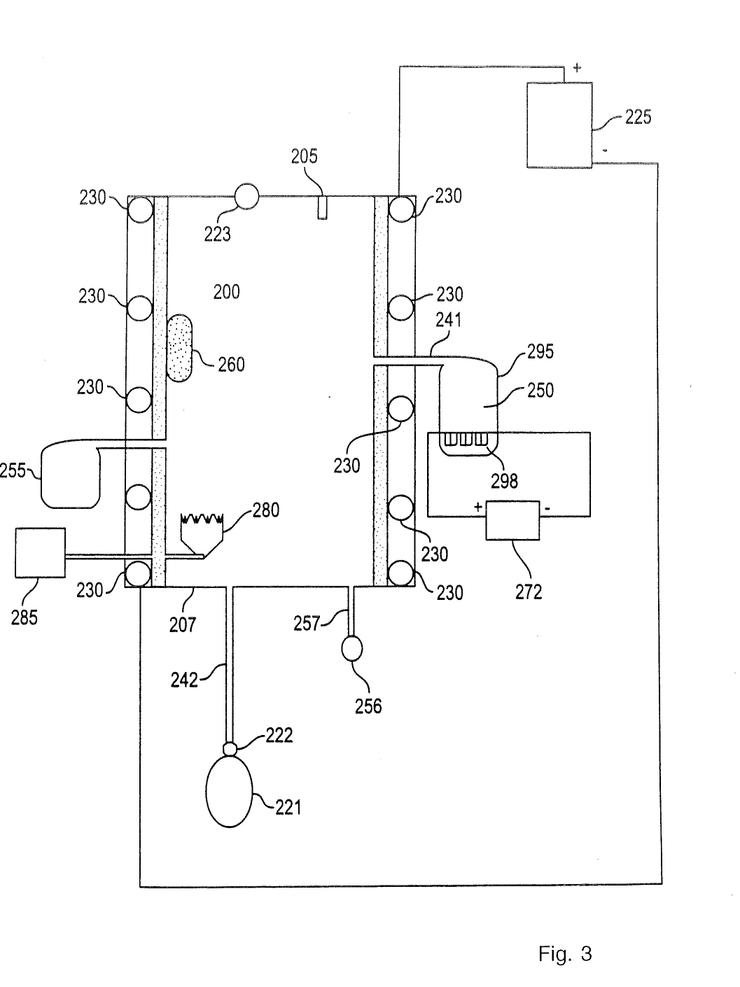

According to an embodiment of the invention, a reactor for producing hydrinos, plasma, and power may take the form of a hydrogen gas cell. A gas cell hydrogen reactor of the present invention is shown in FIG. 3. Reactant hydrinos are provided by a catalytic reaction with a catalyst such as at least one of those given in TABLES 1 and 3 and/or a by a disproportionation reaction. Catalysis may occur in the gas phase.

The reactor of FIG. 3 comprises a reaction vessel 207 having a chamber 200 capable of containing a vacuum or pressures greater than atmospheric. A source of hydrogen 221 communicating with chamber 200 delivers hydrogen to the chamber through hydrogen supply passage 242. A controller 222 is positioned to control the pressure and flow of hydrogen into the vessel through hydrogen supply passage 242. A pressure sensor 223 monitors pressure in the vessel. A vacuum pump 256 is used to evacuate the chamber through a vacuum line 257. The apparatus may further comprise a source of electrons in contact with the hydrinos to form hydrino hydride ions.

In an embodiment, the source of hydrogen 221 communicating with chamber 200 that delivers hydrogen to the chamber through hydrogen supply passage 242 is a hydrogen permeable hollow cathode of an electrolysis cell. Electrolysis of water produces hydrogen that permeates through the hollow cathode. The cathode may be a transition metal such as nickel, iron, or titanium, or a noble metal such as palladium, or platinum, or tantalum or palladium coated tantalum, or palladium coated niobium. The electrolyte may be basic and the anode may be nickel. The electrolyte may be aqueous K₂CO₃. The flow of hydrogen into the cell may be controlled by controlling the electrolysis current with an electrolysis power controller.

A catalyst 250 for generating hydrino atoms can be placed in a catalyst reservoir 295. The catalyst in the gas phase may comprise the catalysts given in TABLES 1 and 3 and those in the Mills Prior Publications. The reaction vessel 207 has a catalyst supply passage 241 for the passage of gaseous catalyst from the catalyst reservoir 295 to the reaction chamber 200. Alternatively, the catalyst may be placed in a chemically resistant open container, such as a boat, inside the reaction vessel.

The molecular and atomic hydrogen partial pressures in the reactor vessel 207, as well as the catalyst partial pressure, is preferably maintained in the range of about 10 millitorr to about 100 torr. Most preferably, the hydrogen partial pressure in the reaction vessel 207 is maintained at about 200 millitorr.

Molecular hydrogen may be dissociated in the vessel into atomic hydrogen by a dissociating material. The dissociating material may comprise, for example, a noble metal such as platinum or palladium, a transition metal such as nickel and titanium, an inner transition metal such as niobium and zirconium, or a refractory metal such as tungsten or molybdenum. The dissociating material may be maintained at an elevated temperature by the heat liberated by the hydrogen catalysis (hydrino generation) and hydrino reduction taking place in the reactor. The dissociating material may also be maintained at elevated temperature by temperature control means 230, which may take the form of a heating coil as shown in cross section in FIG. 3. The heating coil is powered by a power supply 225.

Molecular hydrogen may be dissociated into atomic hydrogen by application of electromagnetic radiation, such as UV light provided by a photon source 205, by a hot filament or grid 280 powered by power supply 285, or by the plasma generated in the cell by the catalysis reaction.

The hydrogen dissociation occurs such that the dissociated hydrogen atoms contact a catalyst which is in a molten, liquid, gaseous, or solid form to produce hydrino atoms. The catalyst vapor pressure is maintained at the desired pressure by controlling the temperature of the catalyst reservoir 295 with a catalyst reservoir heater 298 powered by a power supply 272. When the catalyst is contained in a boat inside the reactor, the catalyst vapor pressure is maintained at the desired value by controlling the temperature of the catalyst boat, by adjusting the boat's power supply.

The rate of production of hydrinos and power by the hydrogen gas cell can be controlled by controlling the amount of catalyst in the gas phase and/or by controlling the concentration of atomic hydrogen. The concentration of gaseous catalyst in vessel chamber 200 may be controlled by controlling the initial amount of the volatile catalyst present in the chamber 200. The concentration of gaseous catalyst in chamber 200 may also be controlled by controlling the catalyst temperature, by adjusting the catalyst reservoir heater 298, or by adjusting a catalyst boat heater when the catalyst is contained in a boat inside the reactor. The vapor pressure of the volatile catalyst 250 in the chamber 200 is determined by the temperature of the catalyst reservoir 295, or the temperature of the catalyst boat, because each is colder than the reactor vessel 207. The reactor vessel 207 temperature is maintained at a higher operating temperature than catalyst reservoir 295 with heat liberated by the hydrogen catalysis (hydrino generation) and hydrino reduction. The reactor vessel temperature may also be maintained by a temperature control means, such as heating coil 230 shown in cross section in FIG. 3. Heating coil 230 is powered by power supply 225. The reactor temperature further controls the reaction rates such as hydrogen dissociation and catalysis.

In an embodiment, the catalyst comprises a mixture of a first catalyst supplied from the catalyst reservoir 295 and a source of a second catalyst supplied from gas supply 221 regulated by flow controller 222. Hydrogen may also be supplied to the cell from gas supply 221 regulated by flow controller 222. The flow controller 222 may achieve a desired mixture of the source of a second catalyst and hydrogen, or the gases may be premixed in a desired ratio. In an embodiment, the first catalyst produces the second catalyst from the source of the second catalyst. In an embodiment, the energy released by the catalysis of hydrogen by the first catalyst produces a plasma in the energy cell. The energy ionizes the source of the second catalyst to produce the second catalyst. The first catalyst may be selected from the group of catalysts given in TABLES 1 and 3 such as potassium and strontium, the source of the second catalyst may be selected from the group of helium and argon and the second catalyst may be selected from the group of He⁺ and Ar⁺ wherein the catalyst ion is generated from the corresponding atom by a plasma created by catalysis of hydrogen by the first catalyst. For examples, 1.) the energy cell contains strontium and argon wherein hydrogen catalysis by strontium produces a plasma containing Ar⁺ which serves as a second catalyst (Eqs. (15-17)) and 2.) the energy cell contains potassium and helium wherein hydrogen catalysis by potassium produces a plasma containing He⁺ which serves as a second catalyst (Eqs. (12-14)). In an embodiment, the pressure of the source of the second catalyst is in the range of about 1 millitorr to about one atmosphere. The hydrogen pressure is in the range of about 1 millitorr to about one atmosphere. In a preferred embodiment, the total pressure is in the range of about 0.5 torr to about 2 torr. In an embodiment, the ratio of the pressure of the source of the second catalyst to the hydrogen pressure is greater than one. In a preferred embodiment, hydrogen is about 0.1% to about 99%, and the source of the second catalyst comprises the balance of the gas present in the cell. More preferably, the hydrogen is in the range of about 1% to about 5% and the source of the second catalyst is in the range of about 95% to about 99%. Most preferably, the hydrogen is about 5% and the source of the second catalyst is about 95%. These pressure ranges are representative examples and a skilled person will be able to practice this invention using a desired pressure to provide a desired result.

The preferred operating temperature depends, in part, on the nature of the material comprising the reactor vessel 207. The temperature of a stainless steel alloy reactor vessel 207 is preferably maintained at about 200-1200° C. The temperature of a molybdenum reactor vessel 207 is preferably maintained at about 200-1800° C. The temperature of a tungsten reactor vessel 207 is preferably maintained at about 200-3000° C. The temperature of a quartz or ceramic reactor vessel 207 is preferably maintained at about 200-1800° C.

The concentration of atomic hydrogen in vessel chamber 200 can be controlled by the amount of atomic hydrogen generated by the hydrogen dissociation material. The rate of molecular hydrogen dissociation can be controlled by controlling the surface area, the temperature, and/or the selection of the dissociation material. The concentration of atomic hydrogen may also be controlled by the amount of atomic hydrogen provided by the atomic hydrogen source 221. The concentration of atomic hydrogen can be further controlled by the amount of molecular hydrogen supplied from the hydrogen source 221 controlled by a flow controller 222 and a pressure sensor 223. The reaction rate may be monitored by windowless ultraviolet (UV) emission spectroscopy to detect the intensity of the UV emission due to the catalysis and the hydrino, dihydrino molecular ion, dihydrino molecule, hydride ion, and compound emissions.
(a) The gas cell hydrogen reactor further comprises other element as an electron source 260 such a reductant in contact with the generated hydrinos to form hydrino hydride ions. Compounds comprising a hydrino hydride anion and a cation may be formed in the gas cell. The cation which forms the hydrino hydride compound may comprise a cation from an added reductant, or a cation present in the cell (such as the cation of the catalyst). The cell may further comprise a getter or cryotrap 255 to selectively collect the lower-energy-hydrogen species and/or the increased-binding-energy hydrogen compounds.
(b) The rt-plasma may be initiated by external heaters and a tungsten filament that is a source of electrons as given in H. Conrads, R. Mills, Th. Wrubel, “Emission in the Deep Vacuum Ultraviolet from a Plasma Formed by Incandescently Heating Hydrogen Gas with Trace Amounts of Potassium Carbonate”, Plasma Sources Science and Technology, Vol. 12, (2003), pp. 389-395 which is herein incorporated by reference. The filament emission may be sufficient at low temperature to initiate the rt-plasma. An efficient source is a rhenium, BaO-coated, or radioactive filament such as a thoriated-tungsten filament. In the latter case, the emission is sufficiently energetic to ionize the catalyst such as Sr⁺ or Ar⁺, and the formed-rt-plasma maintains the ionization at a much higher level.

Hydrogen Gas Discharge Power and Plasma Cell and Reactor

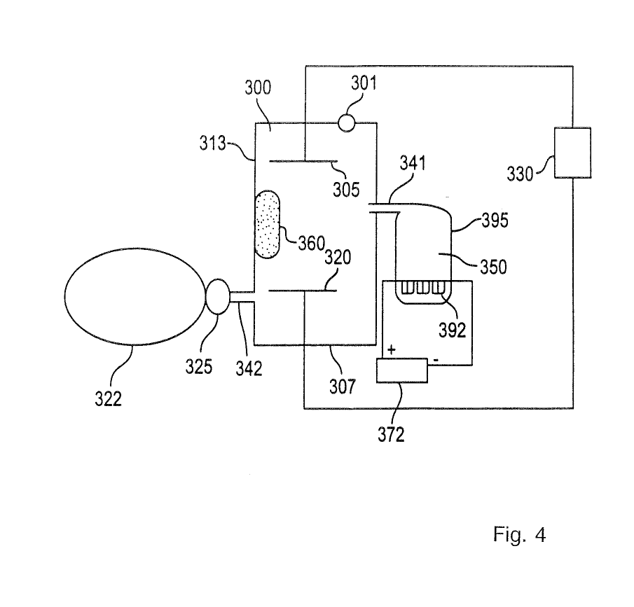

A hydrogen gas discharge power and plasma cell and reactor of the present invention is shown in FIG. 4. The hydrogen gas discharge power and plasma cell and reactor of FIG. 4, includes a gas discharge cell 307 comprising a hydrogen isotope gas-filled glow discharge vacuum vessel 313 having a chamber 300. A hydrogen source 322 supplies hydrogen to the chamber 300 through control valve 325 via a hydrogen supply passage 342. A catalyst is contained in catalyst reservoir 395. A voltage and current source 330 causes current to pass between a cathode 305 and an anode 320. The current may be reversible. In another embodiment, the plasma is generated with a microwave source such as a microwave generator.

In one embodiment of the hydrogen gas discharge power and plasma cell and reactor, the wall of vessel 313 is conducting and serves as the anode. In another embodiment, the cathode 305 is hollow such as a hollow, nickel, aluminum, copper, tungsten, molybdenum, or stainless steel hollow cathode. In an embodiment, the cathode material may be a source of catalyst such as iron or samarium.

The cathode 305 may be coated with the catalyst for generating hydrinos and energy. The catalysis to form hydrinos and energy occurs on the cathode surface. To form hydrogen atoms for generation of hydrinos and energy, molecular hydrogen is dissociated on the cathode. To this end, the cathode is formed of a hydrogen dissociative material. Alternatively, the molecular hydrogen is dissociated by the discharge.

According to another embodiment of the invention, the catalyst for generating hydrinos and energy is in gaseous form. For example, the discharge may be utilized to vaporize the catalyst to provide a gaseous catalyst. Alternatively, the gaseous catalyst is produced by the discharge current. For example, the gaseous catalyst may be provided by a discharge in rubidium metal to form Rb⁺, strontium metal to form Sr⁺, or titanium metal to form Ti²⁺, or potassium to volatilize the metal. The gaseous hydrogen atoms for reaction with the gaseous catalyst are provided by a discharge of molecular hydrogen gas such that the catalysis occurs in the gas phase.

Another embodiment of the hydrogen gas discharge power and plasma cell and reactor where catalysis occurs in the gas phase utilizes a controllable gaseous catalyst. The gaseous hydrogen atoms for conversion to hydrinos are provided by a discharge of molecular hydrogen gas. The gas discharge cell 307 has a catalyst supply passage 341 for the passage of the gaseous catalyst 350 from catalyst reservoir 395 to the reaction chamber 300. The catalyst reservoir 395 is heated by a catalyst reservoir heater 392 having a power supply 372 to provide the gaseous catalyst to the reaction chamber 300. The catalyst vapor pressure is controlled by controlling the temperature of the catalyst reservoir 395, by adjusting the heater 392 by means of its power supply 372. The reactor further comprises a selective venting valve 301.

In another embodiment of the hydrogen gas discharge power and plasma cell and reactor where catalysis occurs in the gas phase utilizes a controllable gaseous catalyst. Gaseous hydrogen atoms provided by a discharge of molecular hydrogen gas. A chemically resistant (does not react or degrade during the operation of the reactor) open container, such as a tungsten or ceramic boat, positioned inside the gas discharge cell contains the catalyst. The catalyst in the catalyst boat is heated with a boat heater using by means of an associated power supply to provide the gaseous catalyst to the reaction chamber. Alternatively, the glow gas discharge cell is operated at an elevated temperature such that the catalyst in the boat is sublimed, boiled, or volatilized into the gas phase. The catalyst vapor pressure is controlled by controlling the temperature of the boat or the discharge cell by adjusting the heater with its power supply.

The gas discharge cell may be operated at room temperature by continuously supplying catalyst. Alternatively, to prevent the catalyst from condensing in the cell, the temperature is maintained above the temperature of the catalyst source, catalyst reservoir 395 or catalyst boat. For example, the temperature of a stainless steel alloy cell is about 0-1200° C.; the temperature of a molybdenum cell is about 0-1800° C.; the temperature of a tungsten cell is about 0-3000° C.; and the temperature of a glass, quartz, or ceramic cell is about 0-1800° C. The discharge voltage may be in the range of about 1000 to about 50,000 volts. The current may be in the range of about 1 μA to about 1 A, preferably about 1 mA.

The discharge current may be intermittent or pulsed. Pulsing may be used to reduce the input power, and it may also provide a time period wherein the field is set to a desired strength by an offset voltage which may be below the discharge voltage. One application of controlling the field during the nondischarge period is to optimize the energy match between the catalyst and the atomic hydrogen. In an embodiment, the offset voltage is between, about 0.5 to about 500 V. In another embodiment, the offset voltage is set to provide a field of about 0.1 V/cm to about 50 V/cm. Preferably, the offset voltage is set to provide a field between about 1 V/cm to about 10 V/cm. The peak voltage may be in the range of about 1 V to 10 MV. More preferably, the peak voltage is in the range of about 10 V to 100 kV. Most preferably, the voltage is in the range of about 100 V to 500 V. The pulse frequency and duty cycle may also be adjusted. An application of controlling the pulse frequency and duty cycle is to optimize the power balance. In an embodiment, this is achieved by optimizing the reaction rate versus the input power. The amount of catalyst and atomic hydrogen generated by the discharge decay during the nondischarge period. The reaction rate may be controlled by controlling the amount of catalyst generated by the discharge such as Ar⁺ and the amount of atomic hydrogen wherein the concentration is dependent on the pulse frequency, duty cycle, and the rate of decay. In an embodiment, the pulse frequency is of about 0.1 Hz to about 100 MHz. In another embodiment, the pulse frequency is faster than the time for substantial atomic hydrogen recombination to molecular hydrogen. Based on anomalous plasma afterglow duration studies R. Mills, T. Onuma, and Y. Lu, “Formation of a Hydrogen Plasma from an Incandescently Heated Hydrogen-Catalyst Gas Mixture with an Anomalous Afterglow Duration”, Int. J. Hydrogen Energy, Vol. 26, No. 7, July, (2001), pp. 749-762; R. Mills, “Temporal Behavior of Light-Emission in the Visible Spectral Range from a Ti-K2CO3-H-Cell”, Int. J. Hydrogen Energy, Vol. 26, No. 4, (2001), pp. 327-332], preferably the frequency is within the range of about 1 to about 200 Hz. In an embodiment, the duty cycle is about 0.1% to about 95%. Preferably, the duty cycle is about 1% to about 50%.

In another embodiment, the power may be applied as an alternating current (AC). The frequency may be in the range of about 0.001 Hz to 1 GHz. More preferably the frequency is in the range of about 60 Hz to 100 MHz. Most preferably, the frequency is in the range of about 10 to 100 MHz. The system may comprises two electrodes wherein one or more electrodes are in direct contact with the plasma; otherwise, the electrodes may be separated from the plasma by a dielectric barrier. The peak voltage may be in the range of about 1 V to 10 MV. More preferably, the peak voltage is in the range of about 10 V to 100 kV. Most preferably, the voltage is in the range of about 100 V to 500 V.

The gas discharge cell apparatus further comprises other element as an electron source 360 such a reductant in contact with the generated hydrinos to form hydrino hydride ions. Compounds comprising a hydrino hydride anion and a cation may be formed in the gas cell. The cation which forms the hydrino hydride compound may comprise a cation from an added reductant, or a cation present in the cell (such as the cation of the catalyst).

In one embodiment of the gas discharge cell apparatus, alkali and alkaline earth hydrino hydrides and energy are produced in the gas discharge cell 307. In an embodiment, the catalyst reservoir 395 contains potassium, rubidium, or strontium metal which may be is ionized to K⁺, Rb⁺ or Sr⁺ catalyst, respectively. The catalyst vapor pressure in the gas discharge cell is controlled by heater 392. The catalyst reservoir 395 is heated with the heater 392 to maintain the catalyst vapor pressure proximal to the cathode 305 preferably in the pressure range 10 millitorr to 100 torr, more preferably at about 200 mtorr. In another embodiment, the cathode 305 and the anode 320 of the gas discharge cell 307 are coated with potassium, rubidium, or strontium. The catalyst is vaporized during the operation of the cell. The hydrogen supply from source 322 is adjusted with control 325 to supply hydrogen and maintain the hydrogen pressure in the 10 millitorr to 100 torr range.

In an embodiment, the electrode to provide the electric field is a compound electrode comprising multiple electrodes in series or parallel that may occupy a substantial portion of the volume of the reactor. In one embodiment, the electrode comprises multiple hollow cathodes in parallel so that the desired electric field is produced in a large volume to generate a substantial power level. One design of the multiple hollow cathodes comprises an anode and multiple concentric hollow cathodes each electrically isolated from the common anode. Another compound electrode comprises multiple parallel plate electrodes connected in series.

A preferable hollow cathode is comprised of refractory materials such as molybdenum or tungsten. A preferably hollow cathode comprises a compound hollow cathode. A preferable catalyst of a compound hollow cathode discharge cell is neon as described in R. L. Mills, P. Ray, J. Dong, M. Nansteel, B. Dhandapani, J. He, “Spectral Emission of Fractional-Principal-Quantum-Energy-Level Atomic and Molecular Hydrogen”, Vibrational Spectroscopy, Vol. 31, No. 2, (2003), pp. 195-213 which is herein incorporated by reference in its entirety. In an embodiment of the cell comprising a compound hollow cathode and neon as the source of catalyst with hydrogen, the partial pressure of neon is in the range 99.99%-90% and hydrogen is in the range 0.01-10%. Preferably the partial pressure of neon is in the range 99.9-99% and hydrogen is in the range 0.1-1%.

### Hydrogen Radio Frequency (RF) Barrier Electrode Discharge Power and Plasma Cell and Reactor

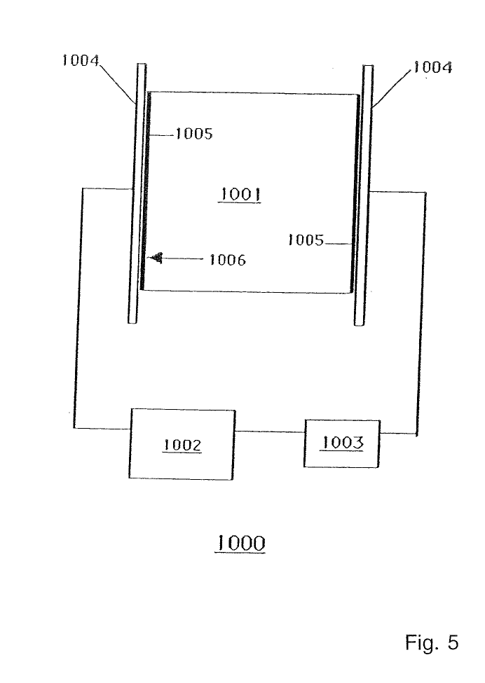

In an embodiment of the hydrogen discharge power and plasma cell and reactor, at least one of the discharge electrodes is shielded by a dielectric barrier such as glass, quartz, Alumina, or ceramic in order to provide an electric field with minimum power dissipation. A radio frequency (RF) barrier electrode discharge cell system 1000 of the present invention is shown in FIG. 5. The RF power may be capacitively coupled. In an embodiment, the electrodes 1004 may be external to the cell 1001. A dielectric layer 1005 separates the electrodes from the cell wall 1006. The high driving voltage may be AC and may be high frequency. The driving circuit comprises a high voltage power source 1002 which is capable of providing RF and an impedance matching circuit 1003. The frequency is preferably in the range of about 100 Hz to about 10 GHz, more preferably, about 1 kHz to about 1 MHz, most preferably about 5-10 kHz. The voltage is preferably in the range of about 100 V to about 1 MV, more preferably about 1 kV to about 100 kV, and most preferably about 5 to about 10 kV.

Hydrogen Plasma Torch Power and Plasma Cell and Reactor

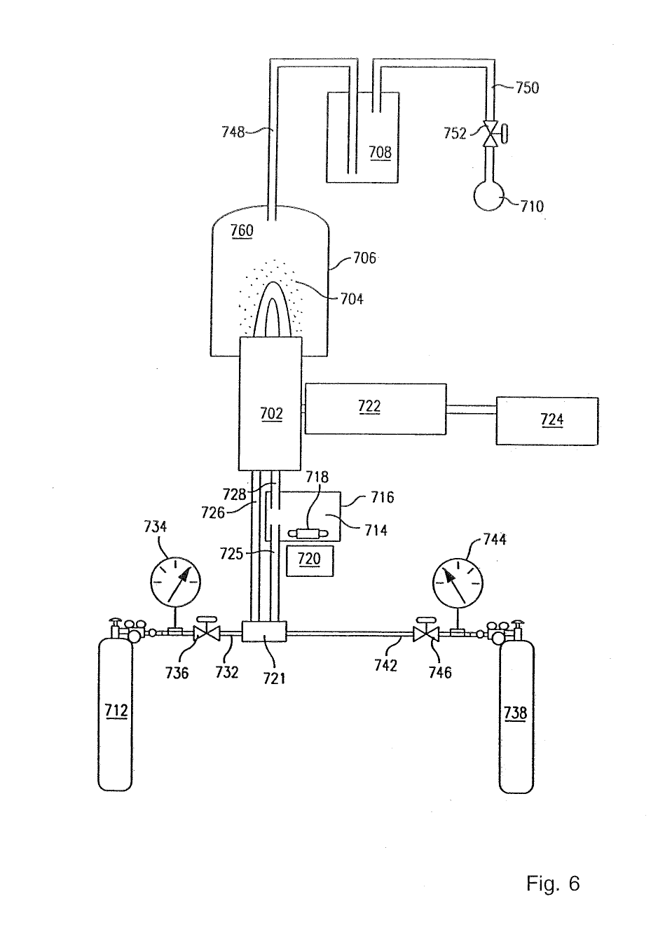

A hydrogen plasma torch power and plasma cell and reactor of the present invention is shown in FIG. 6. A plasma torch 702 provides a hydrogen isotope plasma 704 enclosed by a manifold 706 and contained in plasma chamber 760. Hydrogen from hydrogen supply 738 and plasma gas from plasma gas supply 712, along with a catalyst 714 for forming hydrinos and energy, is supplied to torch 702. The plasma may comprise argon, for example. The catalyst may comprise at least one of those given in TABLES 1 and 3 or a hydrino atom to provide a disproportionation reaction. The catalyst is contained in a catalyst reservoir 716. The reservoir is equipped with a mechanical agitator, such as a magnetic stirring bar 718 driven by magnetic stirring bar motor 720. The catalyst is supplied to plasma torch 702 through passage 728. The catalyst may be generated by a microwave discharge. Preferred catalysts are He⁺ or Ar⁺ from a source such as helium gas or argon gas.

Hydrogen is supplied to the torch 702 by a hydrogen passage 726. Alternatively, both hydrogen and catalyst may be supplied through passage 728. The plasma gas is supplied to the torch by a plasma gas passage 726. Alternatively, both plasma gas and catalyst may be supplied through passage 728.

Hydrogen flows from hydrogen supply 738 to a catalyst reservoir 716 via passage 742. The flow of hydrogen is controlled by hydrogen flow controller 744 and valve 746. Plasma gas flows from the plasma gas supply 712 via passage 732. The flow of plasma gas is controlled by plasma gas flow controller 734 and valve 736. A mixture of plasma gas and hydrogen is supplied to the torch via passage 726 and to the catalyst reservoir 716 via passage 725. The mixture is controlled by hydrogen-plasma-gas mixer and mixture flow regulator 721. The hydrogen and plasma gas mixture serves as a carrier gas for catalyst particles which are dispersed into the gas stream as fine particles by mechanical agitation. The aerosolized catalyst and hydrogen gas of the mixture flow into the plasma torch 702 and become gaseous hydrogen atoms and vaporized catalyst ions (such as Rb⁺ ions from a salt of rubidium) in the plasma 704. The plasma is powered by a microwave generator 724 wherein the microwaves are tuned by a tunable microwave cavity 722. Catalysis may occur in the gas phase.

The amount of gaseous catalyst in the plasma torch can be controlled by controlling the rate at which the catalyst is aerosolized with a mechanical agitator. The amount of gaseous catalyst can also be controlled by controlling the carrier gas flow rate where the carrier gas includes a hydrogen and plasma gas mixture (e.g., hydrogen and argon). The amount of gaseous hydrogen atoms to the plasma torch can be controlled by controlling the hydrogen flow rate and the ratio of hydrogen to plasma gas in the mixture. The hydrogen flow rate and the plasma gas flow rate to the hydrogen-plasma-gas mixer and mixture flow regulator 721 can be controlled by flow rate controllers 734 and 744, and by valves 736 and 746. Mixer regulator 721 controls the hydrogen-plasma mixture to the torch and the catalyst reservoir. The catalysis rate can also be controlled by controlling the temperature of the plasma with microwave generator 724.

Hydrino atoms, dihydrino molecular ions, dihydrino molecules, and hydrino hydride ions are produced in the plasma 704. Dihydrino molecules and hydrino hydride compounds may be cryopumped onto the manifold 706, or they may flow into a trap 708 such as a cryotrap through passage 748. Trap 708 communicates with vacuum pump 710 through vacuum line 750 and valve 752. A flow to the trap 708 is effected by a pressure gradient controlled by the vacuum pump 710, vacuum line 750, and vacuum valve 752.

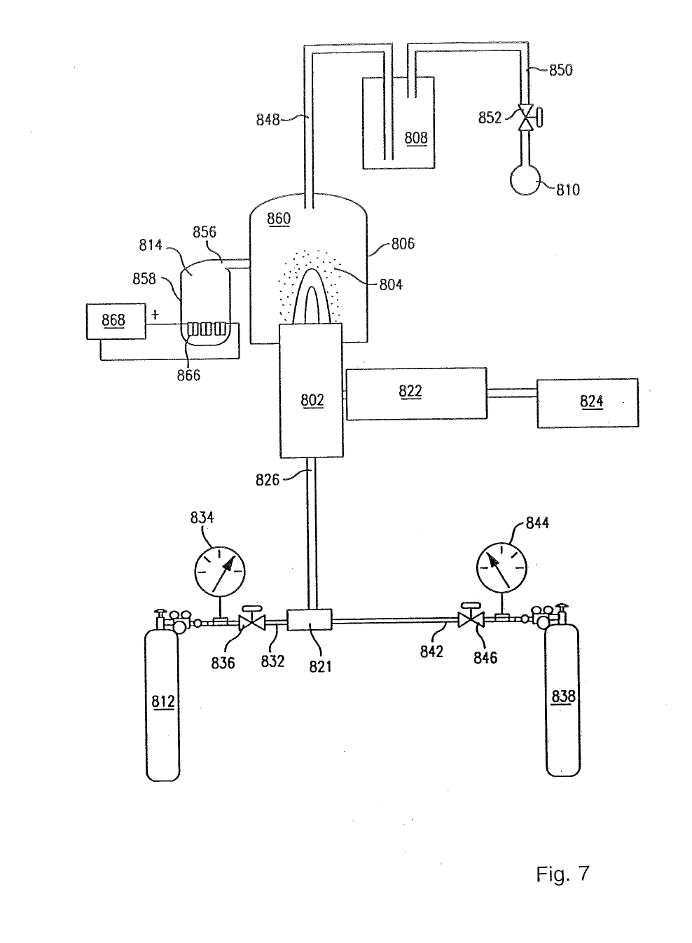

In another embodiment of the plasma torch hydrogen reactor shown in FIG. 7, at least one of plasma torch 802 or manifold 806 has a catalyst supply passage 856 for passage of the gaseous catalyst from a catalyst reservoir 858 to the plasma 804. The catalyst 814 in the catalyst reservoir 858 is heated by a catalyst reservoir heater 866 having a power supply 868 to provide the gaseous catalyst to the plasma 804. The catalyst vapor pressure can be controlled by controlling the temperature of the catalyst reservoir 858 by adjusting the heater 866 with its power supply 868. The remaining elements of FIG. 7 have the same structure and function of the corresponding elements of FIG. 6. In other words, element 812 of FIG. 7 is a plasma gas supply corresponding to the plasma gas supply 712 of FIG. 6, element 838 of FIG. 7 is a hydrogen supply corresponding to hydrogen supply 738 of FIG. 6, and so forth.

In another embodiment of the plasma torch hydrogen reactor, a chemically resistant open container such as a ceramic boat located inside the manifold contains the catalyst. The plasma torch manifold forms a cell which can be operated at an elevated temperature such that the catalyst in the boat is sublimed, boiled, or volatilized into the gas phase. Alternatively, the catalyst in the catalyst boat can be heated with a boat heater having a power supply to provide the gaseous catalyst to the plasma. The catalyst vapor pressure can be controlled by controlling the temperature of the cell with a cell heater, or by controlling the temperature of the boat by adjusting the boat heater with an associated power supply.

The plasma temperature in the plasma torch hydrogen reactor is advantageously maintained in the range of about 5,000-30,000° C. The cell may be operated at room temperature by continuously supplying catalyst. Alternatively, to prevent the catalyst from condensing in the cell, the cell temperature can be maintained above that of the catalyst source, catalyst reservoir 858 or catalyst boat. The operating temperature depends, in part, on the nature of the material comprising the cell. The temperature for a stainless steel alloy cell is preferably about 0-1200° C. The temperature for a molybdenum cell is preferably about 0-1800° C. The temperature for a tungsten cell is preferably about 0-3000° C. The temperature for a glass, quartz, or ceramic cell is preferably about 0-1800° C. Where the manifold 706 is open to the atmosphere, the cell pressure is atmospheric.

An exemplary plasma gas for the plasma torch hydrogen reactor is argon which may also serve as a source of catalyst. Exemplary aerosol flow rates are about 0.8 standard liters per minute (slm) hydrogen and about 0.15 slm argon. An exemplary argon plasma flow rate is about 5 slm. An exemplary forward input power is about 1000 W, and an exemplary reflected power is about 10-20 W.

In other embodiments of the plasma torch hydrogen reactor, the mechanical catalyst agitator (magnetic stirring bar 718 and magnetic stirring bar motor 720) is replaced with an aspirator, atomizer, or nebulizer to form an aerosol of the catalyst 714 dissolved or suspended in a liquid medium such as water. The medium is contained in the catalyst reservoir 716. Or, the aspirator, atomizer, ultrasonic dispersion means, or nebulizer injects the catalyst directly into the plasma 704. The nebulized or atomized catalyst can be carried into the plasma 704 by a carrier gas, such as hydrogen.

The hydrogen plasma torch cell further includes an electron source in contact with the hydrinos, for generating hydrino hydride ions. In the plasma torch cell, the hydrinos can be reduced to hydrino hydride ions by contacting a reductant extraneous to the operation of the cell (e.g. a consumable reductant added to the cell from an outside source). Compounds comprising a hydrino hydride anion and a cation may be formed in the cell. The cation which forms the hydrino hydride compound may comprise a cation of other element, an oxidized species such as a reductant, or a cation present in the plasma (such as a cation of the catalyst).

Hydrogen RF and Microwave Power and Plasma Cell and Reactor

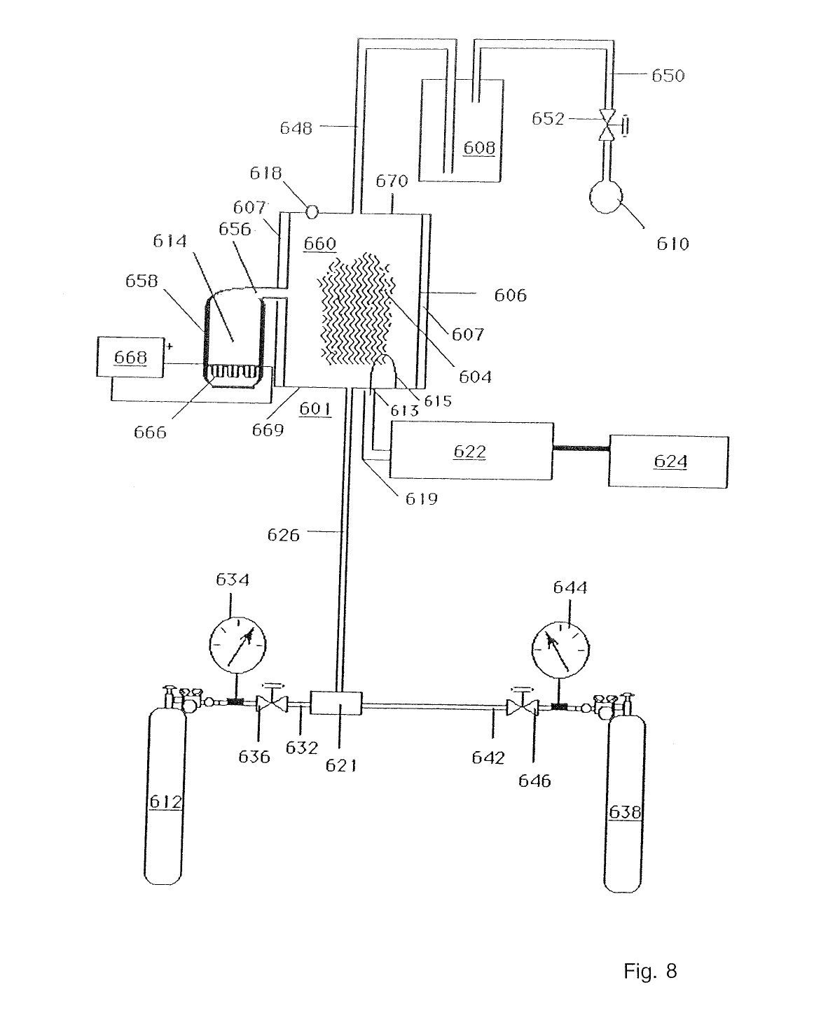

According to an embodiment of the invention, a reactor for producing power, plasma, and at least one of hydrinos, hydrino hydride ions, dihydrino molecular ions, and dihydrino molecules may take the form of a hydrogen microwave reactor. A hydrogen microwave gas cell reactor of the present invention is shown in FIG. 8. Hydrinos are provided by a reaction with a catalyst capable of providing a net enthalpy of reaction of m/2·27.2±0.5 eV where m is an integer, preferably an integer less than 400 such as those given in TABLES 1 and 3 and/or by a disproportionation reaction wherein lower-energy hydrogen, hydrinos, serve to cause transitions of hydrogen atoms and hydrinos to lower-energy levels with the release of power. Catalysis may occur in the gas phase. The catalyst may be generated by a microwave discharge. Preferred catalysts are He⁺ or Ar⁺ from a source such as helium gas or argon gas. The catalysis reaction may provide power to form and maintain a plasma that comprises energetic ions. Microwaves that may or may not be phase bunched may be generated by ionized electrons in a magnetic field; thus, the magnetized plasma of the cell comprises an internal microwave generator. The generated microwaves may then be the source of microwaves to at least partially maintain the microwave discharge plasma.

The reactor system of FIG. 8 comprises a reaction vessel 601 having a chamber 660 capable of containing a vacuum or pressures greater than atmospheric. A source of hydrogen 638 delivers hydrogen to supply tube 642, and hydrogen flows to the chamber through hydrogen supply passage 626. The flow of hydrogen can be controlled by hydrogen flow controller 644 and valve 646. In an embodiment, a source of hydrogen communicating with chamber 660 that delivers hydrogen to the chamber through hydrogen supply passage 626 is a hydrogen permeable hollow cathode of an electrolysis cell of the reactor system. Electrolysis of water produces hydrogen that permeates through the hollow cathode. The cathode may be a transition metal such as nickel, iron, or titanium, or a noble metal such as palladium, or platinum, or tantalum or palladium coated tantalum, or palladium coated niobium. The electrolyte may be basic and the anode may be nickel, platinum, or a dimensionally stable anode. The electrolyte may be aqueous K₂CO₃. The flow of hydrogen into the cell may be controlled by controlling the electrolysis current with an electrolysis power controller.

Plasma gas flows from the plasma gas supply 612 via passage 632. The flow of plasma gas can be controlled by plasma gas flow controller 634 and valve 636. A mixture of plasma gas and hydrogen can be supplied to the cell via passage 626. The mixture is controlled by hydrogen-plasma-gas mixer and mixture flow regulator 621. The plasma gas such as helium may be a source of catalyst such as He⁺ or He₂*, argon may be a source of catalyst such as Ar⁺, neon may serve as a source of catalyst such as Ne₂* or Ne⁺, and neon-hydrogen mixture may serve as a source of catalyst such as Ne⁺/H+. The source of catalyst and hydrogen of the mixture flow into the plasma and become catalyst and atomic hydrogen in the chamber 660.

The plasma may be powered by a microwave generator 624 wherein the microwaves are tuned by a tunable microwave cavity 622, carried by waveguide 619, and can be delivered to the chamber 660 though an RF transparent window 613 or antenna 615. Sources of microwaves known in the art are traveling wave tubes, klystrons, magnetrons, cyclotron resonance masers, gyrotrons, and free electron lasers. The waveguide or antenna may be inside or outside of the cell. In the latter case, the microwaves may penetrate the cell from the source through a window of the cell 613. The microwave window may comprise Alumina or quartz.

In another embodiment, the cell 601 is a microwave resonator cavity. In an embodiment, the source of microwave supplies sufficient microwave power density to the cell to ionize a source of catalyst such as at least one of helium, neon-hydrogen mixture, and argon gases to form a catalyst such as He⁺, Ne⁺, and Ar⁺, respectively. In such an embodiment, the microwave power source or applicator such as an antenna, waveguide, or cavity forms a nonthermal plasma wherein the species corresponding to the source of catalyst such as helium or argon atoms and ions have a higher temperature than that at thermal equilibrium. Thus, higher energy states such as ionized states of the source of catalyst are predominant over that of hydrogen compared to a corresponding thermal plasma wherein excited states of hydrogen are predominant. In an embodiment, the source of catalyst is in excess compared to the source of hydrogen atoms such that the formation of a nonthermal plasma is favored. The power supplied by the source of microwave power may be delivered to the cell such that it is dissipated in the formation of energetic electrons within about the electron mean free path. In an embodiment, the total pressure is about 0.5 to about 5 Torr and the mean electron free path is about 0.1 cm to 1 cm. In an embodiment, the dimensions of the cell are greater than the electron mean free path. In an embodiment, the cavity is at least one of the group of a reentrant cavity such as an Evenson cavity, Beenakker, McCarrol, and cylindrical cavity. In an embodiment, the cavity provides a strong electromagnetic field which may form a nonthermal plasma. The strong electromagnetic field may be due to a TM₁₀₁ mode of a cavity such as a Beenakker cavity. In a preferred embodiment, the cavity provides an E mode rather than an M mode. In a preferred embodiment, the cavity is a reentrant cavity such as an Evenson cavity that forms a plasma with an E mode. Multiple sources of microwave power may be used simultaneously. For example, the microwave plasma such as a nonthermal plasma may be maintained by multiple Evenson cavities operated in parallel to form the plasma in the microwave cell 601. The cell may be cylindrical and may comprise a quartz cell with Evenson cavities spaced along the longitudinal axis. In another embodiment, a multi slotted antenna such as a planar antenna serves as the equivalent of multiple sources of microwaves such as dipole-antenna-equivalent sources. One such embodiment is given in Y. Yasaka, D. Nozaki, M. Ando, T. Yamamoto, N. Goto, N. Ishii, T. Morimoto, “Production of large-diameter plasma using multi-slotted planar antenna,” Plasma Sources Sci. Technol., Vol. 8, (1999), pp. 530-533 which is incorporated herein by reference in its entirety.

In an embodiment, of the hydrogen microwave power and plasma cell and reactor, the output power is optimized by using a cavity such as a reentrant cavity such as an Evenson cavity and tuning the cell to an optimal voltage staging wave. In an embodiment, the reflected versus input power is tuned such that a desired voltage standing wave is obtained which optimizes or controls the output power. Typically, the ratio of the maximum voltage to the minimum voltage on the transmission line determines the voltage standing wave. In another embodiment, the cell comprises a tunable microwave cavity having a desired voltage standing wave to optimize and control the output power.

The cell may further comprise a magnet such a solenoidal magnet 607 to provide an axial magnetic field. The ions such as electrons formed by the hydrogen catalysis reaction produce microwaves to at least partially maintain the microwave discharge plasma. The microwave frequency may be selected to efficiently form atomic hydrogen from molecular hydrogen. It may also effectively form ions that serve as catalysts from a source of catalyst such as He⁺, Ne⁺, Ne⁺/H⁺, or Ar⁺ catalysts from helium, neon, neon-hydrogen mixtures, and argon gases, respectively.

The microwave frequency is preferably in the range of about 1 MHz to about 100 GHz, more preferably in the range about 50 MHz to about 10 GHz, most preferably in the range of about 75 MHz±50 MHz or about 2.4 GHz±1 GHz.

A hydrogen dissociator may be located at the wall of the reactor to increase the atomic hydrogen concentrate in the cell. The reactor may further comprise a magnetic field wherein the magnetic field may be used to provide magnetic confinement to increase the electron and ion energy to be converted into power by means such as a magnetohydrodynamic or plasmadynamic power converter.

A vacuum pump 610 may be used to evacuate the chamber 660 through vacuum lines 648 and 650. The cell may be operated under flow conditions with the hydrogen and the catalyst supplied continuously from catalyst source 612 and hydrogen source 638. The amount of gaseous catalyst may be controlled by controlling the plasma gas flow rate where the plasma gas includes a hydrogen and a source of catalyst (e.g., hydrogen and argon or helium). The amount of gaseous hydrogen atoms to the plasma may be controlled by controlling the hydrogen flow rate and the ratio of hydrogen to plasma gas in the mixture. The hydrogen flow rate and the plasma gas flow rate to the hydrogen-plasma-gas mixer and mixture flow regulator 621 are controlled by flow rate controllers 634 and 644, and by valves 636 and 646. Mixer regulator 621 controls the hydrogen-plasma mixture to the chamber 660. The catalysis rate is also controlled by controlling the temperature of the plasma with microwave generator 624.

Catalysis may occur in the gas phase. Hydrino atoms, dihydrino molecular ions, dihydrino molecules, and hydrino hydride ions are produced in the plasma 604. Dihydrino molecules and hydrino hydride compounds may be cryopumped onto the wall 606, or they may flow into a 608 such as a cryotrap through passage 648. Trap 608 communicates with vacuum pump 610 through vacuum line 650 and valve 652. A flow to the trap 608 can be effected by a pressure gradient controlled by the vacuum pump 610, vacuum line 650, and vacuum valve 652.

In another embodiment of the hydrogen microwave reactor shown in FIG. 8, the wall 606 has a catalyst supply passage 656 for passage of the gaseous catalyst from a catalyst reservoir 658 to the plasma 604. The catalyst in the catalyst reservoir 658 can be heated by a catalyst reservoir heater 666 having a power supply 668 to provide the gaseous catalyst to the plasma 604. The catalyst vapor pressure can be controlled by controlling the temperature of the catalyst reservoir 658 by adjusting the heater 666 with its power supply 668. The catalyst in the gas phase may comprise those given in TABLES 1 and 3, hydrinos, and those described in the Mills Prior Publication.

In another embodiment of the hydrogen microwave reactor, a chemically resistant open container such as a ceramic boat located inside the chamber 660 contains the catalyst. The reactor further comprises a heater that may maintain an elevated temperature. The cell can be operated at an elevated temperature such that the catalyst in the boat is sublimed, boiled, or volatilized into the gas phase. Alternatively, the catalyst in the catalyst boat can be heated with a boat heater having a power supply to provide the gaseous catalyst to the plasma. The catalyst vapor pressure can be controlled by controlling the temperature of the cell with a cell heater, or by controlling the temperature of the boat by adjusting the boat heater with an associated power supply.

In an embodiment, the hydrogen microwave reactor further comprises a structure interact with the microwaves to cause localized regions of high electric and/or magnetic field strength. A high magnetic field may cause electrical breakdown of the gases in the plasma chamber 660. The electric field may form a nonthermal plasma that increases the rate of catalysis by methods such as the formation of the catalyst from a source of catalyst. The source of catalyst may be argon, neon-hydrogen mixture, helium to form He⁺, Ne⁺, and Ar⁺, respectively. The structures and methods are equivalent to those given in the Plasma Torch Cell Hydride Reactor section of my previous international patent application No. WO02/087291, filed March 2002, the complete disclosure of which is incorporated herein by reference.

The nonthermal plasma temperature corresponding to the energetic ion and/or electron temperature as opposed to the relatively low energy thermal neutral gas temperature in the microwave cell reactor is advantageously maintained in the range of about 5,000-5,000,000° C. The cell may be operated without heating or insulation. Alternatively, in the case that the catalyst has a low volatility, the cell temperature is maintained above that of the catalyst source, catalyst reservoir 658 or catalyst boat to prevent the catalyst from condensing in the cell. The operating temperature depends, in part, on the nature of the material comprising the cell. The temperature for a stainless steel alloy cell is preferably about 0-1200° C. The temperature for a molybdenum cell is preferably about 0-1800° C. The temperature for a tungsten cell is preferably about 0-3000° C. The temperature for a glass, quartz, or ceramic cell is preferably about 0-1800° C.

The molecular and atomic hydrogen partial pressures in the chamber 660, as well as the catalyst partial pressure, is preferably maintained in the range of about 1 mtorr to about 100 atm. Preferably the pressure is in the range of about 100 mtorr to about 1 atm, more preferably the pressure is about 100 mtorr to about 20 torr.

An exemplary plasma gas for the hydrogen microwave reactor is argon. Exemplary flow rates are about 0.1 standard liters per minute (slm) hydrogen and about 1 slm argon. An exemplary forward microwave input power is about 1000 W. The flow rate of the plasma gas or hydrogen-plasma gas mixture such as at least one gas selected for the group of hydrogen, argon, helium, argon-hydrogen mixture, helium-hydrogen mixture, water vapor, ammonia is preferably about 0-1 standard liters per minute per cm³ of vessel volume and more preferably about 0.001-10 sccm per cm³ of vessel volume. In the case of an helium-hydrogen, neon-hydrogen, or argon-hydrogen mixture, preferably helium, neon, or argon is in the range of about 99 to about 1%, more preferably about 99 to about 95%. The power density of the source of plasma power is preferably in the range of about 0.01 W to about 100 W/cm³ vessel volume.

In other embodiments of the microwave reactor, the catalyst may be agitated and supplied through a flowing gas stream such as the hydrogen gas or plasma gas which may be an additional source of catalyst such as helium or argon gas. The source of catalyst may also be provided by an aspirator, atomizer, or nebulizer to form an aerosol of the source of catalyst. The catalyst which may become an aerosol may be dissolved or suspended in a liquid medium such as water. The medium may be contained in the catalyst reservoir 614. Alternatively, the aspirator, atomizer, or nebulizer may inject the source of catalyst or catalyst directly into the plasma 604. In another embodiment, the nebulized or atomized catalyst may be carried into the plasma 604 by a carrier gas, such as hydrogen, helium, neon, or argon where the helium, neon-hydrogen, or argon may be ionized to He⁺, Ne⁺, or Ar⁺, respectively, and serve as hydrogen catalysts.

Hydrogen may serve as the catalyst according to Eqs. (30-32). In an embodiment the catalysis of atomic hydrogen to form increased-binding-energy-hydrogen species is achieved with a hydrogen plasma. The cavity may be reentrant cavity such as an Evenson cavity. The hydrogen pressure may be in the range of about 1 mtorr to about 100 atm. Preferably the pressure is in the range of about 100 mtorr to about 1 atm, more preferably the pressure is about 100 mtorr to about 10 torr. The microwave power density may be in the range of about 0.01 W to about 100 W/cm³ vessel volume. The hydrogen flow rate may be in the range of about 0-1 standard liters per minute per cm³ of vessel volume and more preferably about 0.001-10 sccm per cm³ of vessel volume.

The microwave cell may be interfaced with any of the converters of plasma or thermal energy to mechanical or electrical power described herein such as the magnetic mirror magnetohydrodynamic power converter, plasmadynamic power converter, or heat engine, such as a steam or gas turbine system, sterling engine, or thermionic or thermoelectric converter given in Mills Prior Publications. In addition it may be interfaced with the gyrotron, photon bunching microwave power converter, charge drift power, or photoelectric converter as disclosed in Mills Prior Publications.

The hydrogen microwave reactor further includes an electron source in contact with the hydrinos, for generating hydrino hydride ions. In the cell, the hydrinos may be reduced to hydrino hydride ions by contacting a reductant extraneous to the operation of the cell (e.g. a consumable reductant added to the cell from an outside source). In an embodiment, the microwave cell reactor further comprise a selective valve 618 for removal of lower-energy hydrogen products such as dihydrino molecules. Compounds comprising a hydrino hydride anion and a cation may be formed in the gas cell. The cation which forms the hydrino hydride compound may comprise a cation of other element, a cation of an oxidized added reductant, or a cation present in the plasma (such as a cation of the catalyst).

Metal hydrino hydrides may be formed in the microwave plasma reactor having a hydrogen plasma and a source of metal such as a source of the metals given in TABLE 3 that serve as both the catalyst and the reactant. The metal atoms may be provided by vaporization through heating. In one embodiment, the metal is vaporized from a hot filament containing the metal. The vapor pressure of the metal is maintained in the range 0.001 Torr to 100 Torr and the hydrogen plasma is maintained in the range 0.001 Torr to 100 Torr. Preferably the range for both metal and hydrogen is 0.1 Torr to 10 Torr.

Hydrogen Capacitively and Inductively Coupled RF Plasma and Power Cell and Reactor

According to an embodiment of the invention, a reactor for producing power and at least one of hydrinos, hydrino hydride ions, dihydrino molecular ions, and dihydrino molecules may take the form of a hydrogen capacitively or inductively coupled RF power and plasma cell and reactor. A hydrogen RF plasma reactor of the present invention is also shown in FIG. 8. The cell structures, systems, catalysts, and methods may be the same as those given for the microwave plasma cell reactor except that the microwave source may be replaced by a RF source 624 with an impedance matching network 622 that may drive at least one electrode and/or a coil. The RF plasma cell may further comprise two electrodes 669 and 670. The coaxial cable 619 may connect to the electrode 669 by coaxial center conductor 615. Alternatively, the coaxial center conductor 615 may connect to an external source coil which is wrapped around the cell 601 which may terminate without a connection to ground or it may connect to ground. The electrode 670 may be connected to ground in the case of the parallel plate or external coil embodiments. The parallel electrode cell may be according to the industry standard, the Gaseous Electronics Conference (GEC) Reference Cell or modification thereof by those skilled in the art as described in G A. Hebner, K. E. Greenberg, “Optical diagnostics in the Gaseous electronics Conference Reference Cell, J. Res. Natl. Inst. Stand. Technol., Vol. 100, (1995), pp. 373-383; V. S. Gathen, J. Ropcke, T. Gans, M. Kaning, C. Lukas, H. F. Dobele, “Diagnostic studies of species concentrations in a capacitively coupled RF plasma containing CH₄—H₂—Ar,” Plasma Sources Sci. Technol., Vol. 10, (2001), pp. 530-539; P. J. Hargis, et al., Rev. Sci. Instrum., Vol. 65, (1994), p. 140; Ph. Belenguer, L. C. Pitchford, J. C. Hubinois, “Electrical characteristics of a RF-GD-OES cell,” J. Anal. At. Spectrom., Vol. 16, (2001), pp. 1-3 which are herein incorporated by reference in their entirety. The cell which comprises an external source coil such as a 13.56 MHz external source coil microwave plasma source is as given in D. Barton, J. W. Bradley, D. A. Steele, and R. D. Short, “investigating radio frequency plasmas used for the modification of polymer surfaces,” J. Phys. Chem. B, Vol. 103, (1999), pp. 4423-4430; D. T. Clark, A. J. Dilks, J. Polym. Sci. Polym. Chem. Ed., Vol. 15, (1977), p. 2321; B. D. Beake, J. S. G. Ling, G. J. Leggett, J. Mater. Chem., Vol. 8, (1998), p. 1735; R. M. France, R. D. Short, Faraday Trans. Vol. 93, No. 3, (1997), p. 3173, and R. M. France, R. D. Short, Langmuir, Vol. 14, No. 17, (1998), p. 4827 which are herein incorporated by reference in their entirety. At least one wall of the cell 601 wrapped with the external coil is at least partially transparent to the RF excitation. The RF frequency is preferably in the range of about 100 Hz to about 100 GHz, more preferably in the range about 1 kHz to about 100 MHz, most preferably in the range of about 13.56 MHz±50 MHz or about 2.4 GHz±1 GHz.

In another embodiment, an inductively coupled plasma source is a toroidal plasma system such as the Astron system of Astex Corporation described in U.S. Pat. No. 6,150,628 which is herein incorporated by reference in its entirety. In an embodiment, the field strength is high to cause a nonthermal plasma. The toroidal plasma system may comprise a primary of a transformer circuit. The primary may be driven by a radio frequency power supply. The plasma may be a closed loop which acts at as a secondary of the transformer circuit. The RF frequency is preferably in the range of about 100 Hz to about 100 GHz, more preferably in the range about 1 kHz to about 100 MHz, most preferably in the range of about 13.56 MHz±50 MHz or about 2.4 GHz±1 GHz.

In an embodiment, the plasma cell is driven by at least one of a traveling and a standing wave plasma generators such as given in Fossa [A. C. Fossa, M. Moisan, M. R. Wertheimer, “vacuum ultraviolet to visible emission from hydrogen plasma: effect of excitation frequency”, Journal of Applied Physics, Vol. 88, No. 1, (2000), pp. 20-33 which is herein incorporated by reference in its entirety].

In another embodiment, the frequency of the cell is 50 kHz and is driven by a radio frequency generator such as that given by Bzenic et. al. [S. A. Bzenic, S. B. Radovanov, S. B. Vrhovac, Z. B. Velikic, and B. M. Jelenkovic, “On the mechanism of Doppler broadening of H_{β} after dissociative excitation in hydrogen glow discharges”, Chem. Phys. Lett., Vol. 184, (1991), pp. 108-112 which is herein incorporate by reference in its entirety].

In another embodiment of the plasma cell for the production of power and lower-energy-hydrogen compounds, the cell comprises a helicon as described in Asian Particle Accelerator Conference (APAC98), March 26th—Poster Presentation 6D-061, Development of DC Accelerator Ion Sources using Helicon Plasmas p. 825, G. S. Eom, I. S. Hong, Y. S. Hwang, KAIST, Taejon, <http://accelconf.web.cern.ch/AccelConf/a98/APAC98/6D061.PDF>http://accelconf.web.cern.ch/AccelConf/a98/APAC98/6D061.PDFG which is herein incorporated by reference in its entirety.

Plasma Confinement by Spatially Controlling Catalysis

The plasma formed by the catalysis of hydrogen may be confined to a desired region of the reactor by structures and methods such as those that control the source of catalyst, the source of atomic hydrogen, or the source of an electric or magnetic field which alters the catalysis rate as given in the Adjustment of Catalysis Rate section. In an embodiment, the reactor comprises two electrodes, which provide an electric field to control the catalysis rate of atomic hydrogen. The electrodes may produce an electric field parallel to the z-axis. The electrodes may be grids oriented in a plane perpendicular to the z-axis such as grid electrodes 305 and 320 shown in FIG. 4. The space between the electrodes may define the desired region of the reactor. The electrodes may be used in any or the other reactor of the present invention to catalyze atomic hydrogen to lower-energy states such as a plasma electrolysis reactor, barrier electrode reactor, RF plasma reactor, pressurized gas energy reactor, gas discharge energy reactor, microwave cell energy reactor, and a combination of a glow discharge cell and a microwave and or RF plasma reactor.

In another embodiment, a magnetic field may confine a charged catalyst such as Ar⁺ to a desired region to selectively form a plasma as described in the Noble Gas Catalysts and Products section. In an embodiment of the cell, the reaction is maintained in a magnetic field such as a solenoidal or minimum magnetic (minimum B) field such that a second catalyst such as Ar⁺ is trapped and acquires a longer half-life. The second catalyst may be generated by a plasma formed by hydrogen catalysis using a first catalyst. By confining the plasma, the ions such as the electrons become more energetic, which increases the amount of second catalyst such as Ar⁺. The confinement also increases the energy of the plasma to create more atomic hydrogen.

In another embodiment, a hot filament which dissociates molecular hydrogen to atomic hydrogen and which may also provide an electric field that controls the rate of catalysis may be used to define the desired region in the cell. The plasma may form substantially in the region surrounding the filament wherein at least one of the atomic hydrogen concentration, the catalyst concentration, and the electric field provides a much faster rate of catalysis there than in any undesired region of the reactor.

In another embodiment, the source of atomic hydrogen such as the source of molecular hydrogen or a hydrogen dissociator may be used to determine the desired region of the reactor by providing atomic hydrogen selectively in the desired region.

In an another embodiment, the source of catalyst may determine the desired region of the reactor by providing catalyst selectively in the desired region.

In an embodiment of a microwave power cell, the plasma may be maintained in a desire region by selectively providing microwave energy to that region with at least one antenna 615 or waveguide 619 and RF window 613 shown in FIG. 8. The cell may comprise a microwave cavity which causes the plasma to be localized to the desired region.

Hydrogen Multicusp Power and Plasma Cell and Reactor

In an embodiment, the power and plasma cell and reactor comprises a filament, a vacuum vessel capable of pressures above and below atmospheric, a source of atomic hydrogen, a source of catalyst to catalyze atomic hydrogen to a lower-energy state given by Eq. (1), a means to negatively bias the walls of the cell relative to the filament, and magnets to confine a plasma generated in the cell which is formed or enhanced by the catalysis reaction (rt-plasma). In an embodiment, the reactor is described in M. Pealat, J. P. E. Taran, M. Bacal, F. Hillion, J. Chem. Phys., Vol. 82, (1985), p. 45943-4953 and J. Perrin, J. P. M. Schmitt, Chem. Phys. Letts., Vol. 112, (1984), pp. 69-74 which are herein incorporated by reference in their entirety. In this case, in addition, the cell further comprises a source of catalyst to catalyze atomic hydrogen to a lower-energy state given by Eq. (1). An embodiment of the multicusp cell is shown in FIG. 3 wherein the walls are negative biased by a power supply, and magnets such as permanent magnets that enclose the cell to confine the plasma generated inside the cell 200.

### Electron-Beam-Initiated High-Voltage Pulsed Discharge Plasma and Power Cell and Reactor

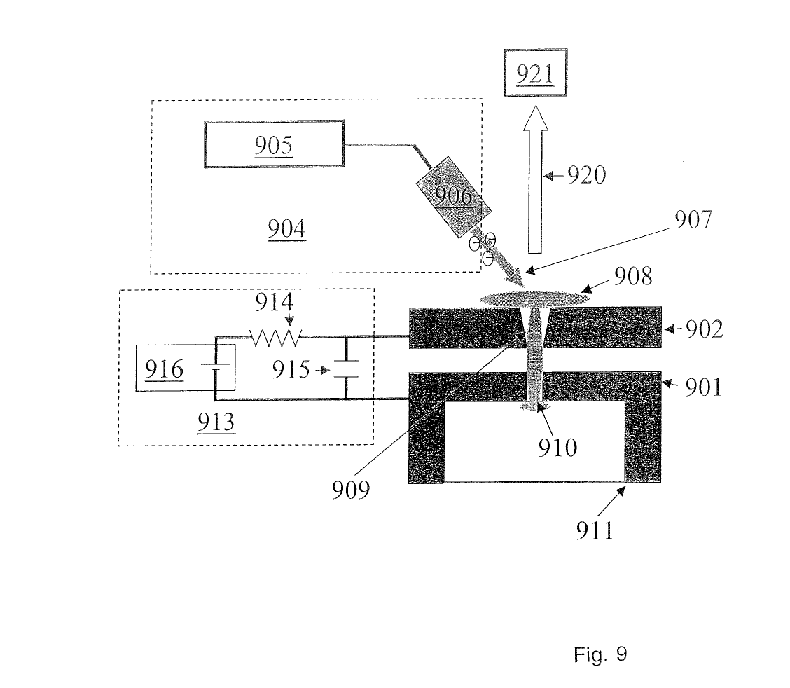

The cell structures, systems, catalysts, and methods of the electron-beam-initiated, high-voltage pulsed discharge plasma and power cell and reactor of the present invention shown in FIG. 9 may be the same as those and given for the Hydrogen Gas Discharge Power and Plasma Cell and Reactor given in Sec. 1.3 and shown in FIG. 4 except that a pulse of high-voltage applied to two electrodes, a cathode and an anode to form a plasma may be triggered by an electron beam. The cell 307 comprising a hydrogen isotope gas-filled glow discharge vacuum vessel 313 having a chamber 300 is shown in FIG. 4. A hydrogen source 322 supplies hydrogen to the chamber 300 through control valve 325 via a hydrogen supply passage 342. A catalyst is contained in catalyst reservoir 395 that is gaseous at room temperature or may be heated to become gaseous in the plasma cell. A voltage and current source 330 causes current to pass between a cathode 305 and an anode 320. The plasma may be pulsed or intermittent.

In addition, the plasma discharge system shown in FIG. 9 comprises a cathode 901 and an anode 902, a high voltage source 913, and an electron beam trigger 904. The high voltage source 913 may comprise a high voltage power supply 916 and an RC circuit 914 and 915. The electron-beam trigger 904 may comprise a high-voltage pulse generator 905, an electron gun 906, and an electron beam 907. The plasma 908 may be an electron-beam-initiated, high-voltage pulsed discharge. The electron gun 906 driven by the high voltage pulse generator 905 with a voltage in the range of 1 V to 1 MV, preferably in the range of 100 V to 100 kV, most preferably in the range of 1 kV to 10 kV provides a pulsed electron beam 907. The beam energy may be in the range of 1 eV to 1 MeV, preferably in the range of 100 eV to 100 keV, most preferably in the range of 1 keV to 10 keV. The beam current may be in the range of about 0.01 μA to 1000 A, preferably on the range of about 0.1 μA to 100 A, more preferably in the range of about 1 μA to 10 A, and most preferably in the range of about 10 μA to 1 A. The electron beam triggers a high-voltage pulsed discharge. The pulse duration is in the range of 1 ns to 100 s, preferably in the range of 1 μs to 1 s, most preferably in the range of 1 to 10 ms. The repetition rate may be in the range of 0.001 Hz to 10 GHz, preferably in the range of 0.1 Hz to 100 Hz, most preferably in the range of 1 to 10 Hz. The negative high voltage power supply 916 applies high voltage to the cathode of the main discharge in the range of 1 to 10 MV, preferably in the range of 100 V to 100 kV, most preferably in the range of 1 kV to 20 kV.

The electrodes may be microhollow electrodes. In an embodiment, the anode comprises a tapered microhollow anode with a variable bore 909 with a reduction ratio in the range of 1 to 0.001, preferably in the range of 1 to 0.1, and most preferably in the range of 1 to 0.5, and a diameter in the range of 1 nm to 10 cm, preferably in the range of 1 μm to 1 cm, and most preferably in the range of 1 mm to 5 mm. The cathode may be a microhollow cathode 910 with a diameter in the range of 1 nm to 10 cm, preferably in the range of 1 μm to 1 cm, and most preferably in the range of 1 mm to 5 mm. The electrodes are separated by a gap in the range of 1 nm to 1 m, preferably in the range of 1 μm to 1 cm, and most preferably in the range of 1 mm to 5 mm. The hollow cathode may further comprise plasma chamber 911 opposite the inter-electrode region with a width in the range of 0.1 mm to 100 cm, preferably in the range of 1 mm to 1 cm, and most preferably 10 to 20 mm.

The molecular and atomic hydrogen partial pressures in the chamber 300 of FIG. 4, as well as the catalyst partial pressure, is preferably maintained in the range of about 1 mtorr to about 100 atm. Preferably the pressure is in the range of about 100 mtorr to about 1 atm, more preferably the pressure is about 100 mtorr to about 1 torr.

The flow rate of the plasma gas or hydrogen-plasma gas mixture such as at least one gas selected for the group of hydrogen, argon, helium, argon-hydrogen mixture, helium-hydrogen mixture, and water vapor is about 0.001-1 standard liters per minute per cm³ of vessel volume more preferably about 0.001-10 sccm per cm³ of vessel volume, and most preferably 0.1 to 1 sccm per cm³ of vessel volume. In the case of an helium-hydrogen, neon-hydrogen, or argon-hydrogen mixture, preferably helium, neon, or argon is in the range of about 99 to about 1%, preferably about 99 to about 50%, and most preferably 98 to 95%. The power density of the source of plasma power is preferably in the range of about 0.01 W to about 100 W/cm³ vessel volume. The mole fraction of hydrogen in the catalyst-hydrogen gas is in the range of about 0.001% to 90%. Preferably it is in the range of about 0.01% to 10%, and most preferably it is in the range of about 0.1% to 5%. The flow rate and pressure are maintained according to that of catalyst-hydrogen mixture to achieve these desired mole fractions.

Hydrogen may serve as the catalyst according to Eqs. (30-32). In an embodiment the catalysis of atomic hydrogen to form increased-binding-energy-hydrogen species is achieved with a hydrogen plasma. The hydrogen pressure may be in the range of about 1 mtorr to about 100 atm. Preferably the pressure is in the range of about 100 mtorr to about 1 atm, more preferably the pressure is about 100 mtorr to about 10 torr. The hydrogen flow rate may be in the range of about 0-1 standard liters per minute per cm³ of vessel volume and more preferably about 0.001-10 sccm per cm³ of vessel volume.

Catalyst Laser

A laser of the present invention comprises at least one of a laser medium comprising an inverted population of a state of the catalyst or a species formed from the catalyst, a laser cavity, laser cavity mirrors, a power source, and a output laser beam from the cavity through one of the mirrors or a windowless output. The invention may further comprise Brewer windows and further optical components to cause stimulated emission of an inverted population of the laser medium in the cavity. In an embodiment, the laser has a sufficient path length such that gain is achieved in the absence of mirrors. In an embodiment that provides EUV laser emission for EUV lithography, the mirrors may comprise multilayer, thin-film coatings such as distributed Bragg reflectors as described by J. E. Bjorkholm, “EUV lithography—the successor to optical lithography?”, Intel Technology Journal, Q3, (1998), pp. 1-8 which is herein incorporated by reference. In a further preferred embodiment, the mirror is Mo:Si ML that has been optimized for peak reflectivity at 13.4 nm. The optical components are known by those skilled in the art and are appropriate for the desired wavelength.

A laser light source of the present invention comprises an inverted population of the emitting species, a cell, a power source, and a output window from the cell. The power input to create a plasma to initiate the catalyst reaction may be at least one of microwave, high voltage, and RF discharges and a particle beam such as an electron beam wherein the system may further comprise a window for an electron beam such as a SiNₓ foil window. The system to create a plasma to form atomic hydrogen and the catalyst may comprises an electron-beam-initiated, high-voltage pulsed discharge plasma of catalyst-hydrogen gases. In an embodiment, the power source may at least partially comprise an increased-binding-energy-hydrogen species reactor, a cell for the catalysis of atomic hydrogen to form novel hydrogen species and/or compositions of matter comprising new forms of hydrogen. The reaction may be maintained by a particle beam, microwave, glow, or RF discharge plasma of a source of atomic hydrogen and a source of catalyst such as helium or argon to provide catalyst He⁺ and Ar⁺, respectively. At least one of the power from catalysis and an external power source maintains an inverted population of one or more states of the catalyst or species formed from the catalyst from which stimulate emission may occur. The emission may be in the ultraviolet (UV) and extreme ultraviolet (EUV) which may be used for photolithography. In an embodiment for short wavelength light such as EUV or soft-X-ray light, the light source further comprises a pin-hole optic that may be differentially pumped to serve as a “windowless” exit for the light from the cell.

In one embodiment wherein He⁺ serves as the catalyst, electronic transitions to fractional Rydberg states of atomic hydrogen given by Eq. (1) occur when 54.417 eV is transferred nonradiatively from atomic hydrogen to He⁺ which is resonantly ionized. The electron decays to the n=⅓ state with the further release of 54.417 eV which may be emitted as a photon or can further serve to ionize He⁺. The catalysis reaction is

$$\begin{matrix}54.417 e V + {H e}^{+} + H [ {a}_{H} ] -> {H e}^{2 +} + {e}^{-} + H [ \frac{{a}_{H}}{3} ] + 108.8 e V & ( 86 ) \\ {H e}^{2 +} + {e}^{-} -> {H e}^{+} + 54.417 e V & ( 87 )\end{matrix}$$

And, the overall reaction is

$$H [ {a}_{H} ] -> H [ \frac{{a}_{H}}{3} ] + 54.4 e V + 54.4 e V \qquad ( 88 )$$

Since the reactions given by Eqs. (86-88) involve two steps of energy release, it may be written as follows:

$$\begin{matrix}54.417 e V + {H e}^{+} + H [ {a}_{H} ] -> {H e}^{2 +} + {e}^{-} + H * [ \frac{{a}_{H}}{3} ] + 54.4 e V & ( 89 ) \\ H * [ \frac{{a}_{H}}{3} ] -> H [ \frac{{a}_{H}}{3} ] + 54.4 e V & ( 90 ) \\ {H e}^{2 +} + {e}^{-} -> {H e}^{+} + 54.417 e V & ( 91 )\end{matrix}$$

And, the overall reaction is

$$H [ {a}_{H} ] \to H [ \frac{{a}_{H}}{3} ] + 54.4 eV + 54.4 eV \qquad ( 92 )$$

where

$$H * [ \frac{{a}_{H}}{3} ]$$

has the radius of the hydrogen atom and a central field equivalent to 3 times that of a proton and is

$$H [ \frac{{a}_{H}}{3} ]$$

the corresponding stable state with the radius of ⅓ that of H.

Akatsuka et al. [H. Akatsuka, M. Suzuki, “Stationary population inversion of hydrogen in arc-heated magnetically trapped expanding hydrogen-helium plasma jet”, Phys. Rev. E, Vol. 49, (1994), pp. 1534-1544] show that it is characteristic of cold recombining plasmas to have the high lying levels in local thermodynamic equilibrium (LTE); whereas, population inversion is obtained when Tₑ suddenly decreases concomitant with rapid decay of the lower lying states. Since inversion has never been achieved in a steady-sate plasma cell, it is remarkable that inversion of the He⁺ lines occurred when hydrogen was introduced to the plasma as predicted. In further embodiments, at least one of K, Sr⁺, Ne⁺, Ne⁺/H⁺ and Ar⁺ serve as the catalyst, and the inverted population is formed in the catalyst or in a species formed from the catalyst by the energetic hydrogen catalysis reaction which pumps the state. The catalyst reactions to form the inverted states in at least one of K³⁺, K²⁺, K⁺, and K are given by Eqs. (3-5). The catalyst reactions to form the inverted states in at least one of Sr³⁺, Sr^{2α}, and Sr⁺ are given by Eqs. (9-11).). The catalyst reactions to form the inverted states in at least one of Ne²⁺ and Ne⁺ are given by Eqs. (18-20) and Eqs. (21-23). The catalyst reactions to form the inverted states in at least one of Ar²⁺ and Ar⁺ are given by Eqs. (15-17).

In further embodiments, Sr⁺, Ne⁺, Ne+/H⁺ or Ar⁺ catalysts are formed from a source comprising strontium vapor and neon, neon-hydrogen mixture, and argon gases, respectively. The source of catalyst may be ionized to form the catalyst by means such as an electron beam and a plasma. The plasma may be at least partially driven by an external power source and may be driven by the catalyst of atomic hydrogen initiated with a first catalyst wherein the energetic reaction creates a plasma and secondarily ionizes the source of catalyst to form the catalyst. The pumping power source may be from the catalysis of atomic hydrogen to states having a binding energy given by

$$\begin{matrix}\begin{matrix}{E}_{n} = - \frac{{e}^{2}}{{n}^{2} 8 {πɛ}_{o} {a}_{H}} \\ = - \frac{13.598 eV}{{n}^{2}}\end{matrix} & ( 93 ) \\ n = \frac{1}{2} , \frac{1}{3} , \frac{1}{4} , … , \frac{1}{p} ; p \leq 137 is an integer & ( 94 )\end{matrix}$$

In an embodiment of the power cell and hydride reactor to form atomic states of hydrogen having energies given by

$$\frac{13.6 eV}{{( \frac{1}{p} )}^{2}}$$

where p is an integer by reaction of atomic hydrogen with a catalyst, a catalyst is generated from a source of catalyst by ionization or excimer formation. In the latter case the cell comprises at least one of an rt-plasma reactor, a plasma electrolysis reactor, barrier electrode reactor, RF plasma reactor, pressurized gas energy reactor, gas discharge energy reactor, an electron-beam-initiated, high-voltage pulsed discharge plasma reactor, a microwave cell energy reactor, and a combination of a glow discharge cell and a microwave and or RF plasma reactor of the present invention. Each reactor comprises a source of hydrogen; one of a solid, molten, liquid, and gaseous source of catalyst; a vessel containing hydrogen and the catalyst wherein the reaction to form lower-energy hydrogen occurs by contact of the hydrogen with the catalyst.

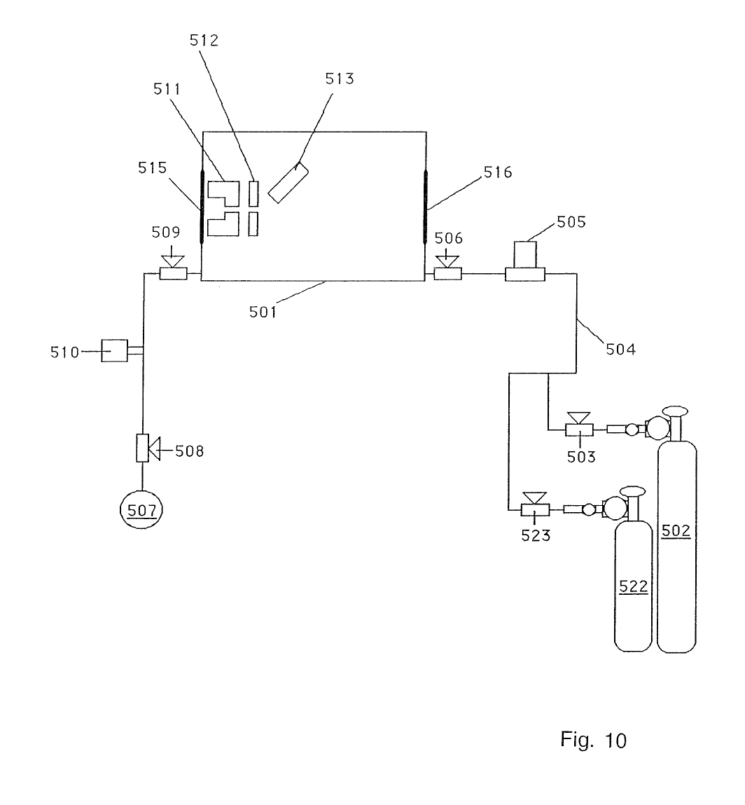

A preferred embodiment of the laser comprises a laser cavity, cavity mirrors, and a power source that may at least partially comprise a cell for the catalysis of atomic hydrogen to form novel hydrogen species and/or compositions of matter comprising new forms of hydrogen. The reaction is preferably maintained by an electron-beam-initiated, high-voltage pulsed discharge plasma of a source of atomic hydrogen and a source of catalyst such as helium and argon to provide catalysts He⁺ and Ar⁺, respectively. An embodiment of the laser shown in FIG. 10 comprises a cavity 501, a source of catalyst 502, a source of hydrogen 523, and a valve 503, a gas supply line 504, a mass flow controller 505, and a valve 506 control the flow of the plasma gases to the cavity. The gas may be flowed through the cavity 501 using pump 507 and valves 508 and 509. The pressure in the cell may be monitored with pressure gauge 510 which also maintains the pressure in the cell with the valves 508 and 509. An embodiment of the laser further comprises an electron-beam-initiated, high-voltage pulsed discharge plasma and power cell and reactor having a cathode 511, an anode 512, and an electron gun 513 of the electron beam trigger. An inverted population of a state of the catalyst or a species formed from the catalyst gas in the cavity 501 is formed by the initiation of a high-voltage pulsed plasma triggered by the electron beam from the electron gun 513.

Laser oscillators occur in the cavity 501 which has the appropriate dimensions and mirrors for lasing that is known to those skilled in the art as described in J. J. Ewing, “Excimer Lasers,” Laser Handbook, edited by M. L. Stitch, North-Holland Publishing Company, Vol. A4, (1979); Laser Handbook, edited by F. T. Arecchi and E. O, Schultz-Dubois, North-Holland Publishing Company, Amsterdam, Vol. 1-6, (1972); M. Brotherton, Masers and lasers: how they work, what they do, New York: McGraw-Hill Book Company, (1964); J. S. Thorp, Masers and lasers: Physics and design, New York: St. Martin's Press, (1967); G. Troup, Masers and lasers: molecular amplification and oscillation by stimulated emission, 2nd Edition, London: Methuen & Co. Ltd, (1963); T. K. Ishii, Maser and laser engineering, Huntington, N.Y.: Robert E. Krieger Publishing Company, (1980); A. E. Siegman, An introduction to lasers and masers, New York: McGraw-Hill Book Company, (1971); C. A. Hogg and L. Sucsy, Research report: Masers and lasers, Cambridge, Mass.: Maser/Laser Associates, (1962), M. J. Beesley, Lasers and Their Applications, Taylor & Francis Ltd, London, (1971) which are herein incorporated by reference in their entirety. The laser light is contained in the cavity 501 between the mirrors 515 and 516. The mirror 516 may be semitransparent, and the light may exit the cavity through this mirror.

In an embodiment that provides EUV laser emission for EUV lithography, the mirrors 515 and 516 may comprise multilayer, thin-film coatings such as distributed Bragg reflectors as described by J. E. Borkholm, “EUV lithography—the successor to optical lithography?” Intel Technology Journal, Q3, (1998), pp. 1-8, which is herein incorporated by reference. In a further preferred embodiment, the mirror is Mo:Si ML that has been optimized for peak reflectivity at 13.4 nm. In an embodiment of an EUV laser, the output is through a pin-hole optic that may be differentially pumped. The cavity may be sufficiently long such that lasing occurs without mirrors to increase the path length.

In the embodiment of the laser of the present invention, the cavity 501 of FIG. 10 comprises a reactor of the present invention to catalyze atomic hydrogen to lower-energy states such as an electron-beam-initiated, high-voltage pulsed discharge plasma and power cell and reactor, an rt-plasma reactor, plasma electrolysis reactor, barrier electrode reactor, RF plasma reactor, pressurized gas energy reactor, gas discharge energy reactor, microwave cell energy reactor, and a combination of a glow discharge cell and a microwave and/or RF plasma reactor of the present invention. The reaction may also be maintained by the plasma formed with the electron beam 513. The catalyst may be supplied by a source of catalyst 502, and hydrogen may be supplied to the reactor from a source 522. The flow of catalyst and hydrogen may be controlled independently through line 504 with mass flow controller 505 and valves 503 and 523. The source of catalyst may be helium or argon gas, and the catalyst may be He⁺ and Ar⁺, respectively.

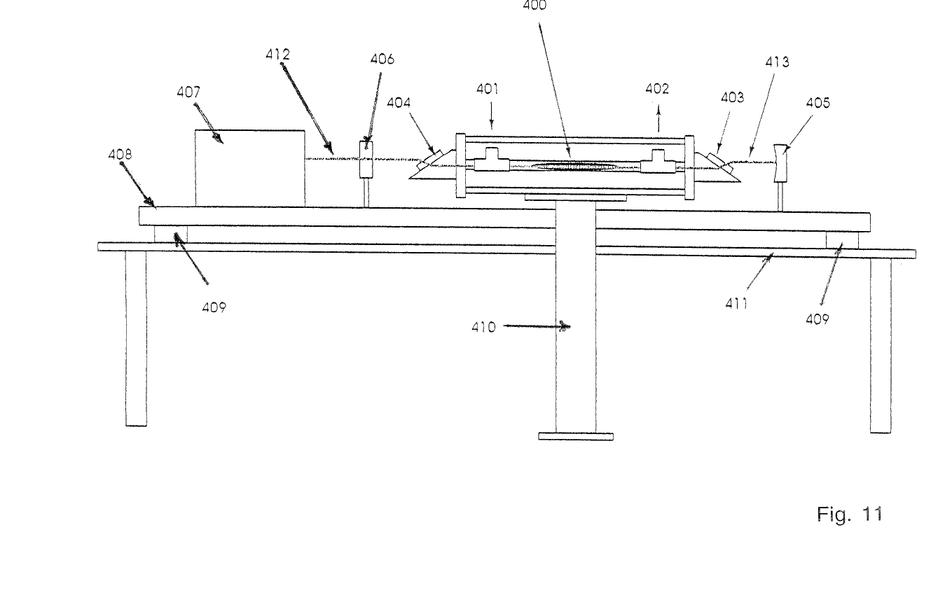

A laser according to the preset invention is shown in FIG. 11. It comprises an inverted population of a state of the catalyst or a species form from the catalyst, a plasma of a catalyst and hydrogen, and laser optics. The plasma may be maintained in an electron-beam-initiated, high-voltage pulsed discharge plasma reactor, an rt-plasma reactor, a plasma electrolysis reactor, a barrier electrode reactor, an RF plasma reactor, a pressurized gas energy reactor, a gas discharge energy reactor, a microwave cell energy reactor, and a combination of a glow discharge cell and a microwave and/or RF plasma reactor. The plasma 400 preferably is maintained by an electron-beam-initiated, high-voltage pulsed discharge plasma (discharge components are shown in FIG. 9). The plasma gas containing hydrogen and catalyst may flow through the cavity via inlet 401 and outlet 402. The laser beam 412 and 413 is directed to a high reflectivity mirror 405, such as a 95 to 99.9999% reflective spherical cavity mirror, and to the output coupler 406 by windows 403 and 404, such as Brewster angle windows. The output coupler may have a transmission in the range 0.1 to 50%, and preferably in the range 1 to 10%. The beam power may be measured by a power meter 407. The laser may be mounted on an optical rail 408 on an optical table 411 which allows for adjustments of the cavity length to achieve lasing at a desired wavelength. Vibrations may be ameliorated by vibration isolation feet 409. The plasma tube may be supported by a plasma tube support structure 410.

While the claimed invention has been described in detail and with reference to specific embodiments thereof, it will be apparent to one of ordinary skill in the art that various changes and modifications can be made to the claimed invention without departing from the spirit and scope thereof.

I claim:

1. A laser and light source comprising:
a cavity;
a source of atomic hydrogen in communication with the cavity; and
a source of catalyst for catalyzing the reaction of hydrogen atoms to lower-energy hydrogen in communication with the cavity, wherein the catalyst is selected such that during operation of the laser or light source the catalyst or a species formed from the catalyst forms an inverted population during reaction with hydrogen atoms to form lower-energy hydrogen.

2. The laser of claim 1 further comprising cavity mirrors and a laser-beam output.

3. The laser of claim 2 wherein the laser light is within the range of wavelengths from about infrared, visible, ultraviolet, extreme ultraviolet, to soft X-ray.

4. The laser of claim 3 wherein the wavelength is useful for EUV lithography in the range of 5-100 nm.

5. The laser of claim 4 wherein the wavelength is useful for EUV lithography and the mirrors comprise multilayer, thin film coatings such as distributed Bragg reflectors.

6. The laser of claim 5 wherein the wavelength is at least one of about 13.4 nm and 11.3 nm and the mirrors comprise Mo:Si ML.

7. The laser of claim 6 wherein the exit for the beam output is an ultraviolet transparent window such as a MrF₂ window.

8. The laser of claim 7 wherein the beam output is a differentially pumped pin-hole optic.

9. The laser of claim 8 wherein the cavity further comprises an electron window for an electron beam such as a SiN, foil window.

10. A laser comprising:
a plasma forming cell or reactor;
a source of atomic hydrogen in communication with the cell or reactor;
a source of catalyst in communication with the cell or reactor for the catalysis of atomic hydrogen to lower-energy hydrogen, wherein during operation of the cell or reactor a continuous stationary inverted population of at least one state of the catalyst of a species of catalyst is formed; and
a means to form and output a laser beam.

11. The laser of claim 10 wherein the cell is capable of maintaining a vacuum or pressures greater than atmospheric pressure.

12. The laser of claim 11 wherein the catalysis of atomic hydrogen generates a plasma, power, and novel hydrogen species and compositions of matter comprising new forms of hydrogen.

13. The laser of claim 12 wherein the means to form an output a laser beam comprises a cavity, cavity mirrors, and a beam output.

14. The laser of claim 13 wherein the cavity comprises a reactor to catalyze atomic hydrogen to lower-energy states such as an electron-beam-initiated, high-voltage pulsed discharge plasma and power cell and reactor, an rt-plasma reactor, plasma electrolysis reactor, barrier electrode reactor, RF plasma reactor, pressurized gas energy reactor, gas discharge energy reactor, microwave cell energy reactor, a combination of a glow discharge cell and a microwave and/or RF plasma reactor, and an electron-beam plasma reactor.

15. The laser of claim 14 wherein the electron-beam-initiated, high-voltage pulsed discharge plasma and power cell and reactor comprises a cell comprising a hydrogen isotope gas-filled glow discharge vacuum vessel, hydrogen source that supplies hydrogen to the chamber through control valve via a hydrogen supply passage; a catalyst contained in catalyst reservoir that is gaseous at room temperature or is heated to become gaseous in the plasma cell, a cathode, an anode, a voltage and current source to cause current to pass between the cathode and the anode, and a power source that drives a continuous or pulsed or intermittent plasma.

16. The laser of claim 15 wherein the electron-beam-initiated, high-voltage pulsed discharge plasma and power cell and reactor further comprises a high voltage source and an electron beam trigger.

17. The laser of claim 16 wherein the high voltage source comprises a high voltage power supply and an RC circuit,

18. The laser of claim 17 wherein the electron-beam trigger comprises a high-voltage pulse generator, an electron gun, and an electron beam and the plasma is an electron-beam-initiated, high-voltage pulsed discharge.

19. The laser of claim 18 wherein the electron gun driven by the high voltage pulse generator with a voltage in the range of 1 V to 1 MV, preferably in the range of 100 V to 100 kV, most preferably in the range of 1 kV to 10 kV provides a pulsed electron beam.

20. The laser of claim 19 wherein the beam energy is in the range of 1 eV to 1 MeV, preferably in the range of 100 eV to 100 keV, most preferably in the range of 1 keV to 10 keV.

21. The laser of claim 20 wherein the beam current is in the range of about 0.01 μA to 1000 A, preferably on the range of about 0.1 μA to 100 A, more preferably in the range of about 1 μA to 10 A, and most preferably in the range of about 10 μA to 1 A.

22. The laser of claim 21 wherein the electron beam triggers a high-voltage pulsed discharge, and the pulse duration is in the range of 1 ns to 100 s, preferably in the range of 1 m to 1 s, most preferably in the range of 1 to 10 ms.

23. The laser of claim 22 wherein the repetition rate is in the range of 0.001 Hz to 10 GHz, preferably in the range of 0.1 Hz to 100 Hz, most preferably in the range of 1 to 10 Hz.

24. The laser of claim 23 wherein the negative high voltage power supply applies high voltage to the cathode of the main discharge in the range of 1 to 10 MV, preferably in the range of 100 V to 100 kV, most preferably in the range of 1 kV to 20 kV.

25. The laser of claim 24 wherein the electrodes are microhollow electrodes.

26. The laser of claim 25 wherein the anode comprises a tapered microhollow anode with a variable bore with a reduction ratio in the range of 1 to 0.001, preferably in the range of 1 to 0.1, and most preferably in the range of 1 to 0.5, and a diameter in the range of 1 nm to 10 cm, preferably in the range of 1 μm to 1 cm, and most preferably in the range of 1 mm to 5 mm.

27. The laser of claim 26 wherein the cathode is a microhollow cathode with a diameter in the range of 1 nm to 10 cm, preferably in the range of 1 μm to 1 cm, and most preferably in the range of 1 mm to 5 mm.

28. The laser of claim 27 wherein the electrodes are separated by a gap in the range of 1 nm to 1 m, preferably in the range of 1 μm to 1 cm, and most preferably in the range of 1 mm to 5 mm.

29. The laser of claim 28 wherein the hollow cathode further comprises plasma chamber opposite the inter-electrode region with a width in the range of 0.1 mm to 100 cm, preferably in the range of 1 mm to 1 cm, and most preferably 10 to 20 mm.

30. The laser of claim 29 wherein the molecular and atomic hydrogen partial pressures in the main reaction chamber as well as the catalyst partial pressure is preferably maintained in the range of about 1 mtorr to about 100 atm.

31. The laser of claim 30 wherein preferably the pressure is in the range of about 100 mtorr to about 1 atm, more preferably the pressure is about 100 mtorr to about 1 torr.

32. The laser of claim 31 wherein the flow rate of the plasma gas or hydrogen-plasma gas mixture such as at least one gas selected for the group of hydrogen, argon, helium, argon-hydrogen mixture, helium-hydrogen mixture, and water vapor is about 0.001-1 standard liters per minute per cm³ of vessel volume more preferably about 0.001-10 sccm per cm³ of vessel volume, and most preferably 0.1 to 1 sccm per cm³ of vessel volume.

33. The laser of claim 32 wherein the gases are selected from the group of helium-hydrogen, neon-hydrogen, and argon-hydrogen mixture, and preferably helium, neon, or argon is in the range of about 99 to about 1%, preferably about 99 to about 50%, and most preferably 98 to 95%.

34. The laser of claim 33 wherein the power density of the source of plasma power is preferably in the range of about 0.01 W to about 100 W/cm³ vessel volume.

35. The laser of claim 34 wherein the mole fraction of hydrogen in the catalyst-hydrogen gas is in the range of about 0.001% to 90%; preferably it is in the range of about 0.01% to 10%, and most preferably it is in the range of about 0.1% to 5%.

36. The laser of claim 35 wherein the flow rate and pressure are maintained according to that of catalyst-hydrogen mixture to achieve the desired mole fractions.

37. The laser of claim 36 wherein hydrogen serves as the catalyst according to the reaction:
$$27.21 eV + 2 H [ \frac{{a}_{H}}{1} ] + H [ \frac{{a}_{H}}{p} ] \to 2 {H}^{+} + 2 {e}^{-} + H [ \frac{{a}_{H}}{( p + 1 )} ] + [ {( p + 1 )}^{2} - {p}^{2} ] X 13.6 eV$$
$$2 {H}^{+} + 2 {e}^{-} \to 2 H [ \frac{{a}_{H}}{1} ] + 27.21 eV$$
And, the overall reaction is
$$H [ \frac{{a}_{H}}{p} ] \to H [ \frac{{a}_{H}}{( p + 1 )} ] + [ {( p + 1 )}^{2} - p ] X 13.6 eV$$

38. The laser of claim 37 wherein the catalysis of atomic hydrogen to form increased-binding-energy-hydrogen species is achieved with a hydrogen plasma.

39. The laser of claim 38 wherein the hydrogen pressure is in the range of about 1 mtorr to about 100 atm; preferably the pressure is in the range of about 100 mtorr to about 1 atm, more preferably the pressure is about 100 mtorr to about 10 torr.

40. The laser of claim 39 wherein the hydrogen flow rate may be in the range of about 0-1 standard liters per minute per cm³ of vessel volume and more preferably about 0.001-10 sccm per cm³ of vessel volume.

41. The laser of claim 40 comprising at least one of a laser medium comprising an inverted population of a state of the catalyst or a species formed from the catalyst, a laser cavity, laser cavity mirrors, a power source, and a output laser beam from the cavity through one of the mirrors or a windowless output.

42. The laser of claim 41 further comprising Brewer windows and further optical components to cause stimulated emission of an inverted population of the laser medium in the cavity.

43. The laser of claim 42 wherein the laser has a sufficient path length such that gain is achieved in the absence of mirrors.

44. The laser of claim 43 that provides EUV laser emission for EUV lithography, and the mirrors comprise multilayer, thin-film coatings such as distributed Bragg reflectors.

45. The laser of claim 44 wherein the mirror are Mo:Si ML that have been optimized for peak reflectivity at 13.4 nm.

46. The laser and light source of claim 45 wherein laser light source comprises an inverted population of the emitting species, a cell, a power source, and a output window from the cell.

47. The laser of claim 46 wherein the power is input to create a plasma to initiate the reaction to form hydrogen atomic states of lower energy than uncatalyzed atomic hydrogen, and the power input to create a plasma to initiate the catalyst reaction is at least one of a particle beam such as an electron beam and microwave, high voltage, and RF discharges.

48. The laser of claim 47 wherein the system to create a plasma to form atomic hydrogen and the catalyst comprises an electron-beam-initiated, high-voltage pulsed discharge plasma of catalyst-hydrogen gases.

49. The laser of claim 48 wherein the power source at least partially comprises an increased-binding-energy-hydrogen species reactor, a cell for the catalysis of atomic hydrogen to form novel hydrogen species and/or compositions of matter comprising new forms of hydrogen.

50. The laser of claim 49 wherein the reaction is maintained by a particle beam, microwave, glow, or RF discharge plasma of a source of atomic hydrogen and a source of catalyst such as helium or argon to provide catalyst He⁺ and Ar⁺, respectively.

51. The laser of claim 50 wherein at least one of the power from catalysis and an external power source maintains an inverted population of one or more states of the catalyst or species formed from the catalyst from which stimulate emission may occur.

52. The laser of claim 51 wherein the emission is in the ultraviolet (UV) and extreme ultraviolet (EUV) which may be used for photolithography.

53. The laser of claim 52 wherein the light source further comprises a pin-hole optic that may be differentially pumped to serve as a “windowless” exit for short wavelength light from the cell such as EUV or soft-X-ray light.

54. The laser of claim 53 wherein He⁺ serves as the catalyst, and electronic transitions to fractional Rydberg states of atomic hydrogen occur when 54.417 eV is transferred nonradiatively from atomic hydrogen to He⁺ which is resonantly ionized.

55. The laser of claim 54 wherein the electron decays to the n=⅓ state with the further release of 54.417 eV which may be emitted as a photon or can further serve to ionize He⁺; the catalysis reaction is
$$54.417 eV + {He}^{+} + H [ {a}_{H} ] \to {He}^{2 +} + {e}^{-} + H [ \frac{{a}_{H}}{3} ] + 108.8 eV$$
$${He}^{2 +} + {e}^{-} \to {He}^{+} + 54.417 eV$$
And, the overall reaction is
$$H [ {a}_{H} ] \to H [ \frac{{a}_{H}}{3} ] + 54.4 eV + 54.4 eV$$

56. The laser of claim 55 wherein the reactions involve two steps of energy release, and may be written as follows:
$$54.417 eV + {He}^{+} + H [ {a}_{H} ] \to {He}^{2 +} + {e}^{-} + H * [ \frac{{a}_{H}}{3} ] + 54.4 eV$$
$$H * [ \frac{{a}_{H}}{3} ] \to H [ \frac{{a}_{H}}{3} ] + 54.4 eV$$
$${He}^{2 +} + {e}^{-} \to {He}^{+} + 54.417 eV$$
And, the overall reaction is
$$H [ {a}_{H} ] \to H [ \frac{{a}_{H}}{3} ] + 54.4 eV + 54.4 eV$$
wherein
$$H * [ \frac{{a}_{H}}{3} ]$$
has the radius of the hydrogen atom and a central field equivalent to 3 times that of a proton and
$$H [ \frac{{a}_{H}}{3} ]$$
is the corresponding stable state with the radius of ⅓ that of H.

57. The laser of claim 56 wherein it is characteristic of cold recombining plasmas to have the high lying levels in local thermodynamic equilibrium (LTE); whereas, population inversion is obtained when Tₑ suddenly decreases concomitant with rapid decay of the lower lying states.

58. The laser of claim 57 wherein at least one of K, Sr⁺, Ne⁺, Ne⁺/H⁺ and Ar⁺ serve as the catalyst, and the inverted population is formed in the catalyst or in a species formed from the catalyst by the energetic hydrogen catalysis reaction which pumps the state.

59. The laser of claim 58 wherein the catalyst reactions to form the inverted states in at least one of K³⁺, K²⁺, K⁺, and K are given by
$$81.7426 eV + K ( m ) + H [ \frac{{a}_{H}}{p} ] \to {K}^{3} + 3 {e}^{-} + H [ \frac{{a}_{H}}{( p + 3 )} ] + [ {( p + 3 )}^{2} - {p}^{2} ] X 13.6 eV$$
$${K}^{3 +} + 3 {e}^{-} \to K ( m ) + 81.7426 eV$$
And, the overall reaction is
$$H [ \frac{{a}_{H}}{p} ] \to H [ \frac{{a}_{H}}{( p + 3 )} ] + [ {( p + 3 )}^{2} - {p}^{2} ] X 13.6 eV$$

60. The laser of claim 59 wherein the catalyst reactions to form the inverted states in at least one of Sr³⁺, Sr²⁺, and Sr⁺ are given by:
$$53.95 eV + {Sr}^{+} + H [ \frac{{a}_{H}}{p} ] \to {Sr}^{3 +} + 2 {e}^{-} + H [ \frac{{a}_{H}}{( p + 2 )} ] + [ {( p + 2 )}^{2} - {p}^{2} ] X 13.6 eV$$
$${Sr}^{3 +} + 2 {e}^{-} \to {Sr}^{+} + 53.92 eV$$
And, the overall reaction is
$$H [ \frac{{a}_{H}}{p} ] \to H [ \frac{{a}_{H}}{( p + 2 )} ] + [ {( p + 2 )}^{2} - {p}^{2} ] X 13.6 eV$$

61. The laser of claim 60 wherein the catalyst reactions to form the inverted states in at least one of Ne²⁺ and Ne⁺ are given by:
$$27.36 eV + {Ne}^{+} + {H}^{+} + H [ \frac{{a}_{H}}{p} ] \to H + {Ne}^{2 +} + H [ \frac{{a}_{H}}{( p + 1 )} ] + [ {( p + 1 )}^{2} - {p}^{2} ] X 13.6 eV$$
$$H + {Ne}^{2 +} \to {H}^{+} + {Ne}^{+} + 27.36 eV$$
And, the overall reaction is
$$H [ \frac{{a}_{H}}{p} ] \to H [ \frac{{a}_{H}}{( p + 1 )} ] + [ {( p + 1 )}^{2} - {p}^{2} ] X 13.6 eV$$
$$And$$
$$27.21 eV + {Ne}_{2}^{*} + H [ \frac{{a}_{H}}{p} ] \to 2 {Ne}^{+} + H [ \frac{{a}_{H}}{( p + 1 )} ] + [ {( p + 1 )}^{2} - {p}^{2} ] X 13.6 eV$$
$$2 {Ne}^{+} \to {Ne}_{2}^{*} + 27.21 eV$$
And, the overall reaction is
$$H [ \frac{{a}_{H}}{p} ] \to H [ \frac{{a}_{H}}{( p + 1 )} ] + [ {( p + 1 )}^{2} - {p}^{2} ] X 13.6 eV$$

62. The laser of claim 61 wherein the catalyst reactions to form the inverted states in at least one of Ar²⁺ and Ar⁺ are given by:
$$27.63 eV + {Ar}^{+} + H [ \frac{{a}_{H}}{p} ] \to {Ar}^{2 +} + {e}^{-} + H [ \frac{{a}_{H}}{( p + 1 )} ] + [ {( p + 1 )}^{2} - {p}^{2} ] X 13.6 eV$$
$${Ar}^{2 +} + {e}^{-} \to {Ar}^{+} + 27.63 eV$$
And, the overall reaction is
$$H [ \frac{{a}_{H}}{p} ] \to H [ \frac{{a}_{H}}{( p + 1 )} ] + [ {( p + 1 )}^{2} - {p}^{2} ] X 13.6 eV$$

63. The laser of claim 62 wherein Sr⁺, Ne⁺, Ne⁺/H⁺ or Ar⁺ catalysts are formed from a source comprising strontium vapor and neon, neon-hydrogen mixture, and argon gases, respectively.

64. The laser of claim 63 wherein the source of catalyst is ionized to form the catalyst by means such as an electron beam and a plasma.

65. The laser of claim 64 wherein the plasma is at least partially driven by an external power source and may be driven by the catalyst of atomic hydrogen initiated with a first catalyst wherein the energetic reaction creates a plasma and secondarily ionizes the source of catalyst to form the catalyst.

66. The laser of claim 65 wherein the pumping power source may be from the catalysis of atomic hydrogen to states having a binding energy given by
$$\begin{matrix}{E}_{n} = - \frac{{e}^{2}}{{n}^{2} 8 π {ɛ}_{o} {a}_{H }} \\ = - \frac{13.598 eV}{{n}^{2}}\end{matrix}$$
$$n = \frac{1}{2} , \frac{1}{3} , \frac{1}{4} , … , \frac{1}{p} ; p \leq 137 is an integer$$

67. The laser of claim 66 wherein the power cell and hydride reactor to form atomic states of hydrogen having energies given by
$$\frac{13.6 eV}{{( \frac{1}{p} )}^{2}}$$
where p is an integer by reaction of atomic hydrogen with a catalyst, a catalyst is generated from a source of catalyst by ionization or excimer formation.

68. The laser of claim 67 wherein the cell comprises at least one of an rt-plasma reactor, a plasma electrolysis reactor, barrier electrode reactor, RF plasma reactor, pressurized gas energy reactor, gas discharge energy reactor, an electron-beam-initiated, high-voltage pulsed discharge plasma reactor, a microwave cell energy reactor, and a combination of a glow discharge cell and a microwave and or RF plasma reactor.

69. The laser of claim 68 wherein each reactor comprises a source of hydrogen; one of a solid, molten, liquid, and gaseous source of catalyst; a vessel containing hydrogen and the catalyst wherein the reaction to form lower-energy hydrogen occurs by contact of the hydrogen with the catalyst.

70. The laser of claim 69 comprising a laser cavity, cavity mirrors, and a power source that may at least partially comprise a cell for the catalysis of atomic hydrogen to form novel hydrogen species and/or compositions of matter comprising new forms of hydrogen.

71. The laser of claim 70 wherein the reaction is preferably maintained by an electron-beam-initiated, high-voltage pulsed discharge plasma of a source of atomic hydrogen and a source of catalyst such as helium and argon to provide catalysts He⁺ and Ar⁺, respectively.

72. The laser of claim 71 wherein comprising a cavity, a source of catalyst, a source of hydrogen, and a hydrogen valve, a gas supply line, a mass flow controller, and a catalyst gas valve, a third valve to control the flow of the plasma gases to the cavity, a pump, a pump valve, and a pressure gauge.

73. The laser of claim 72 wherein gas is flowed through the cavity using the pump and the valves.

74. The laser of claim 73 comprising an electron-beam-initiated, high-voltage pulsed discharge plasma and power cell and reactor having a cathode, an anode, and an electron beam trigger having a power supply and an electron gun.

75. The laser of claim 74 wherein an inverted population of a state of the catalyst or a species formed from the catalyst gas in the cavity is formed by the initiation of a high-voltage pulsed plasma triggered by an electron beam from the electron gun.

76. The laser of claim 75 wherein laser oscillators occur in the cavity which has the appropriate dimensions and mirrors for lasing; the laser light is contained in the cavity between the mirrors; and the output mirror is semitransparent such that the light exits the cavity through this mirror.

77. The laser of claim 76 wherein the emission is EUV laser emission that provides for EUV lithography, and the mirrors comprise multilayer, thin-film coatings such as distributed Bragg reflectors.

78. The laser of claim 77 wherein at least one mirror is Mo:Si ML that has been optimized for peak reflectivity at a desired EUV wavelength.

79. The laser of claim 78 comprising an EUV laser wherein the output is through a pin-hole optic that may be differentially pumped.

80. The laser of claim 79 wherein the cavity is sufficiently long such that lasing occurs without mirrors to increase the path length.

81. The laser of claim 80 wherein the cavity comprises a reactor to catalyze atomic hydrogen to lower-energy states such as an electron-beam-initiated, high-voltage pulsed discharge plasma and power cell and reactor, an rt-plasma reactor, plasma electrolysis reactor, barrier electrode reactor, RF plasma reactor, pressurized gas energy reactor, gas discharge energy reactor, microwave cell energy reactor, and a combination of a glow discharge cell and a microwave and/or RF plasma reactor.

82. The laser of claim 81 wherein the reaction is also maintained by the plasma formed with an electron beam.

83. The laser of claim 82 comprising an inverted population of a state of the catalyst or a species form from the catalyst, a plasma of a catalyst and hydrogen, and laser optics wherein plasma is maintained in an electron-beam-initiated, high-voltage pulsed discharge plasma reactor, an rt-plasma reactor, a plasma electrolysis reactor, a barrier electrode reactor, an RF plasma reactor, a pressurized gas energy reactor, a gas discharge energy reactor, a microwave cell energy reactor, and a combination of a glow discharge cell and a microwave and/or RF plasma reactor.

84. The laser of claim 83 having the plasma maintained by an electron-beam-initiated, high-voltage pulsed discharge plasma further comprising a cavity with an inlet and an outlet, at least one high reflectivity mirror, windows, and an output coupler wherein the plasma gas containing hydrogen and catalyst is flowed through the cavity via the inlet and outlet, the laser beam is directed to a high reflectivity mirror, such as a 95 to 99.9999% reflective spherical cavity mirror, and to the output coupler by the windows, such as Brewster angle windows.

85. The laser of claim 84 wherein the output coupler has a transmission in the range 0.1 to 50%, and preferably in the range 1 to 10%.

86. The laser of claim 85 wherein the beam power is measured by a power meter.

87. The laser of claim 29 wherein the laser is mounted on an optical rail on an optical table which allows for adjustments of the cavity length to achieve lasing at a desired wavelength.

88. The laser of claim 29 wherein vibrations are ameliorated by vibration isolation feet.

89. The laser of claim 29 wherein the plasma tube is supported by a plasma tube support structure.

90. A laser comprising:
a plasma forming cell or reactor for the catalysis of atomic hydrogen producing power, a continuous stationary inverted population of at least one state of the catalyst or a species formed from the catalyst and novel hydrogen species and compositions of matter comprising new forms of hydrogen,
a source of catalyst,
a source of atomic hydrogen,
a controller to cause atomic hydrogen to react with atomic hydrogen to form lower-energy states given by
$$\begin{matrix}{E}_{n} = - \frac{{e}^{2}}{{n}^{2} 8 π {ɛ}_{o} {a}_{H}} \\ = - \frac{13.598 eV}{{n}^{2}}\end{matrix}$$
$$and$$
$${H}_{2} ( 1 / p )$$
$$n = \frac{1}{2} , \frac{1}{3} , \frac{1}{4} , … , \frac{1}{p} ; p \leq 137 ,$$
and
a means to form and output a laser beam.

91. The laser of claim 90 wherein the reactor comprises a source of hydrogen; one of a solid, molten, liquid, and gaseous source of catalyst; a vessel containing hydrogen and the catalyst wherein the reaction to form lower-energy hydrogen occurs by contact of the hydrogen with the catalyst; and a means for providing the at least one inverted state of the catalyst or a species formed from the catalyst to the laser cavity to comprise the laser medium.

92. The laser of claim 91 wherein the cavity comprises a reactor to catalyze atomic hydrogen to lower-energy states, and the reaction is maintained with a plasma.

93. The laser of claim 92 wherein a plasma provides atomic hydrogen, or the cell further comprises a dissociator such as a filament, or metal such as platinum, palladium, titanium, or nickel that forms atomic hydrogen from the source of atomic hydrogen.

94. The laser of claim 93 where the source of catalyst is an excimer.

95. The laser of claim 94 wherein the excimer is at least one of He₂*, Ne₂*, Ne₂*, and Ar₂* and the catalyst is He⁺, Ne⁺, Ne⁺/H⁺ or Ar⁺.

96. The laser of claim 95 wherein the excimer is formed by a high pressure discharge.

97. The laser of claim 96 wherein the discharge is one of a microwave, glow, RF, and electron-beam discharge.

98. The laser of claim 97 further comprising a source of ionization to form the catalyst from the source of catalyst.

99. The laser of claim 98 wherein the catalysis of hydrogen is maintained by a particle beam, microwave, glow, or RF discharge plasma of a source of atomic hydrogen and a source of catalyst.

100. The laser of claim 99 further comprising a catalyst cell, a catalyst, and a source of hydrogen to catalyze the formation of hydrogen to lower-energy states.

101. The laser of claim 100 where the pumping power to form the inverted population is from at least one of the external power supply and the power released from the catalysis of atomic hydrogen to lower-energy states.

102. The laser of claim 101 wherein the catalysis of hydrogen to lower-energy states given by
$$\begin{matrix}{E}_{n} = - \frac{{e}^{2}}{{n}^{2} 8 {πɛ}_{o} {a}_{H}} \\ = - \frac{13.598 eV}{{n}^{2}}\end{matrix}$$
$$n = \frac{1}{2} , \frac{1}{3} , \frac{1}{4} , … , \frac{1}{p} ; p \leq 137$$
occurs to form the inverted population.

103. The laser of claim 102 wherein the catalysis cell is also the laser cavity.

104. The laser of claim 103 wherein the source of catalyst is helium, neon, and argon, and the catalyst is He⁺, Ne⁺, Ne⁺/H⁺ or Ar⁺.

105. A compound produced during operation of the laser of claim 103, the compound comprising
(a) at least one neutral, positive, or negative increased binding energy hydrogen species having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions, or is negative; and
(b) at least one other element.

106. A compound of claim 105 characterized in that the increased binding energy hydrogen species is selected from the group consisting of Hₙ, Hₙ⁻, and Hₙ⁺ where n is a positive integer, with the proviso that n is greater than 1 when H has a positive charge.

107. A compound of claim 106 characterized in that the increased binding energy hydrogen species is selected from the group consisting of (a) hydride ion having a binding energy that is greater than the binding of ordinary hydride ion (about 0.8 eV) for p=2 up to 23 in which the binding energy is represented by
$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} )$$
where p is an integer greater than one, s=½, π is pi, h is Planck's constant bar, μₒ is the permeability of vacuum, mₑ is the mass of the electron, μₑ is the reduced electron mass given by
$${μ}_{e} = \frac{{m}_{e} {m}_{p}}{\frac{{m}_{e}}{\sqrt{\frac{3}{4}}} + {m}_{p}}$$
where mₚ is the mass of the proton, a_{H} is the radius of the hydrogen atom, aₒ is the Bohr radius, and e is the elementary charge; (b) hydrogen atom having a binding energy greater than about 13.6 eV; (c) hydrogen molecule having a first binding energy greater than about 15.3 eV; and (d) molecular hydrogen ion having a binding energy greater than about 16.3 eV.

108. A compound of claim 107 characterized in that the increased binding energy hydrogen is a hydride ion having a binding energy of about 3, 6.6, 11.2, 16.7, 22.8, 29.3, 36.1, 42.8, 49.4, 55.5, 61.0, 65.6, 69.2, 71.6, 72.4, 71.6, 68.8, 64.0, 56.8, 47.1, 34.7, 19.3, and 0.69 eV.

109. A compound of claim 108 characterized in that the increased binding energy hydrogen species is a hydride ion having the binding energy:
$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} )$$
where p is an integer greater than one, s=½, π is pi, h is Planck's constant bar, μₒ is the permeability of vacuum, mₑ is the mass of the electron, μₑ is the reduced electron mass given by
$${μ}_{e} = \frac{{m}_{e} {m}_{p}}{\frac{{m}_{e}}{\sqrt{\frac{3}{4}}} + {m}_{p}}$$
where mₚ is the mass of the proton, a_{H} is the radius of the hydrogen atom, aₒ is the Bohr radius, and e is the elementary charge.

110. A compound of claim 109 characterized in that the increased binding energy hydrogen species is selected from the group consisting of
(a) a hydrogen atom having a binding energy of about
$$\frac{13.6 eV}{{( \frac{1}{p} )}^{2}}$$
where p is an integer,
(b) an increased binding energy hydride ion (H⁻) having a binding energy of about
$$Binding Energy = \frac{{ℏ}^{2} \sqrt{s ( s + 1 )} }{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} )$$
where p is an integer greater than one, s=½, π is pi, h is Planck's constant bar, μₒ is the permeability of vacuum, mₑ is the mass of the electron, μₑ is the reduced electron mass given by
$${μ}_{e} = \frac{{m}_{e} {m}_{p}}{\frac{{m}_{e}}{\sqrt{\frac{3}{4}}} + {m}_{p}}$$
where mₚ is the mass of the proton, a_{H} is the radius of the hydrogen atom, aₒ is the Bohr radius, and e is the elementary charge;
(c) an increased binding energy hydrogen species H₄⁺(1/p);
(d) an increased binding energy hydrogen species trihydrino molecular ion, H₃⁺(1/p), having a binding energy of about
$$\frac{22.6}{{( \frac{1}{p} )}^{2}} eV$$
where p is an integer,
(e) an increased binding energy hydrogen molecule having a binding energy of about
$$\frac{15.3}{{( \frac{1}{p} )}^{2}} eV ;$$
and
(f) an increased binding energy hydrogen molecular ion with a binding energy of about
$$\frac{16.3}{{( \frac{1}{p} )}^{2}} eV .$$

111. The catalyst of claim 110 comprising a chemical or physical process that provides a net enthalpy of m·27.2±0.5 eV where m is an integer or m/2·27.2±0.5 eV where m is an integer greater than one.

112. The catalyst of claim 111 that provides a net enthalpy of m·27.2±0.5 eV where m is an integer or m/2·27.2±0.5 eV where m is an integer greater than one corresponding to a resonant state energy level of the catalyst that is excited to provide the enthalpy.

113. The cell of claim 112 wherein a catalytic system is provided by the ionization of t electrons from a participating species such as an atom, an ion, a molecule, and an ionic or molecular compound to a continuum energy level such that the sum of the ionization energies of the t electrons is approximately m·27.2±0.5 eV where m is an integer or m/2·27.2±0.5 eV where m is an integer greater than one and t is an integer.

114. The plasma cell of claim 113 wherein the catalyst is provided by the transfer of t electrons between participating ions;
the transfer of t electrons from one ion to another ion provides a net enthalpy of reaction whereby the sum of the ionization energy of the electron donating ion minus the ionization energy of the electron accepting ion equals approximately m·27.2±0.5 eV where m is an integer or m/2·27.2±0.5 eV where m is an integer greater than one and t is an integer.

115. The catalyst of claims 111, 112, 113, and 114 wherein preferably m is an integer less than 400.

116. The catalyst of claim 115 comprising He⁺ which absorbs 40.8 eV during the transition from the n=1 energy level to the n=2 energy level which corresponds to 3/2·27.2 eV (m=3) that serves as a catalyst for the transition of atomic hydrogen from the n=1 (p=1) state to the n=½ (p=2) state.

117. The catalyst of claim 116 comprising Ar²⁺ which absorbs 40.8 eV and is ionized to Ar³⁺ which corresponds to 3/2·27.2 eV (m=3) during the transition of atomic hydrogen from the n=1 (p=1) energy level to the n=½ (p=2) energy level.

118. The catalyst of claim 117 is selected from the group of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, He⁺, Na⁺, Rb⁺, Sr⁺, Fe³⁺, Mo²⁺, Mo⁴⁺, and In³⁺.

119. A catalyst of atomic hydrogen of claim 118 capable of providing a net enthalpy of m·27.2±0.5 eV where m is an integer or m/2·27.2±0.5 eV where m is an integer greater than one and capable of forming a hydrogen atom having a binding energy of about
$$\frac{13.6 eV}{{( \frac{1}{p} )}^{2}}$$
where p is an integer wherein the net enthalpy is provided by the breaking of a molecular bond of the catalyst and the ionization of t electrons from an atom of the broken molecule each to a continuum energy level such that the sum of the bond energy and the ionization energies of the t electrons is approximately m·27.2±0.5 eV where m is an integer or m/2·27.2±0.5 eV where m is an integer greater than one.

120. The catalyst of claim 119 comprising at least one of C₂, N₂, O₂, CO₂, NO₂, and NO₃.

121. The catalyst of claim 120 comprising a molecule in combination with an ion or atom catalyst.

122. The catalyst combination of claim 121 comprising at least one molecule selected from the group of C₂, N₂, O₂, CO₂, NO₂, and NO₃ in combination with at least one atom or ion selected from the group of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, Kr, He⁺, Na⁺, Rb⁺, Sr⁺, Fe³⁺, Mo²⁺, Mo⁴⁺, In³⁺, He⁺, Ar⁺, Xe⁺, Ar²⁺ and H⁺, and Ne⁺ and H⁺.

123. The catalyst of claim 122 comprising helium excimer, Ne₂*, which absorbs 27.21 eV and is ionized to 2Ne⁺, to catalyze the transition of atomic hydrogen from the (p) energy level to the (p+1) energy level given by
$$27.21 eV + {Ne}_{2}^{*} + H [ \frac{{a}_{H}}{p} ] \to 2 {Ne}^{+} + H [ \frac{{a}_{H}}{( p + 1 )} ] + [ {( p + 1 )}^{2} - {p}^{2} ] X 13.6 eV$$
$$2 {Ne}^{+} \to {Ne}_{2}^{*} + 27.21 eV$$
And, the overall reaction is
$$H [ \frac{{a}_{H}}{p} ] \to H [ \frac{{a}_{H}}{( p + 1 )} ] + [ {( p + 1 )}^{2} - {p}^{2} ] X 13.6 eV$$

124. The catalyst of claim 123 comprising helium excimer, He₂*, which absorbs 27.21 eV and is ionized to 2He⁺, to catalyze the transition of atomic hydrogen from the (p) energy level to the (p+1) energy level given by
$$27.21 eV + {He}_{2}^{*} + H [ \frac{{a}_{H}}{p} ] \to 2 {He}^{+} + H [ \frac{{a}_{H}}{( p + 1 )} ] + [ {( p + 1 )}^{2} - {p}^{2} ] X 13.6 eV$$
$$2 {He}^{+} \to {He}_{2}^{*} + 27.21 eV$$
And, the overall reaction is
$$H [ \frac{{a}_{H}}{p} ] \to H [ \frac{{a}_{H}}{( p + 1 )} ] + [ {( p + 1 )}^{2} - {p}^{2} ] X 13.6 eV$$

125. The catalyst of claim 124 comprising two hydrogen atoms which absorbs 27.21 eV and is ionized to 2H⁺, to catalyze the transition of atomic hydrogen from the (p) energy level to the (p+1) energy level given by
$$27.21 eV + 2 H [ \frac{{a}_{H}}{1} ] + H [ \frac{{a}_{H}}{p} ] \to 2 {H}^{+} + 2 {e}^{\_} + H [ \frac{{a}_{H}}{( p + 1 )} ] + [ {( p + 1 )}^{2} - {p}^{2} ] X 13.6 eV$$
$$2 {H}^{+} + 2 {e}^{\_} -> 2 H [ \frac{{a}_{H}}{1} ] + 27.21 eV$$
And, the overall reaction is
$$H [ \frac{{a}_{H}}{p} ] \to H [ \frac{{a}_{H}}{( p + 1 )} ] + [ {( p + 1 )}^{2} - p ] X 13.6 eV$$

126. A catalytic disproportionation reaction of atomic hydrogen wherein lower-energy hydrogen atoms, hydrinos, can act as catalysts because each of the metastable excitation, resonance excitation, and ionization energy of a hydrino atom is m×27.2 eV.

127. The catalytic reaction of claim 126 of a first hydrino atom to a lower energy state affected by a second hydrino atom involves the resonant coupling between the atoms of m degenerate multipoles each having 27.21 eV of potential energy.

128. The catalytic reaction of claim 127 wherein the energy transfer of m×27.2 eV from the first hydrino atom to the second hydrino atom causes the central field of the first atom to increase by m and its electron to drop m levels lower from a radius of
$$\frac{{a}_{H}}{p}$$
to a radius of
$$\frac{{a}_{H}}{p + m} .$$

129. The catalytic reaction of claim 128 wherein the second interacting lower-energy hydrogen is either excited to a metastable state, excited to a resonance state, or ionized by the resonant energy transfer.

130. The catalytic reaction of claim 129 wherein the resonant transfer may occur in multiple stages.

131. The catalytic reaction of claim 130 wherein a nonradiative transfer by multipole coupling may occur wherein the central field of the first increases by m, then the electron of the first drops m levels lower from a radius of
$$\frac{{a}_{H}}{p}$$
to a radius of
$$\frac{{a}_{H}}{p + m}$$
with further resonant energy transfer.

132. The catalytic reaction of claim 131 wherein the energy transferred by multipole coupling may occur by a mechanism that is analogous to photon absorption involving an excitation to a virtual level.

133. The catalytic reaction of claim 132 wherein the energy transferred by multipole coupling during the electron transition of the first hydrino atom may occur by a mechanism that is analogous to two photon absorption involving a first excitation to a virtual level and a second excitation to a resonant or continuum level.

134. A catalytic reaction with hydrino catalysts for the transition of
$$H [ \frac{{a}_{H}}{p} ] to H [ \frac{{a}_{H}}{p + m} ]$$
induced by a multipole resonance transfer of m·27.21 eV and a transfer of [(p′)²−(p′−m′)²]×13.6 eV−m·27.2 eV with a resonance state of
$$H [ \frac{{a}_{H}}{{p}^{′} - {m}^{′}} ]$$
excited in
$$H [ \frac{{a}_{H}}{{p}^{′}} ]$$
is represented by
$$H ⌊ \frac{{a}_{H}}{{p}^{′}} ⌋ + H ⌊ \frac{{a}_{H}}{p} ⌋ \to \\ H [ \frac{{a}_{H}}{{p}^{′} - {m}^{′}} ] + H [ \frac{{a}_{H}}{p + m} ] + [ \begin{matrix}( {( p + m )}^{2} - {p}^{2} ) - \\ ( {p}^{′2} - {( {p}^{′} - {m}^{′} )}^{2} )\end{matrix} ] \times 13.6 eV$$
where p, p′, m, and m′ are integers.

135. The catalytic reaction with hydrino catalysts wherein a hydrino atom with the initial lower-energy state quantum number p and radius
$$\frac{{a}_{H}}{p}$$
may undergo a transition to the state with lower-energy state quantum number (p+m) and radius
$$\frac{{a}_{H}}{( p + m )}$$
by reaction with a hydrino atom with the initial lower-energy state quantum number m′, initial radius
$$\frac{{a}_{H}}{{m}^{′}} ,$$
and final radius a_{H} that provides a net enthalpy of m·27.2±0.5 eV where m is an integer or m/2·27.2±0.5 eV where m is an integer greater than one.

136. The catalytic reaction of claim 135 of hydrogen-type atom,
$$H [ \frac{{a}_{H}}{p} ] ,$$
with the hydrogen-type atom,
$$H [ \frac{{a}_{H}}{{m}^{′}} ] ,$$
that is ionized by the resonant energy transfer to cause a transition reaction is represented by
$$m \times 27.21 eV + H [ \frac{{a}_{H}}{{m}^{′}} ] + H [ \frac{{a}_{H}}{p} ] \to \\ {H}^{+} + {e}^{-} + H [ \frac{{a}_{H}}{( p + m )} ] + \begin{matrix}[ {( p + m )}^{2} - {p}^{2} - ( {m}^{′} - 2 m ) ] \times \\ 13.6 eV\end{matrix}$$
$${H}^{+} + {e}^{-} \to H [ \frac{{a}_{H}}{1} ] + 13.6 eV$$
And, the overall reaction is
$$H [ \frac{{a}_{H}}{{m}^{′}} ] + H [ \frac{{a}_{H}}{p} ] \to \\ H [ \frac{{a}_{H}}{1} ] + H [ \frac{{a}_{H}}{( p + m )} ] + \begin{matrix}[ 2 pm + {m}^{2} - {m}^{′2} ] \times \\ 13.6 eV + 13.6 eV\end{matrix}$$

137. The cell for the catalysis of atomic hydrogen of claim 136 wherein the catalyst comprises a mixture of a first catalyst and a source of a second catalyst.

138. The mixture of a first catalyst and a source of a second catalyst of claim 137 wherein the first catalyst produces the second catalyst from the source of the second catalyst.

139. The first catalyst of claim 138 that produces the second catalyst from the source of the second catalyst wherein the energy released by the catalysis of hydrogen by the first catalyst produces a plasma in the energy cell.

140. The first catalyst of claim 101 that produces the second catalyst from the source of the second catalyst wherein the energy released by the catalysis of hydrogen by the first catalyst ionizes the source of the second catalyst to produce the second catalyst.

141. A laser source comprising:
a plasma forming cell or reactor;
a source of atomic hydrogen in communication with the cell or reactor;
a source of catalyst in communication with the cell or reactor for the catalysis of atomic hydrogen to lower-energy hydrogen, wherein during operation of the cell or reactor a continuous stationary inverted population of at least one state of the catalyst of a species of catalyst is formed;
a controller to cause atomic hydrogen to react with atomic hydrogen to form lower-energy states given by
$${E}_{n} = - \frac{{e}^{2}}{{n}^{2} 8 π {ɛ}_{0} {a}_{H}} = - \frac{13.598 eV}{{n}^{2}}$$
$$and$$
$${H}_{2} ( 1 / p )$$
$$n = \frac{1}{2} , \frac{1}{3} , \frac{1}{4} , … , \frac{1}{p} ;$$
p≦137 during operation of the cell or reactor; and
a means to form and output a laser beam.

142. The laser of claim 141 wherein the power source comprises a means to replace the electron deficit due to the higher electron mobility compared to ions to control the plasma potential.

143. The laser of claim 142 further comprising a source of electrons to control the plasma potential.

144. The laser of claim 143 wherein the source of electrons is a current from a hot filament or an electron gun.

145. The laser of claim 144 wherein the power source comprises a means to magnetize the electrons to control the plasma potential.

146. The laser of claims 143 and 145 wherein the plasma potential is maintained at a desired potential of about neutral, positive, or negative potential.

147. The laser of claim 146 wherein the plasma potential is controlled to optimize the rate of the catalysis of hydrogen to lower-energy states given by
$${E}_{n} = - \frac{{e}^{2}}{{n}^{2} 8 π {ɛ}_{0} {a}_{H}} = - \frac{13.598 eV}{{n}^{2}}$$
$$n = \frac{1}{2} , \frac{1}{3} , \frac{1}{4} , … , \frac{1}{p} ;$$
$$p \leq 137$$

148. The laser of claim 147 wherein the magnetic flux is in the range of about 1-100,000 G, preferably the flux is in the range of about 10-1000 G, more preferably the flux in the range of about 50-200 G, most preferably the flux is the range of about 50-150 G.

149. The laser of claims 145 and 148 wherein further comprising a means to measure the plasma potential and a feedback loop of the electron flow and the electron confinement to maintain a desired plasma potential to cause a desired rate of hydrogen catalysis.

150. The laser of claim 149 wherein the plasma potential measurement means comprises a probe such as a Langmuir probe.

151. The laser of claim 150 wherein the source of electrons is a tungsten filament or a rhenium, BaO-coated, or radioactive filament such as a thoriated-tungsten filament.

152. The laser of claim 151 wherein the electron source is an electron emitter a heated alkali (Group I) metal or an alkaline earth (Group II) metal or a thermionic cathode.

153. The laser of claims 151 and 152 wherein the filament ionizes the catalyst such as Sr⁺ or Ar⁺, and the formed-rt-plasma maintains the ionization at a much higher level.

154. The laser of claim 153 wherein the means to confine electrons with a magnetic field is a magnetic bottle or a selenoidal field.

155. The laser of claim 154 wherein the source of electrons is a discharge electrode such as an anode.

156. The laser of claim 155 further comprising a controller wherein the electron flow to the plasma is controlled by controlling the temperature of the filament or the current of the electron gun.

157. The laser of claim 156 further comprising a means to confine electrons in a desired spatial region by an electric field.

158. The laser of claim 157 further comprising electrodes to provide the electric field.

159. The laser of claim 158 further comprising a source of negative ions to control the plasma potential.

160. The laser of claim 159 wherein the source of negatively charged ions is a source of hydride ions.

161. The laser of claim 160 comprising a heating means wherein negative ions such as hydride ions are boiled from the surface of the wall of the reactor by maintaining the wall at an elevated temperature.

162. The laser of claim 161 further comprising a means to maintain a positive plasma potential.

163. The laser of claim 162 further comprising a source of positively charged ions to control the plasma potential.

164. The laser of claim 163 further comprising a means to confine positive ions.

165. The laser of claim 164 wherein the means to confine positive ions is a magnetic field such as a magnetic bottle or a selenoidal field.

166. The laser of claim 165 further comprising a means to confine electrons in a region such that a desired region outside of the electron-rich region is positively charged.

167. The laser of claim 166 wherein the means to confine electrons is a magnetic field such as a magnetic bottle or a selenoidal field.

168. The laser of claim 167 wherein the source of ions is an ion beam or a discharge electrode such as a cathode.

169. The laser of claim 168 wherein the means to confine positive ions in a desired spatial region comprises a source of electric field.

170. The laser of claim 169 wherein the source of electric field is electrodes.

171. The laser of claim 170 wherein the source of positively charged ions is a source of alkali (Group I) or alkaline earth (Group II) ions.

172. The laser of claim 171 further comprising a heating means wherein positive ions such as alkali or alkaline earth ions are boiled from the surface of the wall of the reactor by maintaining the wall at an elevated temperature.

173. The laser of claim 172 further comprising a heating means wherein the positive ions are provided by boiling off electrons to a different region such that electron-emitting source acquires a net positive charge that positively charges the plasma.

174. The laser of claim 173 wherein the electron-emitting source is a thermionic cathode.

175. A laser comprising:
a plasma forming cell or reactor;
a source of atomic hydrogen in communication with the cell or reactor;
a source of catalyst in communication with the cell or reactor for the catalysis of atomic hydrogen to lower-energy hydrogen, wherein during operation of the cell or reactor a continuous stationary inverted population of at least one state of the catalyst of a species of catalyst is formed;
a controller constructed and arranged to cause atomic hydrogen to react with atomic hydrogen to cause EUV emission lines with energies of q·13.6 eV where q is an integer during operation of the cell or reactor, and
a mean to form and output a laser beam.

176. The laser of claim 175 further comprising a means to provide water vapor to the plasma and a means to remove hydrogen and oxygen dissociated from the water vapor by the plasma such that the gases are collected as industrial gases.

177. The laser of claim 176 further comprising an electron beam from a gun wherein the beam energy is tunable and the free electrons serve as the catalyst wherein the free electrons undergo an inelastic scattering reaction with hydrogen atoms.

178. A method of making laser light or light comprising:
providing a cavity;
providing a source of hydrogen to the cavity;
providing a catalyst to the cavity;
providing power to initiate formation of hydrogen atoms from the source of hydrogen and initiate a reaction between the hydrogen atoms and the catalyst to form lower-energy hydrogen having a binding energy given by
$$Binding Energy = \frac{13.6 eV}{{( \frac{1}{p} )}^{2}}$$
where p is an integer greater than 1, preferably from 2 to 200, wherein during the reaction to form lower-energy hydrogen an inverted state in the catalyst or a species formed from the catalyst is formed; and
forming laser light or light from the inverted population.

179. The method of claim 178 further comprising cavity mirrors and a laser-beam output.

180. The method of claim 179 wherein the laser light is within the range of wavelengths from about infrared, visible, ultraviolet, extreme ultraviolet, to soft X-ray.

190. A method of making laser light comprising:
reacting hydrogen atoms with a catalyst for forming lower-energy hydrogen;
forming an inverted population of catalyst or species formed from the catalyst; and
forming laser light or light from the inverted population.

191. A light source comprising:
a cavity;
a source of atomic hydrogen in communication with the cavity;
a source of catalyst for catalyzing the reaction of hydrogen to lower-energy hydrogen in communication with the cavity, wherein the catalyst is selected such that during operation of the laser or light source the catalyst or a species formed from the catalyst forms an inverted population during reaction with hydrogen-atoms to form lower-energy atoms;
and a power source to initiate formation of hydrogen atoms from the source of hydrogen in the cavity.
